(19) United States
(12) Patent Application Publication
(10) Pub. No.: US 2025/0220383 A1
(43) Pub. Date: Jul. 3, 2025

(54) ComSense™: A Wi-Fi-Based RADAR and Audio Beamforming System

(71) Applicant: James Satloff, New York, NY (US)

(72) Inventor: James Satloff, New York, NY (US)

(21) Appl. No.: 19/004,201

(22) Filed: Dec. 27, 2024

Related U.S. Application Data
(60) Provisional application No. 63/616,676, filed on Dec. 31, 2023.

(51) Int. Cl. H04S 7/00; G10L 19/008; H04L 25/02

(52) U.S. Cl. CPC H04S 7/303; G10L 19/008; H04L 25/0202; H04S 2420/01

(57) ABSTRACT

A system and method of targeting spatialized audio to ears of a listener, comprising sensing characteristics of an environment comprising at least one human by receiving radio frequency signals with a radio receiver; using the sensed characteristics in at least one automated processor to analyze at least one human dynamic physiological pattern of each human and estimate a body pose and head position within the environment of each human based on the sensed characteristics and the at least one human dynamic physiological pattern; and using an estimated position of the ears of each human in conjunction with a head-related transfer function in a spatial audio system to generate spatialized audio.

### CROSS REFERENCE TO RELATES APPLICATIONS

The present application is a non-provisional of, and claims benefit of priority from, U.S. Provisional Patent Application No. 63/616,676, filed Dec. 31, 2024, the entirety of which is expressly incorporated herein by reference.

### FIELD OF THE INVENTION

The present invention relates to spatialized audio, and in particular to systems and methods for locating the position and orientation of a human head within a listening environment using radio frequency reflections.

### INCORPORATION BY REFERENCE AND INTERPRETATION OF LANGUAGE

The disclosures of each reference disclosed herein, whether U.S. or foreign patent literature, or non-patent literature, are hereby incorporated by reference in their entirety in this application, and shall be treated as if the entirety thereof forms a part of this application. Citation or identification of any reference herein, in any section of this application, shall not be construed as an admission that such reference is necessarily available as prior art to the present application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references does not admit the field of the invention, the level of skill of the routineer, or that any reference is analogous art. The citation of references is intended to be part of the disclosure of the invention, and not merely supplementary background information. The incorporation by reference does not extend to teachings which are inconsistent with the invention as expressly described herein (which may be treated as counter examples).

The incorporated references are evidence of a proper interpretation by persons of ordinary skill in the art of the terms, phrase and concepts discussed herein, without being limiting as the sole interpretation available. The present specification and claims are not to be interpreted by recourse to lay dictionaries in preference to field-specific dictionaries. Where a conflict of interpretation exists, the hierarchy of resolution shall be the express specification, references cited for propositions, incorporated references in general, academic literature in the field, commercial literature in the field, field-specific dictionaries, lay literature in the field, general purpose dictionaries, and common understanding. Where the issue of interpretation of claim amendments arises, the hierarchy is modified to include arguments made during the prosecution and accepted without retained recourse which are consistent with the disclosure.

### BACKGROUND OF THE INVENTION

Spatialized audio is well known, and relies on directing distinct sounds to a listener's ears to emulate discrete sound sources in a listening area. In the case of headphones, which directly isolate the ears, the technology relies on various delays, frequency equalization, etc., to create the effect. In an open space, however, arrays of speakers are provided which are controlled to direct individual “beams” or wavefronts to the respective ears, and can do so for multiple listeners in the same room or environment.

One issue for open space spatialization, where the location and orientation of the head is unconstrained, is determining the location of a listener's ears. More generally, the spatialized audio is dependent on a head-related transfer function (HRTF) that defines not only the location and orientation of a listener's ears, but also (in well developed models) the effects of the head between the ears and the pinnae. See, en.wikipedia.org/wiki/Head-related_transfer_function; pressbooks.umn.edu/sensationandperception/chapter/head-related-transfer-function/, Hofman, P., Van Riswick, J. & Van Opstal, A. Relearning sound localization with new ears. Nat Neurosci 1, 417-421 (1998). doi.org/10.1038/1633; Brungart D S. Informational and energetic masking effects in the perception of two simultaneous talkers. J Acoust Soc Am. 2001 March; 109(3):1101-9. doi: 10.1121/1.1345696. PMID: 11303924; Blauert, J. (1997). Spatial hearing: The psychophysics of human sound localization. MIT press. books.google.com/books/about/Spatial_Hearing.html?id=ApMeAQAAIAAJ; Wightman F L, Kistler D J. Resolution of front-back ambiguity in spatial hearing by listener and source movement. J Acoust Soc Am. 1999 May; 105(5):2841-53. doi: 10.1121/1.426899. PMID: 10335634; Barreto, Armando, and Navarun Gupta. “Dynamic modeling of the pinna for audio spatialization.” WSEAS Transactions on Acoustics and Music 1, no. 1 (2004): 77-82.

A head-related transfer function (HRTF) is a response that characterizes how an ear receives a sound from a point in space. As sound strikes the listener, the size and shape of the head, ears, ear canal, density of the head, size and shape of nasal and oral cavities, all transform the sound and affect how it is perceived, boosting some frequencies and attenuating others. In additional directionality, there are also spectral differences. A pair of HRTFs for two ears can be used to synthesize a binaural sound that seems to come from a particular point in space.

Humans estimate the location of a source by taking cues derived from one ear (monaural cues), and by comparing cues received at both ears (difference cues or binaural cues). Among the difference cues are time differences of arrival and intensity differences. The monaural cues come from the interaction between the sound source and the human anatomy, in which the original source sound is modified before it enters the ear canal for processing by the auditory system. These modifications encode the source location and may be captured via an impulse response which relates the source location and the ear location. This impulse response is termed the head-related impulse response (HRIR). Convolution of an arbitrary source sound with the HRIR converts the sound to that which would have been heard by the listener if it had been played at the source location, with the listener's ear at the receiver location. The HRTF is the Fourier transform of HRIR. The HRTF can also be described as the modifications to a sound from a direction in free air to the sound as it arrives at the eardrum. These modifications include the shape of the listener's outer ear, the shape of the listener's head and body, the acoustic characteristics of the space in which the sound is played, and so on. All these characteristics will influence how (or whether) a listener can accurately tell what direction a sound is coming from.

The HRTF describes how a given sound wave input (parameterized as frequency and source location) is filtered by the diffraction and reflection properties of the head, pinna, and torso, before the sound reaches the transduction machinery of the eardrum and inner ear (see auditory system). (It typically does not encompass conduction through the head). One method used to obtain the HRTF from a given source location is therefore to measure the head-related impulse response (HRIR), h(t), at the ear drum for the impulse A(t) placed at the source. The HRTF H(t) is the Fourier transform of the HRIR h(t).

Even when measured for a “dummy head” of idealized geometry, HRTF are complicated functions of frequency and the three spatial variables. For distances greater than 1 m from the head, however, the HRTF can be said to attenuate inversely with range. It is this far field HRTF, H(f, θ, φ), that has most often been measured. At closer range, the difference in level observed between the ears can grow quite large, even in the low-frequency region within which negligible level differences are observed in the far field.

While measurement of an actual HRTF for a person may be somewhat involved, and require specialized equipment, in many cases, a generic HRTF may be employed, with further specification of the location and orientation of the head with respect to the sound source(s). The inter-subject variability in the spectra of HRTFs has been studied through cluster analyses. So, R. H. Y., Ngan, B., Horner, A., Leung, K. L., Braasch, J. and Blauert, J. (2010) Toward orthogonal non-individualized head-related transfer functions for forward and backward directional sound: cluster analysis and an experimental study. Ergonomics, 53(6), pp. 767-781. The angle of a sound wave impinging on the pinna and ear canal results in diffractions and reflections to which the auditory system is quite sensitive, and which do differ between subjects. Accumulation of HRTF data has made it possible for a computer program to infer an approximate HRTF from head geometry. Two programs are known to do so, both open-source: Mesh2HRTF, which runs physical simulation on a full 3D-mesh of the head, and EAC, which uses a neural network trained from existing HRTFs and works from photo and other rough measurements. Ziegelwanger, H., and Kreuzer, W., Majdak, P. (2015). “Mesh2HRTF: An open-source software package for the numerical calculation of head-related transfer functions,” in Proceedings of the 22nd International Congress on Sound and Vibration, Florence, Italy; Carvalho, Davi (17 Apr. 2023). “EAC—Individualized HRTF Synthesis”. github.com/davircarvalho/Individualized_HRTF_Synthesis

Spatialized sound is useful for a range of applications, including virtual reality, augmented reality, and modified reality. Such systems generally consist of audio and video devices, which provide three-dimensional perceptual virtual audio and visual objects. A challenge to creation of such systems is how to update the audio signal processing scheme for a non-stationary listener, so that the listener perceives the intended sound image, and especially using a sparse transducer array.

A sound reproduction system that attempts to give a listener a sense of space seeks to make the listener perceive the sound coming from a position where no real sound source may exist. For example, when a listener sits in the “sweet spot” in front of a good two-channel stereo system, it is possible to present a virtual soundstage between the two loudspeakers. If two identical signals are passed to both loudspeakers facing the listener, the listener should perceive the sound as coming from a position directly in front of him or her. If the input is increased to one of the speakers, the virtual sound source will be deviated towards that speaker. This principle is called amplitude stereo, and it has been the most common technique used for mixing two-channel material ever since the two-channel stereo format was first introduced. However, amplitude stereo cannot itself create accurate virtual images outside the angle spanned by the two loudspeakers. In fact, even in between the two loudspeakers, amplitude stereo works well only when the angle spanned by the loudspeakers is 60 degrees or less.

Virtual source imaging systems work on the principle that they optimize the acoustic waves (amplitude, phase, delay) at the ears of the listener. A real sound source generates certain interaural time and level differences at the listener's ears that are used by the auditory system to localize the sound source. For example, a sound source to left of the listener will be louder, and arrive earlier, at the left ear than at the right. A virtual source imaging system is designed to reproduce these cues accurately. In practice, loudspeakers are used to reproduce a set of desired signals in the region around the listener's ears. The inputs to the loudspeakers are determined from the characteristics of the desired signals, and the desired signals must be determined from the characteristics of the sound emitted by the virtual source. Thus, a typical approach to sound localization is determining a HRTF which represents the binaural perception of the listener, along with the effects of the listener's head, and inverting the HRTF and the sound processing and transfer chain to the head, to produce an optimized “desired signal”. By defining the binaural perception as a spatialized sound, the acoustic emission may be optimized to produce that sound.

Typically, a single set of transducers only optimally delivers sound for a single head, and seeking to optimize for multiple listeners within a common listening area requires very high order phase cancellation so that sounds intended for one listener are effectively cancelled (or are present as unintelligible noise) at another listener. Outside of an anechoic chamber, accurate multiuser spatialization is difficult, unless headphones are employed.

Binaural technology is often used for the reproduction of virtual sound images. Binaural technology is based on the principle that if a sound reproduction system can generate the same sound pressures at the listener's eardrums as would have been produced there by a real sound source, then the listener should not be able to tell the difference between the virtual image and the real sound source. Therefore, a source must be distorted by a filter to achieve the natural transmission channel distortions.

A typical discrete surround-sound system, for example, assumes a specific speaker setup to generate the sweet spot, where the auditory imaging is stable and robust. However, not all areas can accommodate the proper specifications for such a system, further minimizing a sweet spot that is already small. For the implementation of binaural technology over loudspeakers, it is necessary to minimize or cancel the cross-talk that prevents a signal meant for one ear from being heard at the other. However, such cross-talk cancellation, normally realized by time-invariant filters, works only for a specific listening location and the sound field can only be controlled in the sweet-spot.

A digital sound projector is an array of transducers or loudspeakers that is controlled such that audio input signals are emitted in a controlled fashion within a space in front of the array. Often, the sound is emitted as a beam, directed in an arbitrary direction within the half-space in front of the array. By making use of carefully chosen reflection paths from room features, a listener will perceive a sound beam emitted by the array as if originating from the location of its last reflection. If the last reflection happens in a rear corner, the listener will perceive the sound as if emitted from a source behind him or her. However, human perception also involves echo processing, so that second and higher reflections should have physical correspondence to environments to which the listener is accustomed, or the listener may sense distortion. Thus, if one seeks a perception in a rectangular room that the sound is coming from the front left of the listener, the listener will expect a slightly delayed echo from behind, and a further second order reflection from another wall, each being acoustically colored by the properties of the reflective surfaces. One application of digital sound projectors is to replace conventional discrete surround-sound systems, which typically employ several separate loudspeakers placed at different locations around a listener's position. The digital sound projector, by generating beams for each channel of the surround-sound audio signal, and steering the beams into the appropriate directions, creates a true surround-sound at the listener's position without the need for further loudspeakers or additional wiring. One such system is described in U.S. Patent Publication No. 2009/0161880 of Hooley, et al., the disclosure of which is incorporated herein by reference.

Cross-talk cancellation is in a sense the ultimate sound reproduction problem, since an efficient cross-talk canceller gives one complete control over the sound field at a number of “target” positions. The objective of a cross-talk canceller is to reproduce a desired signal at a single target position while cancelling out the sound perfectly at all remaining target positions. The basic principle of cross-talk cancellation using only two loudspeakers and two target positions has been known for more than 30 years. Atal and Schroeder U.S. Pat. No. 3,236,949 used physical reasoning to determine how a cross-talk canceller comprising only two loudspeakers placed symmetrically in front of a single listener could work. In order to reproduce a short pulse at the left ear only, the left loudspeaker first emits a positive pulse. This pulse must be cancelled at the right ear by a slightly weaker negative pulse emitted by the right loudspeaker. This negative pulse must then be cancelled at the left ear by another even weaker positive pulse emitted by the left loudspeaker, and so on. Atal and Schroeder's model assumes free-field conditions. The influence of the listener's torso, head and outer ears on the incoming sound waves is ignored.

In order to control delivery of the binaural signals, or “target” signals, it is necessary to know how the listener's torso, head, and pinnae (outer ears) modify incoming sound waves as a function of the position of the sound source. This information can be obtained by making measurements on “dummy-heads” or human subjects. The results of such measurements are HRTFs. HRTFs may vary significantly between listeners, particularly at high frequencies. The large statistical variation in HRTFs between listeners is one of the main problems with virtual source imaging over headphones. Headphones offer good control over the reproduced sound. There is no “cross-talk” (the sound does not wrap around the head to the opposite ear), and the acoustical environment does not modify the reproduced sound (room reflections do not interfere with the direct sound). Unfortunately, however, when headphones are used, the virtual image is often perceived as being too close to the head, and sometimes even inside the head. This phenomenon is particularly difficult to avoid when one attempts to place the virtual image directly in front of the listener. Compensation is necessary for both the listener's own HRTFs and the response of the headphones. In addition, the whole sound stage moves with the listener's head (unless head-tracking and sound stage resynthesis is used, and this requires a significant amount of additional processing power). Spatialized Loudspeaker reproduction using linear transducer arrays, on the other hand, provides natural listening conditions but makes it necessary to compensate for cross-talk and also to consider the reflections from the acoustical environment.

Beamforming or spatial filtering is a signal processing technique used in sensor arrays for directional signal transmission or reception. This is achieved by combining elements in an antenna array in such a way that signals at particular angles experience constructive interference while others experience destructive interference. Beamforming can be used at both the transmitting and receiving ends in order to achieve spatial selectivity. The improvement compared with omnidirectional reception/transmission is known as the directivity of the array. Adaptive beamforming is used to detect and estimate the signal of interest at the output of a sensor array by means of optimal (e.g., least-squares) spatial filtering and interference rejection.

The Comhear “MyBeam” line array employs Digital Signal Processing (DSP) on identical, equally spaced, individually powered and perfectly phase-aligned speaker elements in a linear array to produce constructive and destructive interference. See, U.S. Pat. Nos. 9,578,440, 11,363,402, 11,750,997. The speakers are intended to be placed in a linear array parallel to the inter-aural axis of the listener, in front of the listener. The Mybeam speaker is active—it contains its own amplifiers and I/O and can be configured to include ambience monitoring for automatic level adjustment, and can adapt its beam forming focus to the distance of the listener. and operate in several distinct modalities, including binaural (transaural), single beam-forming optimized for speech and privacy, near field coverage, far field coverage, multiple listeners, etc. In binaural mode, operating in either near or far field coverage, Mybeam renders a normal PCM stereo music or video signal (compressed or uncompressed sources) with exceptional clarity, a very wide and detailed sound stage, excellent dynamic range, and communicates a strong sense of envelopment (the image musicality of the speaker is in part a result of sample-accurate phase alignment of the speaker array). Running at up to 96K sample rate, and 24-bit precision, the speakers reproduce Hi Res and HD audio with exceptional fidelity. When reproducing a PCM stereo signal of binaurally processed content, highly resolved 3D audio imaging is easily perceived. Height information as well as frontal 180-degree images are well-rendered and rear imaging is achieved for some sources. Reference form factors include 12 speaker, 10 speaker, and 8 speaker versions, in widths of ˜8 to 22 inches.

A spatialized sound reproduction system is disclosed in U.S. Pat. No. 5,862,227. This system employs z domain filters, and optimizes the coefficients of the filters H₁(z) and H₂(z) in order to minimize a cost function given by J=E[e₁²(n)+e₂²(n)], where E [symbol] is the expectation operator, and eₘ(n) represents the error between the desired signal and the reproduced signal at positions near the head. The cost function may also have a term which penalizes the sum of the squared magnitudes of the filter coefficients used in the filters H₁(z) and H₂(z) in order to improve the conditioning of the inversion problem.

Another spatialized sound reproduction system is disclosed in U.S. Pat. No. 6,307,941. Exemplary embodiments may use, any combination of (i) FIR and/or IIR filters (digital or analog), and (ii) spatial shift signals (e.g., coefficients) generated using any of the following methods: raw impulse response acquisition; balanced model reduction; Hankel norm modeling; least square modeling; modified or unmodified Prony methods; minimum phase reconstruction; Iterative Pre-filtering; or Critical Band Smoothing.

U.S. Pat. No. 9,215,544 relates to sound spatialization with multichannel encoding for binaural reproduction on two loudspeakers. A summing process from multiple channels is used to define the left and right speaker signals.

U.S. Pat. No. 7,164,768 provides a directional channel audio signal processor.

U.S. Pat. No. 8,050,433 provides an apparatus and method for canceling crosstalk between two-channel speakers and two ears of a listener in a stereo sound generation system.

U.S. Pat. Nos. 9,197,977 and 9,154,896 relate to a method and apparatus for processing audio signals to create “4D” spatialized sound, using two or more speakers, with multiple-reflection modelling.

ISO/IEC FCD 23003-2:200x, Spatial Audio Object Coding (SAOC), Coding of Moving Pictures And Audio, ISO/IEC JTC 1/SC 29/WG 11N10843, July 2009, London, UK, discusses stereo downmix transcoding of audio streams from an MPEG audio format. The transcoding is done in two steps: In one step the object parameters (OLD, NRG, IOC, DMG, DCLD) from the SAOC bitstream are transcoded into spatial parameters (CLD, ICC, CPC, ADG) for the MPEG Surround bitstream according to the information of the rendering matrix. In the second step the object downmix is modified according to parameters that are derived from the object parameters and the rendering matrix to form a new downmix signal.

Calculations of signals and parameters are done per processing band m and parameter time slot l. The input signals to the transcoder are the stereo downmix denoted as

$$X = {x}^{n , k} = ( \begin{matrix}{l}_{0}^{n , k} \\ {r}_{0}^{n , k}\end{matrix} ) .$$

The data that is available at the transcoder is the covariance matrix E, the rendering matrix Mᵣₑₙ, and the downmix matrix D. The covariance matrix E is an approximation of the original signal matrix multiplied with its complex conjugate transpose, SS*≈E, where S=s^{n,k}. The elements of the matrix E are obtained from the object OLDs and IOCs, eᵢⱼ=\sqrt{OLDᵢOLDⱼ}IOCᵢⱼ, where OLDᵢ^{l,m}=D_{OLD}(i,l,m) and IOCᵢⱼ^{l,m}=D_{IOC}(i,j,l,m). The rendering matrix Mᵣₑₙ of size 6×N determines the target rendering of the audio objects S through matrix multiplication Y=y^{n,k}=MᵣₑₙS. The downmix weight matrix D of size 2×N determines the downmix signal in the form of a matrix with two rows through the matrix multiplication X=DS.

The elements dᵢⱼ (i=1, 2; j=0 . . . N−1) of the matrix are obtained from the dequantized DCLD and DMG parameters

$$\begin{matrix}{d}_{1 j} = {10}^{0.05 {DMG}_{j}} \sqrt{\frac{{10}^{0.1 {DCLD}_{j}}}{1 + {10}^{0.1 {DCLD}_{j}}}} , \\ {d}_{2 j} = {10}^{0.05 {DMG}_{j}} \sqrt{\frac{1}{1 + {10}^{0.1 {DCLD}_{j}}}} ,\end{matrix}$$

where DMGⱼ=D_{DMG}(j,l) and DCLDⱼ=D_{DCLD}(j,l).

The transcoder determines the parameters for the MPEG Surround decoder according to the target rendering as described by the rendering matrix Mᵣₑₙ. The six-channel target covariance is denoted with F and given by F=YY*=MᵣₑₙS(MᵣₑₙS)*=Mᵣₑₙ(SS*)M*ᵣₑₙ=MᵣₑₙEM*ᵣₑₙ. The transcoding process can conceptually be divided into two parts. In one part a three-channel rendering is performed to a left, right, and center channel. In this stage the parameters for the downmix modification as well as the prediction parameters for the TTT box for the MPS decoder are obtained. In the other part the CLD and ICC parameters for the rendering between the front and surround channels (OTT parameters, left front—left surround, right front—right surround) are determined. The spatial parameters are determined that control the rendering to a left and right channel, consisting of front and surround signals. These parameters describe the prediction matrix of the TTT box for the MPS decoding C_{TTT} (CPC parameters for the MPS decoder) and the downmix converter matrix G. C_{TTT} is the prediction matrix to obtain the target rendering from the modified downmix \hat{x}=GX:C_{TTT}\hat{X}=C_{TTT}GX≈A₃S. A₃ is a reduced rendering matrix of size 3×N, describing the rendering to the left, right, and center channel, respectively. It is obtained as A₃=D₃₆Mᵣₑₙ with the 6 to 3 partial downmix matrix D₃₆ defined by

$${D}_{36} = [ \begin{matrix}{w}_{1} & 0 & 0 & 0 & {w}_{1} & 0 \\ 0 & {w}_{2} & 0 & 0 & 0 & {w}_{2} \\ 0 & 0 & {w}_{3} & {w}_{3} & 0 & 0\end{matrix} ] .$$

The partial downmix weights, wₚ, p=1, 2, 3 are adjusted such that the energy of wₚ(y₂ₚ₋₁+y₂ₚ) is equal to the sum of energies ∥y₂ₚ₋₁∥²+∥y₂ₚ∥² up to a limit factor:

$${w}_{1} = \frac{{f}_{1 , 1} + {f}_{5 , 5}}{{f}_{1 , 1} + {f}_{5 , 5} + 2 {f}_{1 , 5}} , {w}_{2} = \frac{{f}_{2 , 2} + {f}_{6 , 6}}{{f}_{2 , 2} + {f}_{6 , 6} + 2 {f}_{2 , 6}} , {w}_{3} = 0.5 ,$$

where f_{i,j} denote the elements of F. For the estimation of the desired prediction matrix C_{TTT} and the downmix preprocessing matrix G we define a prediction matrix C₃ of size 3×2, that leads to the target rendering C₃X≈A₃S. Such a matrix is derived by considering the normal equations C₃(DED*)≈A₃ED*.

The solution to the normal equations yields the best possible waveform match for the target output given the object covariance model. G and C_{TTT} are now obtained by solving the system of equations C_{TTT}G=C₃. To avoid numerical problems when calculating the term J=(DED*)⁻¹, J is modified. First the eigenvalues λ_{1,2} of J are calculated, solving det(J−λ_{1,2}I)=0. Eigenvalues are sorted in descending (λ₁≥λ₂) order and the eigenvector corresponding to the larger eigenvalue is calculated according to the equation above. It is assured to lie in the positive x-plane (first element has to be positive). The second eigenvector is obtained from the first by a −90 degrees rotation:

$$J = ( {v}_{1} {v}_{2} ) ( \begin{matrix}{λ}_{1} & 0 \\ 0 & {λ}_{2}\end{matrix} ) {( {v}_{1} {v}_{2} )}^{*} .$$

A weighting matrix W=(D·diag(C₃)) is computed from the downmix matrix D and the prediction matrix C₃. Since C_{TTT} is a function of the MPEG Surround prediction parameters c₁ and c₂ (as defined in ISO/IEC 23003-1:2007), C_{TTT}G=C₃ is rewritten in the following way, to find the stationary point or points of the function,

$$Γ ( \begin{matrix}{\tilde{c}}_{1} \\ {\tilde{c}}_{2}\end{matrix} ) = b , with Γ = ( {D}_{TTT} {C}_{3} ) {W ( {D}_{TTT} {C}_{3} )}^{*} and b = {GWC}_{3} v , where {D}_{TTT} ( \begin{matrix}1 & 0 & 1 \\ 0 & 1 & 1\end{matrix} )$$

and V=(1 1 −1). If Γ does not provide a unique solution (det(Γ)<10⁻³), the point is chosen that lies closest to the point resulting in a TTT pass through. As a first step, the row i of —F is chosen γ=[γ_{i,1} γ_{i,2}] where the elements contains most energy, thus γ_{i,1}²+γ_{i,2}²≥γ_{j,1}²+γ_{j,2}², j=1, 2. Then a solution is determined such that

$$( \begin{matrix}{\tilde{c}}_{1} \\ {\tilde{c}}_{2}\end{matrix} ) = ( \begin{matrix}1 \\ 1\end{matrix} ) - 3 y with y = \frac{{b}_{i , 3}}{( {\sum }_{j = 1 , 2} {( {γ}_{i , j} )}^{2} ) + ε} {γ}^{T} .$$

If the obtained solution for c̅₁ and c̅₂ is outside the allowed range for prediction coefficients that is defined as −2≤\tilde{c}ⱼ≤3 (as defined in ISO/IEC 23003-1:2007), \tilde{c}ⱼ are calculated as follows. First define the set of points, Xₚ as:

$${x}_{p} ∈ \{ \begin{matrix}( \begin{matrix}min ( 3 , max ( - 2 , \frac{- 2 {γ}_{12} - {b}_{1}}{{γ}_{11} + ε} ) ) \\ - 2\end{matrix} ) , & ( \begin{matrix}min ( 3 , max ( - 2 , \frac{3 {γ}_{12} - {b}_{1}}{{γ}_{11} + ε} ) ) \\ 3\end{matrix} ) \\ ( \begin{matrix}- 2 \\ min ( 3 , max ( - 2 , \frac{- 2 {γ}_{21} - {b}_{2}}{{γ}_{22} + ε} ) )\end{matrix} ) , & ( \begin{matrix}3 \\ min ( 3 , max ( - 2 , \frac{3 {γ}_{21} - {b}_{2}}{{γ}_{22} + ε} ) )\end{matrix} )\end{matrix} \} ,$$

and the distance function,

$$distFunc ( {x}_{p} ) = {x}_{p}^{*} Γ {x}_{p 1} - 2 {bx}_{p} .$$

Then the prediction parameters are defined according to:

$$( \begin{matrix}{\tilde{c}}_{1} \\ {\tilde{c}}_{2}\end{matrix} ) = arg {min}_{x ∈ {x}_{p}} ( distFunc ( x ) ) .$$

The prediction parameters are constrained according to: c₁=(1−λ)\tilde{c}₁+λγ₁, c₂(1−λ)\tilde{c}₂+λγ₂, where λ, γ₁ and γ₂ are defined as

$${γ}_{1} = \frac{2 {f}_{1 , 1} + 2 {f}_{5 , 5} - {f}_{3 , 3} + {f}_{1 , 3} + {f}_{5 , 3}}{2 {f}_{1 , 1} + 2 {f}_{5 , 5} + 2 {f}_{3 , 3} + 4 {f}_{1 , 3} + 4 {f}_{5 , 3}} , {γ}_{2} = \frac{2 {f}_{2 , 2} + 2 {f}_{6 , 6} - {f}_{3 , 3} + {f}_{2 , 3} + {f}_{6 , 3}}{2 {f}_{2 , 2} + 2 {f}_{6 , 6} + 2 {f}_{3 , 3} + 4 {f}_{2 , 3} + 4 {f}_{6 , 3}} , and$$

$$λ = {( \frac{{( {f}_{1 , 2} + {f}_{1 , 6} + {f}_{5 , 2} + {f}_{5 , 6} + {f}_{1 , 3} + {f}_{5 , 3} + {f}_{2 , 3} + {f}_{6 , 3} + {f}_{3 , 3} )}^{2}}{( {f}_{1 , 1} + {f}_{5 , 5} + {f}_{3 , 3} + 2 {f}_{1 , 3} + 2 {f}_{5 , 3} ) ( {f}_{2 , 2} + {f}_{6 , 6} + {f}_{3 , 3} + 2 {f}_{2 , 3} + 2 {f}_{6 , 3} )} )}^{8} .$$

For the MPS decoder, the CPCs are provided in the form D_{CPC_1}=c₁(l,m) and D_{CPC_2}=c₂(l,m). The parameters that determine the rendering between front and surround channels can be estimated directly from the target covariance matrix F

$$\begin{matrix}{CLD}_{a , b} = 10 {log}_{10} ( \frac{{f}_{a , a}}{{f}_{b , b}} ) , & {ICC}_{a , b} = \frac{{f}_{a , b}}{\sqrt{{f}_{a , a} {f}_{b , b}}}\end{matrix} ,$$

with (a,b)=(1,2) and (3,4).

The MPS parameters are provided in the form CLDₕ^{l,m}=D_{CLD}(h,l,m) and ICCₕ^{l,m}=D_{ICC}(h,l,m) for every OTT box h.

The stereo downmix X is processed into the modified downmix signal [symbol] : [symbol] =GX, where G=D_{TTT}C₃=D_{TTT}MᵣₑₙED*J. The final stereo output from the SAOC transcoder [symbol] is produced by mixing X with a decorrelated signal component according to: \hat{X}=G_{Mod}X+P₂X_{d}, where the decorrelated signal x_{d} is calculated as noted herein, and the mix matrices G_{Mod} and P₂ according to below.

First, define the render upmix error matrix as R=A_{diff}EA*_{diff}, where A_{diff}=D_{TTT}A₃−GD, and moreover define the covariance matrix of the predicted signal \hat{R} as

$$\hat{R} = ( \begin{matrix}{\hat{r}}_{11} & {\hat{r}}_{12} \\ {\hat{r}}_{21} & {\hat{r}}_{22}\end{matrix} ) = {GDED}^{*} {G}^{*} .$$

The gain vector g_{vec} can subsequently be calculated as:

$${g}_{vec} = ( \begin{matrix}min ( \sqrt{\frac{+ {r}_{11} + ε}{{r}_{11} + ε}} , 1.5 ) & min ( \sqrt{\frac{+ {r}_{22} + ε}{{r}_{22} + ε}} , 1.5 )\end{matrix} )$$

and the mix matrix G_{Mod} will be given as

$${G}_{Mod} = \{ \begin{matrix}diag ( {g}_{vec} ) G , & {r}_{12} > 0 , \\ G , & otherwise\end{matrix} .$$

Similarly, the mix matrix P₂ is given as:

$${P}_{2} = \{ \begin{matrix}( \begin{matrix}0 & 0 \\ 0 & 0\end{matrix} ) , & {r}_{12} > 0 , \\ {v}_{R} diag ( {W}_{d} ) , & otherwise\end{matrix} .$$

To derive v_{R} and w_{d}, the characteristic equation of R needs to be solved: det(R−λ_{1,2}I)=0, giving the eigenvalues, λ₁ and λ₂. The corresponding eigenvectors v_{R1} and v_{R2} of R can be calculated solving the equation system: (R−λ_{1,2}I)v_{R1,R2}=0. Eigenvalues are sorted in descending (λ₁≥λ₂) order and the eigenvector corresponding to the larger eigenvalue is calculated according to the equation above. It is assured to lie in the positive x-plane (first element has to be positive). The second eigenvector is obtained from the first by a −90 degrees rotation:

$$R = ( \begin{matrix}{v}_{R 1} & {v}_{R 2}\end{matrix} ) ( \begin{matrix}{λ}_{1} & 0 \\ 0 & {λ}_{2}\end{matrix} ) {( \begin{matrix}{v}_{R 1} & {v}_{R 2}\end{matrix} )}^{*} .$$

Incorporating P₁=(1 1)G, R_{d} can be calculated according to:

$${R}_{d} = ( \begin{matrix}{r}_{d 11} & {r}_{d 12} \\ {r}_{d 21} & {r}_{d 22}\end{matrix} ) = diag ( {P}_{1} ( {DED}^{*} ) {P}_{1}^{*} ) , \\ which gives : \{ \begin{matrix}{w}_{d 1} = min ( \sqrt{\frac{{λ}_{1}}{{r}_{d 1} + ε}} , 2 ) , \\ {w}_{d 2} = min ( \sqrt{\frac{{λ}_{2}}{{r}_{d 2} + ε}} , 2 ) ,\end{matrix} ,$$

and finally, the mix matrix,

$${P}_{2} = ( \begin{matrix}{v}_{R 1} & {v}_{R 2}\end{matrix} ) ( \begin{matrix}{w}_{d 1} & 0 \\ 0 & {w}_{d 2}\end{matrix} ) .$$

The decorrelated signals x_{d} are created from the decorrelator described in ISO/IEC 23003-1:2007. Hence, the decorrFunc( ) denotes the decorrelation process:

$${X}_{d} = ( \begin{matrix}{x}_{1 d} \\ {x}_{2 d}\end{matrix} ) = ( \begin{matrix}decorrFunc ( ( \begin{matrix}1 & 0\end{matrix} ) {P}_{1} X ) \\ decorrFunc ( ( \begin{matrix}0 & 1\end{matrix} ) {P}_{1} X )\end{matrix} ) .$$

The SAOC transcoder can let the mix matrices P₁, P₂ and the prediction matrix C₃ be calculated according to an alternative scheme for the upper frequency range. This alternative scheme is particularly useful for downmix signals where the upper frequency range is coded by a non-waveform preserving coding algorithm e.g. SBR in High Efficiency AAC. For the upper parameter bands, defined by bsTttBandsLow≤pb<numBands, P₁, P₂, and C₃ should be calculated according to the alternative scheme described below:

$$\{ \begin{matrix}{P}_{1} = ( \begin{matrix}0 & 0 \\ 0 & 0\end{matrix} ) , \\ {P}_{2} = G\end{matrix} .$$

Define the energy downmix and energy target vectors, respectively:

$$\{ \begin{matrix}{e}_{dmx} = ( \begin{matrix}{e}_{dmx 1} \\ {e}_{dmx 2}\end{matrix} ) = diag ( {DED}^{*} ) + ε I , \\ {e}_{tar} = ( \begin{matrix}{e}_{tar 1} \\ {e}_{tar 2} \\ {e}_{tar 3}\end{matrix} ) = diag ( {A}_{3} {EA}_{3}^{*} )\end{matrix} ,$$

and the help matrix

$$T = ( \begin{matrix}{t}_{11} & {t}_{12} \\ {t}_{21} & {t}_{22} \\ {t}_{31} & {t}_{32}\end{matrix} ) = {A}_{3} {D}^{*} + ε I .$$

Then calculate the gain vector

$$g = ( \begin{matrix}{g}_{1} \\ {g}_{2} \\ {g}_{3}\end{matrix} ) = ( \begin{matrix}\sqrt{\frac{{e}_{tar 1}}{{t}_{11}^{2} {e}_{dmx 1} + {t}_{12}^{2} {e}_{dmx 2}}} \\ \sqrt{\frac{{e}_{tar 2}}{{t}_{21}^{2} {e}_{dmx 1} + {t}_{22}^{2} {e}_{dmx 2}}} \\ \sqrt{\frac{{e}_{tar 3}}{{t}_{31}^{2} {e}_{dmx 1} + {t}_{32}^{2} {e}_{dmx 2}}}\end{matrix} ) ,$$

which finally gives the new prediction matrix

$${C}_{3} = ( \begin{matrix}{g}_{1} {t}_{11} & {g}_{1} {t}_{12} \\ {g}_{2} {t}_{21} & {g}_{2} {t}_{22} \\ {g}_{3} {t}_{31} & {g}_{3} {t}_{32}\end{matrix} ) .$$

For the decoder mode of the SAOC system, the output signal of the downmix preprocessing unit (represented in the hybrid QMF domain) is fed into the corresponding synthesis filterbank as described in ISO/IEC 23003-1:2007 yielding the final output PCM signal. The downmix preprocessing incorporates the mono, stereo and, if required, subsequent binaural processing.

The output signal \hat{x} is computed from the mono downmix signal X and the decorrelated mono downmix signal x_{d} as \hat{X}:=GX+P₂X_{d}. The decorrelated mono downmix signal x_{d} is computed as X_{d}=decorrFunc(X). In case of binaural output the upmix parameters G and P₂ derived from the SAOC data, rendering information Mᵣₑₙ^{l,m} and HRTF parameters are applied to the downmix signal X (and x_{d}) yielding the binaural output \hat{x}. The target binaural rendering matrix A^{l,m} of size 2×N consists of the elements a_{x,y}^{l,m}. Each element a_{x,y}^{l,m} is derived from HRTF parameters and rendering matrix Mᵣₑₙ^{l,m} with elements m_{i,y}^{l,m}. The target binaural rendering matrix A^{l,m} represents the relation between all audio input objects y and the desired binaural output.

$${a}_{1 , y}^{l , m} = {\sum }_{i = 0}^{{N}_{HRTF} - 1} {m}_{i , y}^{l , m} {P}_{i , L}^{m} exp ( j \frac{{ϕ}_{i}^{m}}{2} ) , \\ {a}_{2 , y}^{l , m} = {\sum }_{i = 0}^{{N}_{HRTF} - 1} {m}_{i , y}^{l , m} {P}_{i , R}^{m} exp ( - j \frac{{ϕ}_{i}^{m}}{2} ) .$$

The HRTF parameters are given by P_{i,L}ⁿ, P_{i,R}^{m}, and ϕᵢ^{m} for each processing band m. The spatial positions for which HRTF parameters are available are characterized by the index i. These parameters are described in ISO/IEC 23003-1:2007.

The upmix parameters G^{l,m} and P₂^{l,m} are computed as

$${G}^{l , m} = ( \begin{matrix}{P}_{L}^{l , m} exp ( j \frac{{ϕ}_{C}^{l , m}}{2} ) cos ( {β}^{l , m} + {α}^{l , m} ) \\ {P}_{R}^{l , m} exp ( - j \frac{{ϕ}_{C}^{l , m}}{2} ) cos ( {β}^{l , m} - {α}^{l , m} )\end{matrix} ) , \\ and {P}_{2}^{l , m} = ( \begin{matrix}{P}_{L}^{l , m} exp ( j \frac{{ϕ}_{C}^{l , m}}{2} ) sin ( {β}^{l , m} + {α}^{l , m} ) \\ {P}_{R}^{l , m} exp ( - j \frac{{ϕ}_{C}^{l , m}}{2} ) sin ( {β}^{l , m} - {α}^{l , m} )\end{matrix} ) .$$

The gains P_{L}^{l,m} and P_{R}^{l,m} for the left and right output channels are

$${P}_{L}^{l , m} = \sqrt{\frac{{f}_{1 , 1}^{l , m}}{{v}^{l , m}}} , and {P}_{R}^{l , m} = \sqrt{\frac{{f}_{2 , 2}^{l , m}}{{v}^{l , m}}} .$$

The desired covariance matrix F^{l,m} of size 2×2 with elements f_{i,j}^{l,m} is given as F^{l,m}=A^{l,m}E^{l,m}(A^{l,m})*. The scalar v^{l,m} is computed as v^{l,m}=d^{l}E^{l,m}(D^{l})*+ε. The downmix matrix D^{l} of size 1×N with elements dⱼ^{l} can be found as dⱼ^{l}=10^{0.005DMG}^{ⱼ}^{^{l}}.

The matrix E^{l,m} with elements eᵢⱼ^{l,m} are derived from the following relationship eᵢⱼ^{l,m}=\sqrt{OLDᵢ^{l,m}OLDⱼ^{l,m}}max(IOCᵢⱼ^{l,m},0). The inter channel phase difference ϕ_{C}^{l,m} is given as

$${ϕ}_{C}^{l , m} = \{ \begin{matrix}arg ( {f}_{1 , 2}^{l , m} ) , & 0 \leq m \leq 11 , & {ρ}_{C}^{l , m} \geq 0.6 , \\ 0 , & otherwise . & \end{matrix}$$

The inter channel coherence ρ_{C}^{l,m} is computed as

$${ρ}_{C}^{l , m} = min ( \frac{\vert {f}_{1 , 2}^{l , m} \vert}{\sqrt{{f}_{1 , 1}^{l , m} {f}_{2 , 2}^{l , m}}} , 1 ) .$$

The rotation angles α^{l,m} and β^{l,m} are given as

$${α}^{l , m} = \{ \begin{matrix}\frac{1}{2} arc cos ( {ρ}_{C}^{l , m} cos ( arg ( {f}_{1 , 2}^{l , m} ) ) ) , & 0 \leq m \leq 11 , & {ρ}_{C}^{l , m} < 0.6 , \\ \frac{1}{2} arc cos ( {ρ}_{C}^{l , m} ) , & otherwise . & \end{matrix} , \\ {β}^{l , m} = arc tan ( tan ( {α}^{l , m} ) \frac{{P}_{R}^{l , m} - {P}_{L}^{l , m}}{{P}_{L}^{l , m} + {P}_{R}^{l , m} + ε} ) .$$

In case of stereo output, the “x-1-b” processing mode can be applied without using HRTF information. This can be done by deriving all elements a_{x,y}^{l,m} of the rendering matrix A, yielding: a_{1,y}^{l,m}=m_{Lf,y}^{l,m}, a_{2,y}^{l,m}=m_{Rf,y}^{l,m}. In case of mono output the “x-1-2” processing mode can be applied with the following entries: a_{1,y}^{l,m}=m_{C,y}^{l,m}, a_{2,y}^{l,m}=0

In a stereo to binaural “x-2-b” processing mode, the upmix parameters G^{l,m} and P₂^{l,m} are computed as

$${G}^{l , m} = ( \begin{matrix}{P}_{L}^{l , m , 1} exp ( j \frac{{ϕ}^{l , m , 1}}{2} ) cos ( {β}^{l , m} + {α}^{l , m} ) & {P}_{L}^{l , m , 2} exp ( j \frac{{ϕ}^{l , m , 2}}{2} ) cos ( {β}^{l , m} + {α}^{l , m} ) \\ {P}_{R}^{l , m , 1} exp ( - j \frac{{ϕ}^{l , m , 1}}{2} ) cos ( {β}^{l , m} - {α}^{l , m} ) & {P}_{R}^{l , m , 2} exp ( - j \frac{{ϕ}^{l , m , 2}}{2} ) cos ( {β}^{l , m} - {α}^{l , m} )\end{matrix} ) , \\ {P}_{2}^{l , m} = ( \begin{matrix}{P}_{L}^{l , m} exp ( j \frac{arg ( {c}_{12}^{l , m} )}{2} ) sin ( {β}^{l , m} + {α}^{l , m} ) \\ {P}_{R}^{l , m} exp ( - j \frac{arg ( {c}_{12}^{l , m} )}{2} ) sin ( {β}^{l , m} - {α}^{l , m} )\end{matrix} ) .$$

The corresponding gains P_{L}^{l,m,x}, P_{R}^{l,m,x}, and P_{L}^{l,m}, P_{R}^{l,m} for the left and right output channels are

$${P}_{L}^{l , m , x} = \sqrt{\frac{{f}_{1 , 1}^{l , m , x}}{{v}^{l , m , x}}} , {P}_{R}^{l , m , x} = \sqrt{\frac{{f}_{2 , 2}^{l , m , x}}{{v}^{l , m , x}}} , {P}_{L}^{l , m} = \sqrt{\frac{{c}_{1 , 1}^{l , m}}{{v}^{l , m}}} , {P}_{R}^{l , m} = \sqrt{\frac{{c}_{2 , 2}^{l , m}}{{v}^{l , m}}} .$$

The desired covariance matrix F^{l,m,x} of size 2×2 with elements f_{u,v}^{l,m,x} is given as F^{l,m,x}=A^{l,m}E^{l,m,x}(A^{l,m})*. The covariance matrix C^{l,m} of size 2×2 with elements c_{u,v}^{l,m} of the dry binaural signal is estimated as C^{l,m}=\tilde{G}^{l,m}D^{l}E^{l,m}(D^{l})*(\tilde{G}^{l,m})*, where

$${\tilde{G}}^{l , m} = ( \begin{matrix}{P}_{L}^{l , m , 1} exp ( j \frac{{ϕ}^{l , m , 1}}{2} ) & {P}_{L}^{l , m , 2} exp ( j \frac{{ϕ}^{l , m , 2}}{2} ) \\ {P}_{R}^{l , m , 1} exp ( - j \frac{{ϕ}^{l , m , 1}}{2} ) & {P}_{R}^{l , m , 2} exp ( - j \frac{{ϕ}^{l , m , 2}}{2} )\end{matrix} ) .$$

The corresponding scalars v^{l,m,x} and v^{l,m} are computed as v^{l,m,x}=D^{l,x}E^{l,m}(D^{l,x})*+ε,

$${v}^{l , m} = ( {D}^{l , 1} + {D}^{l , 2} ) {{E}^{l , m} ( {D}^{l , 1} + {D}^{l , 2} )}^{*} + ε .$$

The downmix matrix D^{l,x} of size 1×N with elements dᵢ^{l,x} can be found as

$${d}_{i}^{l , 1} = {10}^{0.05 {DMG}_{i}^{l}} \sqrt{\frac{{10}^{0.1 {DCLD}_{i}^{l}}}{1 + {10}^{0.1 {DCLD}_{i}^{l}}}} , {d}_{i}^{l , 2} = {10}^{0.05 {DMG}_{i}^{l}} \sqrt{\frac{1}{1 + {10}^{0.1 {DCLD}_{i}^{l}}}} .$$

The stereo downmix matrix D^{l} of size 2×N with elements d_{x,j}^{l} can be found as d_{x,i}^{l}=dᵢ^{l,x}.

The matrix E^{l,m},x with elements eᵢⱼ^{l,m,x} are derived from the following relationship

$${e}_{ij}^{l , m , x} = {e}_{ij}^{l , m} ( \frac{{d}_{i}^{l , x}}{{d}_{i}^{l , 1} + {d}_{i}^{l , 2}} ) ( \frac{{d}_{j}^{l , x}}{{d}_{j}^{l , 1} + {d}_{j}^{l , 2}} ) .$$

The matrix E^{l,m} with elements eᵢⱼ^{l,m} are given as eᵢⱼ^{l,m}=\sqrt{OLDᵢ^{l,m}OLDⱼ^{l,m}}max(IOCᵢⱼ^{l,m},0). The inter channel phase differences ϕ_{C}^{l,m} are given as

$${ϕ}^{l , m , x} = \{ \begin{matrix}arg ( {f}_{1 , 2}^{l , m , x} ) , & 0 \leq m \leq 11 , & {ρ}_{C}^{l , m} > 0.6 , \\ 0 , & otherwise . & \end{matrix}$$

The ICCs ρ_{C}^{l,m} and ρ_{R}^{l,m} are computed as

$${ρ}_{T}^{l , m} = min ( \frac{\vert {f}_{1 , 2}^{l , m} \vert}{\sqrt{{f}_{1 , 1}^{l , m} {f}_{2 , 2}^{l , m}}} , 1 ) , {ρ}_{c}^{l , m} = min ( \frac{\vert {c}_{12}^{l , m} \vert}{\sqrt{{c}_{11}^{l , m} - {c}_{22}^{l , m}}} , 1 ) .$$

The rotation angles α^{l,m} and β^{l,m} are given as

$${α}^{l , m} = \frac{1}{2} ( arc cos ( {ρ}_{T}^{l , m} ) - arc cos ( {ρ}_{C}^{l , m} ) ) , {β}^{l , m} = arc tan ( tan ( {α}^{l , m} ) \frac{{P}_{R}^{l , m} - {P}_{L}^{l , m}}{{P}_{L}^{l , m} + {P}_{R}^{l , m}} ) .$$

In case of stereo output, the stereo preprocessing is directly applied as described above. In case of mono output, the MPEG SAOC system the stereo preprocessing is applied with a single active rendering matrix entry

$${M}_{ren}^{l , m} = ( {m}_{0 , Lf}^{l , m} , … , {m}_{N - 1 , Lf}^{l , m} ) .$$

The audio signals are defined for every time slot n and every hybrid subband k. The corresponding SAOC parameters are defined for each parameter time slot l and processing band m. The subsequent mapping between the hybrid and parameter domain is specified by Table A.31, ISO/IEC 23003-1:2007. Hence, all calculations are performed with respect to the certain time/band indices and the corresponding dimensionalities are implied for each introduced variable. The OTN/TTN upmix process is represented either by matrix M for the prediction mode or M_{Energy} for the energy mode. In the first case M is the product of two matrices exploiting the downmix information and the CPCs for each EAO channel. It is expressed in “parameter-domain” by M=A\tilde{D}⁻¹C, where \tilde{D}⁻¹ is the inverse of the extended downmix matrix \tilde{D} and C implies the CPCs. The coefficients mⱼ and nⱼ of the extended downmix matrix \tilde{D} denote the downmix values for every EAO j for the right and left downmix channel as mⱼ=d_{l,EAO(j)}, nj=d_{2,EAO(j)}.

In case of stereo, the extended downmix matrix \tilde{D} is

$$\tilde{D} = ( \begin{matrix}1 & 0 & {m}_{0} & … & {m}_{{N}_{EAO} - 1} \\ 0 & 1 & {n}_{0} & … & {n}_{{N}_{EAO} - 1} \\ {m}_{0} & {n}_{0} & - 1 & … & 0 \\ ⋮ & ⋮ & 0 & ⋱ & ⋮ \\ {m}_{{N}_{EAO} - 1} & {n}_{{N}_{EAO} - 1} & 0 & … & - 1\end{matrix} ) ,$$

and for a mono, it becomes

$$\tilde{D} = ( \begin{matrix}1 & {m}_{0} & … & {m}_{{N}_{EAO} - 1} \\ 1 & {n}_{0} & … & {n}_{{N}_{EAO} - 1} \\ {m}_{0} + {n}_{0} & - 1 & … & 0 \\ ⋮ & 0 & ⋱ & ⋮ \\ {m}_{{N}_{EAO} - 1} + {n}_{{N}_{EAO} - 1} & 0 & … & - 1\end{matrix} ) .$$

With a stereo downmix, each EAO j holds two CPCs c_{j,0} and c_{j,1} yielding matrix C

$$C = ( \begin{matrix}1 & 0 & 0 & ⋯ & 0 \\ 0 & 1 & 0 & ⋯ & 0 \\ {c}_{0 , 0} & {c}_{0 , 1} & 1 & ⋯ & 0 \\ ⋮ & ⋮ & ⋮ & ⋱ & ⋮ \\ {c}_{{N}_{EAO} - 1 , 0} & {c}_{{N}_{EAO} - 1 , 1} & 0 & ⋯ & 1\end{matrix} ) .$$

The CPCs are derived from the transmitted SAOC parameters, i.e., the OLDs, IOCs, DMGs and DCLDs. For one specific EAO channel j=0 . . . N_{EAO}−1 the CPCs can be estimated by

$${\tilde{c}}_{j , 0} = \frac{{P}_{LoCo , j} {P}_{Ro} - {P}_{RoCo , j} {P}_{LoRo}}{{P}_{Lo} {P}_{Ro} - {P}_{LoRo}^{2}} , {\tilde{c}}_{j , 1} = \frac{{P}_{RoCo , j} {P}_{Lo} - {P}_{LoCo , j} {P}_{LoRo}}{{P}_{Lo} {P}_{Ro} - {P}_{LoRo}^{2}} .$$

In the following description of the energy quantities P_{Lo}, P_{Ro}, P_{LoRo}, P_{LoCo,j}, and P_{RoCo,j}.

$${P}_{Lo} = {OLD}_{L} + {\sum }_{j = 0}^{{N}_{EAO} - 1} {\sum }_{k = 0}^{{N}_{EAO} - 1} {m}_{j} {m}_{k} {e}_{j , k} , {P}_{Ro} = {OLD}_{R} + {\sum }_{j = 0}^{{N}_{EAO} - 1} {\sum }_{k = 0}^{{N}_{EAO} - 1} {n}_{j} {n}_{k} {e}_{j , k} , {P}_{LoRo} = {e}_{L , R} + {\sum }_{j = 0}^{{N}_{EAO} - 1} {\sum }_{k = 0}^{{N}_{EAO} - 1} {m}_{j} {n}_{k} {e}_{j , k} ,$$

$${P}_{LoCo , j} = {m}_{j} {OLD}_{L} + {n}_{j} {e}_{L , R} - {m}_{j} {OLD}_{j} - {\sum }_{\begin{matrix}i = 0 \\ i \neq j\end{matrix}}^{{N}_{EAO} - 1} {m}_{i} {e}_{i , j} , {P}_{RoCo , j} = {n}_{j} {OLD}_{R} + {m}_{j} {e}_{L , R} - {n}_{j} {OLD}_{j} - {\sum }_{\begin{matrix}i = 0 \\ i \neq j\end{matrix}}^{{N}_{EAO} - 1} {n}_{i} {e}_{i , j} .$$

The parameters OLD_{L}, OLD_{R}, and IOC_{LR} correspond to the regular objects and can be derived using downmix information:

$${OLD}_{L} = {\sum }_{i = 0}^{N - {N}_{EAO} - 1} {d}_{0 , i}^{2} {OLD}_{i} , {OLD}_{R} = {\sum }_{i = 0}^{N - {N}_{EAO} - 1} {d}_{1 , i}^{2} {OLD}_{i} , {IOC}_{LR} = \{ \begin{matrix}{IOC}_{0 , 1} , & N - {N}_{EAO} = 2 , \\ 0 , & otherwise .\end{matrix}$$

The CPCs are constrained by the subsequent limiting functions:

$${γ}_{j , 1} = \frac{{m}_{j} {OLD}_{L} + {n}_{j} {e}_{L , R} - {\sum }_{i = 0}^{{N}_{EAO} - 1} {m}_{i} {e}_{i , j}}{2 ( {OLD}_{L} + {\sum }_{i = 0}^{{N}_{EAO} - 1} {\sum }_{k = 0}^{{N}_{EAO} - 1} {m}_{i} {m}_{k} {e}_{i , k} )} ,$$

$${γ}_{j , 2} = \frac{{n}_{j} {OLD}_{R} + {m}_{j} {e}_{L , R} - {\sum }_{i = 0}^{{N}_{EAO} - 1} {n}_{i} {e}_{i , j}}{2 ( {OLD}_{R} + {\sum }_{i = 0}^{{N}_{EAO} - 1} {\sum }_{k = 0}^{{N}_{EAO} - 1} {n}_{i} {n}_{k} {e}_{i , k} )} .$$

With the weighting factor

$$λ = {( \frac{{P}_{LoRo}^{2}}{{P}_{Lo} {P}_{Ro}} )}^{8} .$$

The constrained CPCs become c_{j,0}=(1−λ)\tilde{c}_{j,0}+λγ_{j,0}, c_{j,1}=(1−λ)\tilde{c}_{j,1}+λγ_{j,1}.

The output of the TTN element yields

$$Y = ( \begin{matrix}{y}_{L} \\ \frac{{y}_{R}}{{y}_{0 , EAO}} \\ ⋮ \\ {y}_{{N}_{EAO} - 1 , EAO}\end{matrix} ) = MX = A {\tilde{D}}^{- 1} C ( \begin{matrix}{I}_{0} \\ \frac{{r}_{0}}{{res}_{0}} \\ ⋮ \\ {res}_{{N}_{EAO} - 1}\end{matrix} ) ,$$

where X represents the input signal to the SAOC decoder/transcoder.

In case of a stereo, the extended downmix matrix \tilde{D} matrix is

$$\tilde{D} = ( \begin{matrix}1 & 1 & {m}_{0} & ⋯ & {m}_{{N}_{EAO} - 1} \\ {m}_{0} / 2 & {m}_{0} / 2 & - 1 & ⋯ & 0 \\ ⋮ & ⋮ & 0 & ⋱ & ⋮ \\ {m}_{{N}_{EAO} - 1} / 2 & {m}_{{N}_{EAO} - 1} / 2 & 0 & ⋯ & - 1\end{matrix} ) ,$$

and for a mono, it becomes

$$\tilde{D} = ( \begin{matrix}1 & {m}_{0} & ⋯ & {m}_{{N}_{EAO} - 1} \\ {m}_{0} & - 1 & ⋯ & 0 \\ ⋮ & 0 & ⋱ & ⋮ \\ {m}_{{N}_{EAO} - 1} & 0 & ⋯ & - 1\end{matrix} ) .$$

With a mono downmix, one EAO j is predicted by only one coefficient cⱼ yielding

$$C = ( \begin{matrix}1 & 0 & ⋯ & 0 \\ {c}_{0} & 1 & ⋯ & 0 \\ ⋮ & 0 & ⋱ & ⋮ \\ {c}_{{N}_{EAO} - 1} & 0 & ⋯ & 1\end{matrix} ) .$$

All matrix elements cⱼ are obtained from the SAOC parameters according to the relationships provided above. For the mono downmix case the output signal Y of the OTN element yields:

$$Y = M ( \begin{matrix}\frac{{d}_{0}}{{res}_{0}} \\ ⋮ \\ {res}_{{N}_{EAO} - 1}\end{matrix} ) .$$

In case of a stereo, the matrix M_{Energy} are obtained from the corresponding OLDs according to:

$${M}_{Energy} = A ( \begin{matrix}\sqrt{\frac{{OLD}_{L}}{{OLD}_{L} + {\sum }_{i = 0}^{{N}_{EAO} - 1} {m}_{i}^{2} {OLD}_{i}}} & 0 \\ 0 & \sqrt{\frac{{OLD}_{R}}{{OLD}_{R} + {\sum }_{i = 0}^{{N}_{EAO} - 1} {n}_{i}^{2} {OLD}_{i}}} \\ \sqrt{\frac{{m}_{0}^{2} {OLD}_{0}}{{OLD}_{L} + {\sum }_{i = 0}^{{N}_{EAO} - 1} {m}_{i}^{2} {OLD}_{i}}} & \sqrt{\frac{{n}_{0}^{2} {OLD}_{0}}{{OLD}_{R} + {\sum }_{i = 0}^{{N}_{EAO} - 1} {n}_{i}^{2} {OLD}_{i}}} \\ ⋮ & ⋮ \\ \sqrt{\frac{{m}_{{N}_{EAO} - 1}^{2} {OLD}_{{N}_{EAO} - 1}}{{OLD}_{L} + {\sum }_{i = 0}^{{N}_{EAO} - 1} {m}_{i}^{2} {OLD}_{i}}} & \sqrt{\frac{{n}_{{N}_{EAO} - 1}^{2} {OLD}_{{N}_{EAO} - 1}}{{OLD}_{R} + {\sum }_{i = 0}^{{N}_{EAO} - 1} {n}_{i}^{2} {OLD}_{i}}}\end{matrix} ) .$$

The output of the TTN element yields:

$$Y = ( \begin{matrix}{y}_{L} \\ \frac{{y}_{R}}{{y}_{0 , EAO}} \\ ⋮ \\ {y}_{{N}_{EAO} - 1 , EAO}\end{matrix} ) = {M}_{Energy} X = {M}_{Energy} ( \begin{matrix}{I}_{0} \\ {r}_{0}\end{matrix} ) .$$

The adaptation of the equations for the mono signal results in

$${M}_{Energy} = A ( \begin{matrix}\sqrt{\frac{{OLD}_{L}}{{OLD}_{L} + {\sum }_{i = 0}^{{N}_{EAO} - 1} {m}_{i}^{2} {OLD}_{i}}} & \sqrt{\frac{{OLD}_{L}}{{OLD}_{L} + {\sum }_{i = 0}^{{N}_{EAO} - 1} {n}_{i}^{2} {OLD}_{i}}} \\ \sqrt{\frac{{m}_{0}^{2} {OLD}_{0}}{{OLD}_{L} + {\sum }_{i = 0}^{{N}_{EAO} - 1} {m}_{i}^{2} {OLD}_{i}}} & \sqrt{\frac{{n}_{0}^{2} {OLD}_{0}}{{OLD}_{L} + {\sum }_{i = 0}^{{N}_{EAO} - 1} {n}_{i}^{2} {OLD}_{i}}} \\ ⋮ & ⋮ \\ \sqrt{\frac{{m}_{{N}_{EAO} - 1}^{2} {OLD}_{{N}_{EAO} - 1}}{{OLD}_{L} + {\sum }_{i = 0}^{{N}_{EAO} - 1} {m}_{i}^{2} {OLD}_{i}}} & \sqrt{\frac{{n}_{{N}_{EAO} - 1}^{2} {OLD}_{{N}_{EAO} - 1}}{{OLD}_{L} + {\sum }_{i = 0}^{{N}_{EAO} - 1} {n}_{i}^{2} {OLD}_{i}}}\end{matrix} ) .$$

The output of the TTN element yields:

$$Y = ( \begin{matrix}\frac{{y}_{L}}{{y}_{0 , EAO}} \\ ⋮ \\ {y}_{{N}_{EAO} - 1 , EAO}\end{matrix} ) = {M}_{Energy} X = {M}_{Energy} ( \begin{matrix}{I}_{0} \\ {r}_{0}\end{matrix} ) .$$

The corresponding OTN matrix M_{Energy} for the stereo case can be derived as:

$${M}_{Energy} = A ( \frac{1}{\sqrt{{OLD}_{L} + {\sum }_{i = 0}^{{N}_{EAO} - 1} {m}_{i}^{2} {OLD}_{i}}} + \frac{1}{\sqrt{{OLD}_{R} + {\sum }_{i = 0}^{{N}_{EAO} - 1} {n}_{i}^{2} {OLD}_{i}}} ) ( \begin{matrix}\sqrt{{OLD}_{L}} \\ \sqrt{{OLD}_{R}} \\ \\ \sqrt{{m}_{0}^{2} {OLD}_{0}} + \sqrt{{n}_{0}^{2} {OLD}_{0}} \\ ⋮ \\ \sqrt{{m}_{{N}_{EAO} - 1}^{2} {OLD}_{{N}_{EAO} - 1}} + \sqrt{{n}_{{N}_{EAO} - 1}^{2} {OLD}_{{N}_{EAO} - 1}}\end{matrix} ) ,$$

hence the output signal Y of the OTN element yields: Y=M_{Energy}d₀.

For the mono case the OTN matrix M_{Energy} reduces to:

$${M}_{Energy} = A \frac{1}{\sqrt{{OLD}_{L} + {\sum }_{i = 0}^{{N}_{EAO} - 1} {m}_{i}^{2} {OLD}_{i}}} ( \begin{matrix}\sqrt{{OLD}_{L}} \\ \\ \sqrt{{m}_{0}^{2} {OLD}_{0}} \\ ⋮ \\ \sqrt{{m}_{{N}_{EAO} - 1}^{2} {OLD}_{{N}_{EAO} - 1}}\end{matrix} ) .$$

Requirements for acoustically simulating a concert hall or other listening space are considered in Julius O. Smith III, Physical Audio Signal Processing for Virtual Musical Instruments And Audio Effects, Center for Computer Research in Music and Acoustics (CCRMA), Dept. Music, Stanford University, December 2008.

The response is considered at one or more discrete listening points in space (“ears”) due to one or more discrete point sources of acoustic energy. The direct signal propagating from a sound source to a listener's ear can be simulated using a single delay line in series with an attenuation scaling or lowpass filter. (Such a model of amplitude and phase response fails to account for directionality, though this may be included in more complex models). Each sound ray arriving at the listening point via one or more reflections can be simulated using a delay-line and some scale factor (or filter). Two rays create a feedforward comb filter. More generally, a tapped delay line FIR filter can simulate many reflections. Each tap brings out one echo at the appropriate delay and gain, and each tap can be independently filtered to simulate air absorption and lossy reflections. In principle, tapped delay lines can accurately simulate any reverberant environment, because reverberation really does consist of many paths of acoustic propagation from each source to each listening point. Tapped delay lines are expensive computationally relative to other techniques, and handle only one “point to point” transfer function, i.e., from one point-source to one ear, and are dependent on the physical environment. In general, the filters should also include filtering by the pinnae of the ears, so that each echo can be perceived as coming from the correct angle of arrival in 3D space; in other words, at least some reverberant reflections should be spatialized so that they appear to come from their natural directions in 3D space. Again, the filters change if anything changes in the listening space, including source or listener position. The basic architecture provides a set of signals, s₁(n), s₂(n), s₃(n), . . . that feed set of filters (h₁₁, h₁₂, h₁₃), (h₂₁, h₂₂, h₂₃), . . . which are then summed to form composite signals y₁(n), y₂(n), representing signals for two ears. Each filter hᵢⱼ can be implemented as a tapped delay line FIR filter. In the frequency domain, it is convenient to express the input-output relationship in terms of the transfer-function matrix:

$$[ \begin{matrix}{Y}_{1} ( z ) \\ {Y}_{2} ( z )\end{matrix} ] = [ \vert \begin{matrix}{H}_{11} ( z ) & {H}_{12} ( z ) & {H}_{13} ( z ) \\ {H}_{21} ( z ) & {H}_{22} ( z ) & {H}_{23} ( z )\end{matrix} ] [ \begin{matrix}{S}_{1} ( z ) \\ {S}_{2} ( z ) \\ {S}_{3} ( z )\end{matrix} ]$$

Denoting the impulse response of the filter from source j to ear i by hᵢⱼ(n), the two output signals are computed by six convolutions:

$${y}_{i} ( n ) = {\sum }_{j = 1}^{3} {s}_{j} * {h}_{ij} ( n ) = {\sum }_{j = 1}^{3} {\sum }_{m = 0}^{{M}_{ij}} {s}_{j} ( m ) {h}_{ij} ( n - m ) , i = 1 , 2 ,$$

where Mᵢⱼ denotes the order of FIR filter hᵢⱼ. Since many of the filter coefficients h(n) are zero (at least for small n), it is more efficient to implement them as tapped delay lines so that the inner sum becomes sparse. For greater accuracy, each tap may include a lowpass filter which models air absorption and/or spherical spreading loss. For large n, the impulse responses are not sparse, and must either be implemented as very expensive FIR filters, or limited to approximation of the tail of the impulse response using less expensive IIR filters.

For music, a typical reverberation time is on the order of one second. At an audio sampling rate of 50 kHz, each filter requires 50,000 multiplies and additions per sample per second, or 2.5 billion multiply-adds per second. Handling three sources and two listening points (ears), we reach 30 billion operations per second for the reverberator. While these numbers can be improved using FFT convolution instead of direct convolution (at the price of introducing a throughput delay which can be a problem for real-time systems), it remains the case that exact implementation of all relevant point-to-point transfer functions in a reverberant space is very expensive computationally. It may not be necessary for acceptable results. While a tapped delay line FIR filter can provide an accurate model for any point-to-point transfer function in a reverberant environment, it is rarely used for this purpose in practice because of the extremely high computational expense. While there are specialized commercial products that implement reverberation via direct convolution of the input signal with the impulse response, the great majority of artificial reverberation systems use other methods to synthesize the late reverb more economically.

One disadvantage of the point-to-point transfer function model is that some or all of the filters must change when anything moves. If instead the computational model was of the whole acoustic space, sources and listeners could be moved as desired without affecting the underlying room simulation (though the interaction of the dynamically moving sources and listeners may require consideration in the model). Furthermore, we could use “virtual dummy heads” as listeners, complete with pinnae filters, so that all of the 3D directional aspects of reverberation could be captured in two extracted signals for the ears. Thus, there are compelling reasons to consider a full 3D model of a desired acoustic listening space. Let us briefly estimate the computational requirements of a “brute force” acoustic simulation of a room. It is generally accepted that audio signals require a 20 kHz bandwidth. Since sound travels at about a foot per millisecond, a 20 kHz sinusoid has a wavelength on the order of 1/20 feet, or about half an inch. Since, by elementary sampling theory, we must sample faster than twice the highest frequency present in the signal, we need “grid points” in our simulation separated by a quarter inch or less. At this grid density, simulating an ordinary 12′×12′×8′ room in a home requires more than 100 million grid points. Using finite-difference or waveguide-mesh techniques, the average grid point can be implemented as a multiply-free computation; however, since it has waves coming and going in six spatial directions, it requires on the order of 10 additions per sample. Thus, running such a room simulator at an audio sampling rate of 50 kHz requires on the order of 50 billion additions per second, which is comparable to the three-source, two-ear simulation. It is noted that, especially where the calculations are amenable to parallel implementations, co-called General Purpose Graphics Processing Unit (GPGPU) technology, which is implemented using single instruction-multiple data (SIMD) processors, can achieve these levels of performance. For example, an nVidia RTX 4090 can achieve 82.6 TFLOPS, and an AMD RX 7600 can achieve 21.5 TFLOPS, en.wikipedia.org/wiki/Floating_point_operations_per_second, while an nVidia A100 can achieve 312 TFLOPS. www.nvidia.com/en-us/data-center/h100/; www.nvidia.com/content/dam/en-zz/Solutions/Data-Center/a100/pdf/nvidia-a100-datasheet-us-nvidia-1758950-r4-web.pdf; Kushwaha, Saksham Singh, Jianbo Ma, Mark RP Thomas, Yapeng Tian, and Avery Bruni. “Diff-SAGe: End-to-End Spatial Audio Generation Using Diffusion Models.” arXiv preprint arXiv:2410.11299 (2024); www.researchgate.net/publication/329045073_Spatial_Audio_Modelling_to_Provide_Artificially_Intelligent_Characters_with_Realistic_Sound_Perception. Therefore, these levels of performance are available in commercial products.

Based on limits of perception, the impulse response of a reverberant room can be divided into two segments. The first segment, called the early reflections, consists of the relatively sparse first echoes in the impulse response. The remainder, called the late reverberation, is so densely populated with echoes that it is best to characterize the response statistically in some way. Similarly, the frequency response of a reverberant room can be divided into two segments. The low-frequency interval consists of a relatively sparse distribution of resonant modes, while at higher frequencies the modes are packed so densely that they are best characterized statistically as a random frequency response with certain (regular) statistical properties. The early reflections are a particular target of spatialization filters, so that the echoes come from the right directions in 3D space. It is known that the early reflections have a strong influence on spatial impression, i.e., the listener's perception of the listening-space shape.

A lossless prototype reverberator has all of its poles on the unit circle in the z plane, and its reverberation time is infinity. To set the reverberation time to a desired value, we need to move the poles slightly inside the unit circle. Furthermore, we want the high-frequency poles to be more damped than the low-frequency poles. This type of transformation can be obtained using the substitution z⁻¹←G(z)z⁻¹, where G(z) denotes the filtering per sample in the propagation medium (a lowpass filter with gain not exceeding 1 at all frequencies). Thus, to set the reverberation time in an feedback delay network (FDN), we need to find the G(z) which moves the poles where desired, and then design lowpass filters Hᵢ(z)≈G^{M}^{ᵢ}(z) which will be placed at the output (or input) of each delay line. All pole radii in the reverberator should vary smoothly with frequency.

Let t₆₀(ω) denote the desired reverberation time at radian frequency ω, and let Hᵢ(z) denote the transfer function of the lowpass filter to be placed in series with delay line i. The problem we consider now is how to design these filters to yield the desired reverberation time. We will specify an ideal amplitude response for Hᵢ(z) based on the desired reverberation time at each frequency, and then use conventional filter-design methods to obtain a low-order approximation to this ideal specification. Since losses will be introduced by the substitution z⁻¹←G(z)z⁻¹, we need to find its effect on the pole radii of the lossless prototype. Let pᵢ□e^{jω}^{ᵢ}^{T} denote the i^{th} pole. (Recall that all poles of the lossless prototype are on the unit circle.) If the per-sample loss filter G(z) were zero phase, then the substitution z⁻¹←G(z)z⁻¹ would only affect the radius of the poles and not their angles. If the magnitude response of G(z) is close to 1 along the unit circle, then we have the approximation that the i^{th} pole moves from z=e^{jω}^{ᵢ}^{T} to pᵢ=Rᵢe^{jω}^{ᵢ}^{T}, where Rᵢ=G(Rᵢe^{jω}^{ᵢ}^{T})≈G(e^{jω}^{ᵢ}^{T}).

In other words, when z⁻¹ is replaced by G(z)z⁻¹, where G(z) is zero phase and |G(e^{jω})| is close to (but less than) 1, a pole originally on the unit circle at frequency ωᵢ moves approximately along a radial line in the complex plane to the point at radius Rᵢ≈G(e^{jω}^{ᵢ}^{T}). The radius we desire for a pole at frequency ωᵢ is that which gives us the desired t₆₀(ωᵢ): Rᵢ^{t}^{₆₀}^{(ω}^{ᵢ}^{)/T}=0.001. Thus, the ideal per-sample filter G(z) satisfies |G(ω)|^{t}^{₆₀}^{(ω}^{ᵢ}^{)/T}=0.001.

The lowpass filter in series with a length Mᵢ delay line should therefore approximate Hᵢ(z)=G^{M}^{ᵢ}(z), which implies

$${\vert {H}_{i} ( {e}^{j ω T} ) \vert}^{\frac{{t}_{60} ( ω )}{{M}_{i} T}} = 0.001 .$$

Taking 20 log₁₀ of both sides gives

$$20 {log}_{10} \vert {H}_{i} ( {e}^{j ω T} ) \vert = - 60 \frac{{M}_{i} T}{{t}_{60} ( ω )} .$$

Now that we have specified the ideal delay-line filter Hᵢ(e^{jωT}) any number of filter-design methods can be used to find a low-order Hᵢ(z) which provides a good approximation. Examples include the functions invfreqz and stmcb in Matlab. Since the variation in reverberation time is typically very smooth with respect to ω, the filters Hᵢ(z) can be very low order.

The early reflections should be spatialized by including an HRTF on each tap of the early-reflection delay line. Some kind of spatialization may be needed also for the late reverberation. A true diffuse field consists of a sum of plane waves traveling in all directions in 3D space. Spatialization may also be applied to late reflections, though since these are treated statistically, the implementation is distinct.

US 20200008005 discloses a spatialized audio system includes a sensor to detect a head pose of a listener. The system also includes a processor to render audio data in first and second stages. The first stage includes rendering first audio data corresponding to a first plurality of sources to second audio data corresponding to a second plurality of sources. The second stage includes rendering the second audio data corresponding to the second plurality of sources to third audio data corresponding to a third plurality of sources based on the detected head pose of the listener. The second plurality of sources consists of fewer sources than the first plurality of sources.

US 20190327574 discloses a dual source spatialized audio system includes a general audio system and a personal audio system. The personal system may include a head pose sensor to collect head pose data of the user, and/or a room sensor. The system may include a personal audio processor to generate personal audio data based on the head pose of the user.

US 20200162140 provides for use of a spatial location and mapping (SLAM) sensor for controlling a spatialized audio system. The process of determining where the audio sources are located relative to the user may be referred to herein as “localization,” and the process of rendering playback of the audio source signal to appear as if it is coming from a specific direction may be referred to herein as “spatialization.” According to US 20200162140, localizing an audio source may be performed in a variety of different ways. In some cases, an AR or VR headset may initiate a direction of arrival (DOA) analysis to determine the location of a sound source. The DOA analysis may include analyzing the intensity, spectra, and/or arrival time of each sound at the AR/VR device to determine the direction from which the sound originated. In some cases, the DOA analysis may include any suitable algorithm for analyzing the surrounding acoustic environment in which the artificial reality device is located. For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

As an alternate, a directional (vector) microphone may be used, e.g., U.S. Pat. Nos. 11,006,219; 11,490,208; 10042038.

One was to accommodate individual differences between listeners is to perform a calibration, which may per performed once, or only when performance degrades. For example, a “pure effect”, such as a directional monotone sound from a specific vector direction is produced according to a generic HRTF. The listener then proceeds to input perceived defects, until the effect converges to an optimum, much in the way an optometrist tests different lenses when fitting an optical prescription. This may be repeated for a number of tones, for a number of vectors (including in-plane and out-of-plane), until an optimum set of parameters for a personalized HRTF is achieved. In some cases, an EEG headset may be used to extracted evoked potentials from the listener, to automatically detected artifacts and ultimate convergence of the HRTF model. This may also compensate for hearing deficiencies, such as gearing loss, hair styles, glasses, hearing aids or earbuds, etc. See, Angrisani, Leopoldo, Pasquale Arpaia, Egidio De Benedetto, Luigi Duraccio, Fabrizio Lo Regio, and Annarita Tedesco. “Wearable Brain-Computer Interfaces Based on Steady-State Visually Evoked Potentials and Augmented Reality: A Review.” IEEE Sensors Journal 23, no. 15 (2023): 16501-16514; Wheeler, Laura Jean. “In-Ear EEG Device for Auditory Brain-Computer Interface Communication.” PhD diss., 2024; Islam, Md Nahidul, Norizam Sulaiman, Bifta Sama Bari, Mamunur Rashid, and Mahfuzah Mustafa. “Auditory Evoked Potential (AEP) Based Brain-Computer Interface (BCI) Technology: A Short Review.” Advances in Robotics, Automation and Data Analytics: Selected Papers from CITES 2020 (2021): 272-284; Norris, Victoria. “Measuring the brain's response to music and voice using EEG. A pilot study.” PhD diss., 2023; Searchfield, Grant D., Philip J. Sanders, Zohreh Doborjeh, Maryam Doborjeh, Roger Boldu, Kevin Sun, and Amit Barde. “A state-of-art review of digital technologies for the next generation of tinnitus therapeutics.” Frontiers in digital health 3 (2021): 724370; Sudre, Salome, Richard Kronland-Martinet, Laetitia Petit, Jocelyn Rozé, Sølvi Ystad, and Mitsuko Aramaki. “A new perspective on binaural beats: Investigating the effects of spatially moving sounds on human mental states.” Plos one 19, no. 7 (2024): e0306427; Seha, Sherif Nagib Abbas, and Dimitrios Hatzinakos. “EEG-based human recognition using steady-state AEPs and subject-unique spatial filters.” IEEE Transactions on Information Forensics and Security 15 (2020): 3901-3910; www.frontiersin.org/journals/human-neuroscience/articles/10.3389/fnhum.2014.00182/full;

Different users may perceive the source of a sound as coming from slightly different locations. This may be the result of each user having a unique HRTF, which may be dictated by a user's anatomy including ear canal length and the positioning of the ear drum. The artificial reality device may provide an alignment and orientation guide, which the user may follow to customize the sound signal presented to the user based on their unique HRTF. In some embodiments, an AR or VR device may implement one or more microphones to listen to sounds within the user's environment. The AR or VR device may use a variety of different array transfer functions (ATFs) (e.g., any of the DOA algorithms identified above) to estimate the direction of arrival for the sounds. Once the direction of arrival has been determined, the artificial reality device may play back sounds to the user according to the user's unique HRTF. Accordingly, the DOA estimation generated using an ATF may be used to determine the direction from which the sounds are to be played from. The playback sounds may be further refined based on how that specific user hears sounds according to the HRTF.

In addition to or as an alternative to performing a DOA estimation, the device may perform localization based on information received from other types of sensors. These sensors may include video or other cameras, infrared radiation (IR) sensors (imaging/semi-imaging), heat sensors, motion sensors (ultrasonic, radar, lidar, optical, etc.), global positioning system (GPS) receivers, or in some cases, sensors that detect a user's eye movements (EOG, optical, etc.). Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time. The determined DOA may be used to generate a more customized output audio signal for the user. For instance, an acoustic transfer function may characterize or define how a sound is received from a given location. An acoustic transfer function may define the relationship between parameters of a sound at its source location and the parameters by which the sound signal is detected (e.g., detected by a microphone array or detected by a user's ear).

U.S. Patent Pub No. 20200112815 implements an augmented reality or mixed reality system. One or more processors (e.g., CPUs, DSPs) of an augmented reality system can be used to process audio signals or to implement steps of computer-implemented methods described below; sensors of the augmented reality system (e.g., cameras, acoustic sensors, IMUs, LIDAR, GPS) can be used to determine a position and/or orientation of a user of the system, or of elements in the user's environment; and speakers of the augmented reality system can be used to present audio signals to the user. In some embodiments, external audio playback devices (e.g. headphones, earbuds) could be used instead of the system's speakers for delivering the audio signal to the user's ears.

U.S. Patent Pub. No. 20200077221 discloses a system for providing spatially projected audio communication between members of a group, the system mounted onto a respective user of the group. The system includes a detection unit, configured to determine the three-dimensional head position of the user, and to obtain a unique identifier of the user. The system further includes a communication unit, configured to transmit the determined user position and the obtained user identifier and audio information to at least one other user of the group, and to receive a user position and user identifier and associated audio information from at least one other user of the group. The system may further include a processing unit, configured to track the user position and user identifier received from at least one other user of the group, to establish the relative position of the other user, and to synthesize a spatially resolved audio signal of the received audio information of the other user based on the updated position of the other user. The communication unit may be integrated with the detection unit configured to transmit and receive information via a RADAR-communication (RadCom) technique.

The detection unit may include one or Simultaneous Localization and Mapping (SLAM) sensors, such as at least one of: a RADAR sensor, a LIDAR sensor, an ultrasound sensor, a camera, a field camera, and a time-of-flight camera. The sensors may be arranged in a configuration so as to provide 3600 coverage around the user and capable of tracking individuals in different environments. In one embodiment, the sensor module is a RADAR module. A system on chip millimeter wave RADAR transceiver (such as the TI IWR1243, TI AWR1642, TI IWLR1432, TIAWR2944, NXP TEF8101, TEF82XX, SAF85XX, SAF86XX, AKm AK5818) can provide the necessary detection functionality while allowing for a compact and low power design, which may be an advantage in mobile applications. www.nxp.com/products/radio-frequency/radar-transceivers-and-socs/fully-integrated-77-ghz-rfcmos-automotive-radar-transceiver:TEF82xx; www.nxp.com/products/radio-frequency/radar-transceivers-and-socs/high-performance-77ghz-rfcmos-automotive-radar-one-chip-soc:SAF85XX; www.nxp.com/products/radio-frequency/radar-transceivers-and-socs/one-chip-rfcmos-automotive-radar-soc-for-distributed-architectures:SAF86XX; akm.com/us/en/about-us/news/2024/20240108-pontosense-ak5818/.

A mm wave radar transceiver may be integrated on an electronics board with a patch antenna design. The sensor module may provide reliable detection of persons for distances of up to 30 m, motorcycles of up to 50 m, and automobiles of up to 80 m, with a range resolution of up to 40 cm. The sensor module may provide up to a 120° azimuthal field of view (FoV) with a resolution of 15 degree. Three modules can provide a full 360° azimuthal FoV, though in some applications it may be possible to use two modules or even a single module. The RADAR module in its basic mode of operation can detect objects in the proximity of the sensor but has limited identification capabilities. LIDAR sensors and ultrasound sensors may suffer from the same limitations. Optical cameras and their variants can provide identification capabilities, but such identification may require considerable computational resources, may not be entirely reliable and may not readily provide distance information. Spatially projected communication requires the determination of the spatial position of the communicating parties, to allow for accurately and uniquely representing their audio information to a user in three-dimensional (3D) space. Some types of sensors, such as RADAR and ultrasound, can provide the instantaneous relative velocity of the detected objects in the vicinity of the user. The relative velocity information of the detected objects can be used to provide a Doppler effect on the audio representation of those detected objects. AI alternate to mm wave radar is the use of WiFi, and especially the “high” bands of 5.8 GHz (802.11ax, WiFi 6), 6 GHz (WiFi 6E), and 60 GHz (WiGig, 802.11ad), though in some cases the 2.4 GHz band may be employed.

A positioning unit is used to determine the position of the users. Such positioning unit may include localization sensors or systems, such as a global navigation satellite system (GNSS), a global positioning system (GPS), GLONASS, and the like, for outdoor applications. Alternatively, an indoor positioning sensor that is used as part of an indoor localization system may be used for indoor applications. The position of each user is acquired by the respective positioning unit of the user, and the acquired position and the unique user ID is transmitted by the respective communication unit of the user to the group. The other members of the group reciprocate with the same process. Each member of the group now has the location information and the accompanied unique ID of each user. To track the other members of the group in dynamic situations, where the relative positions can change, the user systems can continuously transmit, over the respective communication units, their acquired position to other members of the group and/or the detection units can track the position of other members independent of the transmission of the other members positions. Using the detection unit for tracking may provide lower latency (receiving the other members positions through the communications channel is no longer necessary) and the relative velocity of the other members positions relative to the user. Lower latency translates to better positioning accuracy in dynamic situations since between the time of transmission and the time of reception, the position of the transmitter position may have changed. A discrepancy between the system's representation of the audio source position and the actual position of the audio source (as may be visualized by the user) reduces the ability of the user to “believe” or to accurately perceive the spatial audio effect being generated. Both positioning accuracy and relative velocity are important to emulate natural human hearing.

A head orientation measurement unit provides continuous tracking of the user's head position. Knowing the user's head position is critical to providing the audio information in the correct position in 3D space relative to the user's head, since the perceived location of the audio information is head position-dependent and the user's head can swivel rapidly. The head orientation measurement unit may include a dedicated inertial measurement unit (IMU) or magnetic compass (magnetometer) sensor, such as the Bosch BM1160X. Alternatively, the head position can be measured and extracted through a head mounted detection system located on the head of the user. The detection unit can be configured to transmit information between users in the group, such as via a technique known as “RADAR communication” or “RadCom” as known in the art (as described for example in: Hassanein et al. A Dual Function Radar-Communications system using sidelobe control and waveform diversity, IEEE National Radar Conference—Proceedings 2015:1260-1263). This embodiment would obviate the need to correlate the ID of the user with their position to generate their spatial audio representation since the user's audio information will already be spatialized and detected coming from the direction that their RadCom signal is acquired from. This may substantially simplify the implementation since there is no need for additional hardware to provide localization of the audio source or to transmit the audio information, beyond the existing detection unit. Similar functionality described for RadCom can also be applied to ultrasound-based detection units (Jiang et al, Indoor wireless communication using airborne ultrasound and OFDM methods, 2016 IEEE International Ultrasonic Symposium). As such this embodiment can be achieved with a detection unit, power unit and audio unit only, obviating but not necessarily excluding, the need for the head orientation measurement, positioning, and communication units.

U.S. Patent Pub. No. 20190387352 describes an example of a system for determining spatial audio properties based on an acoustic environment. As examples, such properties may include a volume of a room; reverberation time as a function of frequency; a position of a listener with respect to the room; the presence of objects (e.g., sound-dampening objects) in the room; surface materials; or other suitable properties. These spatial audio properties may be retrieved locally by capturing a single impulse response with a microphone and loudspeaker freely positioned in a local environment, or may be derived adaptively by continuously monitoring and analyzing sounds captured by a mobile device microphone. An acoustic environment can be sensed via sensors of an XR system (e.g., an augmented reality system), a user's location can be used to present audio reflections and reverberations that correspond to an environment presented (e.g., via a display) to the user. An acoustic environment sensing module may identify spatial audio properties of an acoustic environment. Acoustic environment sensing module can capture data corresponding to an acoustic environment. For example, the data captured at a stage could include audio data from one or more microphones; camera data from a camera such as an RGB camera or depth camera; LIDAR data, sonar data; RADAR data; GPS data; or other suitable data that may convey information about the acoustic environment. In some instances, the data can include data related to the user, such as the user's position or orientation with respect to the acoustic environment.

A local environment in which the head-mounted display device is may include one or more microphones. In some embodiments, one or more microphones may be employed, and may be mobile device mounted or environment positioned or both. Benefits of such arrangements may include gathering directional information about reverberation of a room, or mitigating poor signal quality of any one microphone within the one or more microphones. Signal quality may be poor on a given microphone due for instance to occlusion, overloading, wind noise, transducer damage, and the like. Features can be extracted from the data. For example, the dimensions of a room can be determined from sensor data such as camera data, LIDAR data, sonar data, etc. The features can be used to determine one or more acoustic properties of the room, for example, frequency-dependent reverberation times, and these properties can be stored and associated with the current acoustic environment. The system can include a reflections adaptation module for retrieving acoustic properties for a room, and applying those properties to audio reflections (for example, audio reflections presented via headphones, or via speakers to a user).

U.S. Patent Pub. No. 20190387349 teaches a spatialized audio system in which object detection and location can also be achieved with RADAR-based technology (e.g., an object-detection system that transmits radio waves to determine one or more of an angle, distance, velocity, and identification of a physical object).

U.S. Patent Pub. No. 20190342693 teaches a spatialized audio system having an indoor positioning system (IPS) locates objects, people, or animals inside a building or structure using one or more of radio waves, magnetic fields, acoustic signals, or other transmission or sensory information that a PED receives or collects. Non-radio technologies can also be used in an IPS to determine position information with a wireless infrastructure. Examples of such non-radio technology include, but are not limited to, magnetic positioning, inertial measurements, and others. Further, wireless technologies can generate an indoor position and be based on, for example, a Wi-Fi positioning system (WPS), Bluetooth, RFID systems, identity tags, angle of arrival (AoA, e.g., measuring different arrival times of a signal between multiple antennas in a sensor array to determine a signal origination location), time of arrival (ToA, e.g., receiving multiple signals and executing trilateration and/or multi-lateration to determine a location of the signal), received signal strength indication (RSSI, e.g., measuring a power level received by one or more sensors and determining a distance to a transmission source based on a difference between transmitted and received signal strengths), and ultra-wideband (UWB) transmitters and receivers. Object detection and location can also be achieved with RADAR-based technology (e.g., an object-detection system that transmits radio waves to determine one or more of an angle, distance, velocity, and identification of a physical object).

3D audio effects are a group of sound effects that manipulate the sound produced by stereo speakers, surround-sound speakers, speaker-arrays, or headphones. (en.wikipedia.org/wiki/3D_audio_effect). This frequently involves the virtual placement of sound sources anywhere in three-dimensional space, including behind, above or below the listener.

AN HRTF is a filter that contains all of the acoustic information required to describe how sound reflects or diffracts around a listener's head, torso, and outer ear before entering their auditory system. HRTFs can be used to render spatial audio, which simulates a soundscape around the user. Spatialized audio is a technique that simulates a realistic soundscape around the listener by using HRTFs, which are filters that describe how sound reflects or diffracts around the listener's head and ears.

3-D audio (processing) is the spatial domain convolution of sound waves using HRTF. It is the phenomenon of transforming sound waves (using HRTF filters and cross talk cancellation techniques) to mimic natural sounds waves, which emanate from a point in a 3-D space.

Using HRTFs and reverberation, the changes of sound on its way from the source (including reflections from walls and floors) to the listener's ear can be simulated. These effects include localization of sound sources behind, above and below the listener.

True representation of the elevation level for 3D loudspeaker reproduction become possible by the Ambisonics and wave field synthesis (WFS) principle. Wave field synthesis (WFS) is a spatial audio rendering technique, characterized by creation of virtual acoustic environments. (See, en.wikipedia.org/wiki/Wave_field_synthesis). It produces artificial wavefronts synthesized by a large number of individually driven loudspeakers from elementary waves. Such wavefronts are controlled to apparently originate from a virtual starting point, the virtual sound source, which can remain fixed while the listener moves. WFS is based on the Huygens-Fresnel principle, which states that any wavefront can be regarded as a superposition of spherical elementary waves. Therefore, any wavefront can be synthesized from such elementary waves. In practice, a computer controls a large array of individual loudspeakers and produces sounds from signals which are controlled in frequency, phase and amplitude, to contribute to the desired wavefront at each of the listener's ears. Because the ears are separated by the head, an HRTF may be used to define sets of signals that achieve high isolation between left and right ears.

The basic procedure was developed in 1988 by Professor A. J. Berkhout at the Delft University of Technology. Brandenburg, Karlheinz; Brix, Sandra; Sporer, Thomas (2009). 2009 3DTV Conference: The True Vision Capture, Transmission and Display of 3D Video. pp. 1-4. doi:10.1109/3DTV.2009.5069680. ISBN 978-1-4244-4317-8. S2CID 22600136. Its mathematical basis is the Kirchhoff-Helmholtz integral. It states that the sound pressure is completely determined within a volume free of sources, if sound pressure and velocity are determined in all points on its surface,

$$P ( w , z ) = \int {\int }_{dA} ( G ( w , z \vert {z}^{′} ) \frac{\partial }{\partial n} P ( w , {z}^{′} ) - P ( w , {z}^{′} ) \frac{\partial }{\partial n} G ( w , z \vert {z}^{′} ) ) {dz}^{′} .$$

Therefore, any sound field can be reconstructed, if sound pressure and acoustic velocity are restored on all points of the surface of its volume. This approach is the underlying principle of holophony.

According to this theory, for reproduction, the entire surface of the volume would have to be covered with closely spaced loudspeakers, each individually driven with its own signal. Moreover, the listening area would have to be anechoic, in order to avoid sound reflections that would violate source-free volume assumption. In practice, this is infeasible. Because our acoustic perception is most exact in the horizontal plane, practical approaches generally reduce the array to a horizontal loudspeaker line, circle or rectangle around the listener. So the origin of the synthesized wavefront is restricted to points on the horizontal plane of the loudspeakers. For sources behind the loudspeakers, the array will produce convex wavefronts. Sources in front of the speakers can be rendered by concave wavefronts that focus in the virtual source inside playback area and diverge again as convex wave. Changes of the listener's position in the rendition area may produce the same impression as an appropriate change of location in the recording room. Two dimension arrays can establish parallel wavefronts. The horizontal arrays can only produce cylinder waves, which lose 3 dB per doubling of distance.

The Moving Picture Expert Group standardized an object-oriented transmission standard MPEG-4 allowing separate transmission of content (dry recorded audio signal) and form (the impulse response or the acoustic model). Each virtual acoustic source needs its own (mono) audio channel. The spatial sound field in the recording room consists of the direct wave of the acoustic source and a spatially distributed pattern of mirror acoustic sources caused by the reflections by the room surfaces. Reducing that spatial mirror source distribution onto a few transmitting channels causes loss of spatial information. This spatial distribution can be synthesized much more accurately by the rendition side.

Schissler, Carl, Aaron Nicholls, and Ravish Mehra. “Efficient HRTF-based spatial audio for area and volumetric sources.” IEEE transactions on visualization and computer graphics 22, no. 4 (2016): 1356-1366 presents a spatial audio rendering technique to handle sound sources that can be represented by either an area or a volume in VR environments. As opposed to point-sampled sound sources, our approach projects the area-volumetric source to the spherical domain centered at the listener and represents this projection area compactly using the spherical harmonic (SH) basis functions.

A key component of spatial audio is the modeling of HRTF, which is a filter defined over the spherical domain that describes how a listener's head, torso, and ear geometry affects incoming sound from all directions. J. Blauert. Spatial hearing: the psychophysics of human sound localization. MIT press, 1997. The filter maps incoming sound arriving towards the center of the head to the corresponding sound received by the user's left and right ears. In order to auralize the sound for a given source direction, an HRTF filter is computed for that direction, then convolved with dry input audio to generate binaural audio. When this binaural audio is played over headphones, the listener hears the sound as if it comes from the direction of the sound source.

The HRTF uses a linear filter to map the sound arriving from a direction (θ, φ) at the center of the head to the sound received at the entrance of each ear canal of the listener. In spherical coordinates, the HRTF is a function of three parameters: azimuth φ, elevation θ, and either time t or frequency v. We denote the time-domain HRTF for the left and right ears as h_{L}(θ, φ, t), and h_{R}(θ, φ, t). The frequency-domain HRTF is denoted by h_{L}(θ, φ, v) and h_{R}(θ, φ, v). In the frequency domain, the HRTF filter can be stored using the real and imaginary components of the Fourier transform of the time-domain signal, or can be represented by the magnitude response and a frequency-independent inter-aural delay. In the second case, a causal minimum-phase filter can be constructed from the magnitude data using the min-phase approximation (A. Kulkarni, S. Isabelle, and H. Colburn. On the minimum-phase approximation of HRTFs. In Applications of Signal Processing to Audio and Acoustics, 1995., IEEE ASSP Workshop on, pages 84-87. IEEE, 1995) and the inter-aural delay. HRTFs are typically measured over evenly-spaced directions in anechoic chambers using specialized equipment. The output of this measurement process is an impulse response for each measured direction (θᵢ, φᵢ). We refer to this HRTF representation as a sampled HRTF. Another possible HRTF representation is one where the sampled HRTF data has been projected into the spherical harmonic basis. M. J. Evans, J. A. Angus, and A. I. Tew. Analyzing HRTF measurements using surface spherical harmonics. The Journal of the Acoustical Society of America, 104(4):2400-2411, 1998; B. Rafaely, and A. Avni. Interaural cross correlation in a sound field represented by spherical harmonics. The Journal of the Acoustical Society of America, 127(2):823-828, 2010.

HRTF-Based systems are discussed in web.archive.org/web/20211024031356/https://www.ece.ucdavis.edu/cipic/spatial-sound/tutorial/hrtfsys/. One of the simplest effective HRTF models is the Inter Aural Time Delay (ITD) model. It can easily be implemented as an FIR filter. It moves the source in azimuth by introducing an azimuth-dependent time delay that is different for the two ears, which are assumed to be diagonally opposite across the head. Using the same geometrical argument that was employed to derive the ITD, we find that the time-delay function is given by

$${T}_{d} ( θ ) = \{ \begin{matrix}\frac{a}{c} ( 1 - cos ( θ ) & if \vert θ \vert < \frac{π}{2} \\ \frac{a}{c} ( \vert θ \vert + 1 - \frac{π}{2} ) & if \frac{π}{2} < \vert θ \vert < π\end{matrix}$$

where a is the head radius and c is the speed of sound. As one would expect, a model as simple is this is rather limited. It produces no sense of externalization and no front/back discrimination. However, it does produce a sound image that moves smoothly from the left ear through the head to the right ear as the azimuth goes from −90° to +90°, with none of the oppressive sense that one gets when all of the sound energy is going to only one ear. With some wideband signals, some people get the impression of two sound images, one displaced and one at the center of the head. The reason for that is that while the ITD cue is telling the brain that the source is displaced, the energy at the two ears is the same, and the Intrasual Level Difference (ILD) cue is telling the brain that the source is in the center. This problem can be rectified by adding head shadow. An early analytical solution for the ILD represents a rigid sphere. While this solution is in the form of an infinite series, it turns out that its magnitude response can be fairly well approximated by the one-pole, one-zero transfer function

$$H ( s , θ ) = \frac{α ( θ ) s + β}{s + β} , where α ( θ ) = 1 + cos θ and β = 2 \frac{c}{a} .$$

This transfer function boosts the high frequencies when the azimuth is 0°, and cuts them when the azimuth is 180°, thereby simulating the effects of head shadow. By offsetting the azimuth to the ear positions, we obtain a simple ILD model, which can be implemented as an IIR filter. Like the ITD model, the ILD model produces no sense of externalization and no front/back discrimination. However, one does experience a smooth motion of the sound image from the left ear to the right ear as the azimuth parameter is changed. Although there is a significant interaural group delay at low frequencies, the group delay becomes negligible at high frequencies. This again leads to a “split image problem,” since the ILD and ITD cues are conflicting. The way to fix this problem is to combine the ITD and the ILD models. By merely cascading the ITD model and the ILD model, an approximate but useful spherical-head model is obtained. While there is still no sense of externalization or elevation, it eliminates the “split image” problem and produces a very “tightly focused” phantom image. Another simple modification of this model is to add a simulated room echo to produce some externalization and get an “out-of-head” sensation. Here the “echo” is the same in each ear, regardless of the position of the source. The gain K_{echo} should be between zero and one (not too large), and the delay T_{echo} should be between 10 and 30 ms. This very simple room model is more characteristic of the “reverberant tail” than the early reflections, and fails to produce externalization when the azimuth is near 0°. However, it does get the sound out of the head at other azimuths. *Externalization near 0° can be achieved by adding a second echo with a delay in one of the channels to break the symmetry. One or more “pinna echoes” may be modelled. The problem is to determine how the gains K and time delays T vary with azimuth and elevation.

By combining the head and pinna models (and adding torso diffraction models, shoulder reflection models, ear-canal resonance models, room models, etc.) we can obtain successively better approximations to the actual HRTF.

Spatial audio techniques aim to approximate the human auditory system by filtering and reproducing sound localized in 3D space. The human ear determines the location of a sound source by considering the differences between the sound heard at each ear. Interaural time differences (ITD) occur when sound reaches one ear before the other, while interaural level differences (ILD) are caused by different sound levels at each ear. (Blauert 1997)) Listeners use these cues for localization along the left-right axis. Differences in spectral content, caused by filtering of the pinnae, resolve front-back and up-down ambiguities.

The simplest approaches for spatial sound are based on amplitude panning, where the levels of the left and right channels are changed to suggest a sound source that is localized toward the left or right. However, this stereo sound approach is insufficient for front-back or out-of-plane localization. Conversely, Vector-based amplitude panning (VBAP) allows panning among arbitrary 2D or 3D speaker arrays. (V. Pulkki. Virtual sound source positioning using vector base amplitude panning. Journal of the Audio Engineering Society, 45(6):456-466, 1997).

To compute spatial audio for a point sound source using the HRTF, we first determine the direction from the center of the listener's head to the sound source (θ_{S}, φ_{S}). Using this direction, the HRTF filters h_{L}(θ_{S}, φ_{S}, t) and h_{R}(θ_{S}, φ_{S}, t) for the left and right ears are interpolated from the nearest measured impulse responses. If the dry audio for the sound source is given by s(t), and the sound source is at a distance d_{S} from the listener, the sound signals at the left ear p_{L}(t) and the right ear p_{R}(t) can be computed as follows:

$${p}_{L} ( t ) = \frac{1}{1 + {d}_{S}^{2}} {h}_{L} ( {θ}_{S} , {ϕ}_{S} , t ) ⊗ s ( t )$$

$${p}_{R} ( t ) = \frac{1}{1 + {d}_{S}^{2}} {h}_{R} ( {θ}_{S} , {ϕ}_{S} , t ) ⊗ s ( t ) ,$$

where ⊗ is the convolution operator and

$$\frac{1}{1 + {d}_{S}^{2}}$$

is the distance attenuation factor. Other distance attenuation models may also be used to suit the requirements of a specific application. If there are multiple sound sources, the signals for each source are added together to produce the final audio at each ear. For the sake of clarity, from this point forth, we drop the subscripts L and R of the HRTF. The reader should assume that the audio for each ear can be computed in the same way.

Ambisonics is a spatial audio technique first proposed by Gerzon (M. A. Gerzon. Periphony: With-height sound reproduction. J. Audio Eng. Soc, 21(1):2-10, 1973) that uses first-order plane wave decomposition of the sound field to capture a playback-independent representation of sound called the B-format. This representation can then be decoded at the listener's playback setup, which can be either headphones, 5.1, 7.1 or any general speaker configuration.

Wave-field Synthesis Wave-field synthesis is a loudspeaker-based technique that enables spatial audio reconstruction that is independent of listener-position. This approach typically requires hundreds of loudspeakers and is used for multi-user audio-visual environments. (J. P. Springer, C. Sladeczek, M. Scheffler, J. Hochstrate, F. Melchior, and B. Frohlich. Combining wave field synthesis and multi-viewer stereo displays. In Virtual Reality Conference, 2006, pages 237-240. IEEE, 2006.)

Previous work on sound for virtual scenes has frequently focused on point sources. Although directional sound sources can be modeled for points in the far-field (R. Mehra, L. Antani, S. Kim, and D. Manocha. Source and listener directivity for interactive wave-based sound propagation. Visualization and Computer Graphics, IEEE Transactions on, 20(4):495-503, 2014), these approaches cannot produce the near-field effects of large area or volume sources. The diffuse rain technique (D. Schroder. “Physically based real-time auralization of interactive virtual environments, volume 11. Logos Verlag Berlin GmbH, 2011) computes an approximation of diffuse sound propagation for spherical, cylindrical, and planar sound sources, but does not consider spatial sound effects. Other approaches approximate area or volume sources using multiple sound emitters, or use the closest point on the source as a proxy when computing spatial audio. However, none of these techniques accurately model how an area-volumetric sound source interacts with the HRTF to give the impression of an extended source.

A key goal for VR systems is to help users achieve a sense of presence in virtual environments. Experimentally, self-reported levels of immersion and/or presence have been shown to increase or decrease inline with auditory fidelity. (C. Hendrix and W. Barfield. The sense of presence within auditory virtual environments. Presence: Teleoperators and Virtual Environments, 5(3):290-301, 1996; R. L. Storms. Auditory-visual cross-modal perception phenomena. Technical report, DTIC Document, 1998). Head-tracking and spatialization further increase self-reported realism of audio and the sense of presence. In addition, head-tracked HRTFs greatly improve localization performance in virtual environments. Multiple studies have demonstrated that with sufficient simulation quality, HRTF-based audio techniques can produce virtual sounds indistinguishable from real sound sources.

Orthogonal basis functions defined on the spherical domain have been frequently used in audio rendering. Several approaches have proposed the use of spherical harmonics for efficient HRTF representations. (D. N. Zotkin, R. Duraiswami, N. Gumerov, et al. Regularized HRTF fitting using spherical harmonics. In Applications of Signal Processing to Audio and Acoustics, 2009. WASPAA'09. IEEE Workshop on, pages 257-260. IEEE, 2009; B. Rafaely and A. Avni. Interaural cross correlation in a sound field represented by spherical harmonics. The Journal of the Acoustical Society of America, 127(2):823-828, 2010). Spherical basis functions can also be used to represent the directivity of sound sources. One approach combines a set of elementary spherical harmonic source directivities to synthesize directional sound sources using a 3D loudspeaker array. (O. Warusfel and N. Misdariis. Sound source radiation syntheses: From performance to domestic rendering. In Audio Engineering Society Convention 116. Audio Engineering Society, 2004). Noitening et al. (M. Noisternig, F. Zotter, and B. F. Katz. Reconstructing sound source directivity in virtual acoustic environments. Principles and Applications of Spatial Hearing, World Scientific Publishing, pages 357-373, 2011) use the discrete spherical harmonic transform to reconstruct radiation patterns in virtual and augmented reality. In wave-based sound simulations, spherical harmonics have been used with the plane-wave decomposition of the sound field to produce dynamic source directivity as well as spatial sound. (R. Mehra, L. Antani, S. Kim, and D. Manocha. Source and listener directivity for interactive wave-based sound propagation. Visualization and Computer Graphics, IEEE Transactions on, 20(4):495-503, 2014). These basis functions have also been used for spatial sound encoding in the near-field using higher-order ambisonics. (D. Menzies and M. Al-Akaidi. Nearfield binaural synthesis and ambisonics. The Journal of the Acoustical Society of America, 121(3):1559-1563, 2007; J. Daniel. Spatial sound encoding including near field effect: Introducing distance coding filters and a viable, new ambisonic format. In Audio Engineering Society Conference: 23rd International Conference: Signal Processing in Audio Recording and Reproduction, May 2003).

In Monte Carlo integration, a set of uniformly distributed random samples are used to numerically compute the integral of function. Each sample is weighted according to its probability. An approximate value for the integral is computed by summing the weighted random samples. Due to the law of large numbers, the accuracy of the integral increases when more samples are taken. This approach has previously been applied for computing direct light for computer graphics, as well as for low-order spherical harmonic representations of lighting.

### SUMMARY OF THE INVENTION

The present technology provides a system having audio beamforming capabilities, guided by a radio wave interaction with or sounding of an environment. For example, the environment is a living or listening environment in a residence, office, social space or auditorium, and the radio frequency waves are gigahertz radio waves. Advantageously, the radio wave interactions are detected using a Wi-Fi radio, e.g., IEEE-802.11ax, ad, be, ay, az, bd, bf, bi, ki, etc.

Once the location of each ear is estimated, and an HRTF is established, traditional spatial audio techniques may be employed, as modified herein. The HRTF may be user-specific (i.e., personalized by user measurements, calibration, feedback or preferences), or more generalized, such as by characteristics of hair, ears, distance between ears, race, sex, age, etc.

The Wi-Fi RADAR produces signals that may be difficult to interpret, especially in an uncontrolled environment. Further, using Wi-Fi to detect head position and orientation is difficult, since there are typically no readily determined, reliable, RADAR-reflective landmarks that reveal the exact location of the ears. Use of RF retroreflective ear or pinna markers may increase ear localization accuracy and efficiency. However, dynamic analysis of movements can detect heartbeats and respiration, and doppler analysis can detect heart and chest wall movement. These individually or together can be used to isolate the heart and chest wall patterns in a received signal. Given the relatively fixed anatomical relationships, the return signal from emitted radio waves can then provide an estimate of body pose, including where the head is located. The estimated region of the head may then be integrated over a longer period of time to increase signal to noise ratio, thereby deduce ear location based on estimates of jaw and cranium. Further, a number of inferences are available to estimate head orientation based on body pose, which may be extracted from a static analysis of the radio signals. While the dynamic and static analysis may be separated, then may also be consolidated into a single algorithm.

According to one embodiment, the technology therefore provides a system and method for controlling a spatial audio system, using reflected or scattered RF signals, to determine a listener pose, from which positions of the ears are inferred or deduced. The HRTF of the spatial audio system is then constrained by the inferred or deduced pose, and the spatial audio produced accordingly. Preferably, the RF system extracts cyclically varying anatomical features such as heartbeat and respiration, to infer location and orientation of a chest wall (presuming normal anatomy, though the system may be calibrated for different anatomies). From the chest wall location and orientation, the location and orientation of the neck may be inferred, and scattered RF signals may also directly identify the head and neck, including pose. The angle of the neck and skull may be presumed to be aligned with a presentation or soundscape, for example based on a television location, or other focal point in a room. A sensor or fiducial may be provided on the user to determine head orientation, all without use of a optical imaging device. While an imaging device may be employed, one goal may be to avoid the privacy intrusion implications of a camera in a living space.

The algorithm (which need not be conducted as discrete steps) is therefore:
1. detect dynamically oscillating (cyclically varying) objects in the environment within a period of 10 seconds to 0.3 seconds, representing heartbeat and respiration. (May also extract animals).
2. Determine a position of the source of the oscillating signals within the environment.
3. Determine a body pose including head orientation of a body (thoracic wall) as the source of the heartbeat and respiration.
4. Estimate or infer a set of ear positions for each body.
5. Assign head-related transfer functions (HRTFs) to each of a respective pair of ears.
6. Emit spatialized audio dependent on each HRTF, the listening environment, and an audio source.

Note that if there are multiple listeners within an environment, isolation strategies for sounds intended for different listeners will depend on room boundaries and acoustics, speaker/speaker array location, acoustic delays, common signals to be received by multiple listeners, equalization issues, etc.

Thus, after the ear locations are estimated or predicted, more traditional spatial audio technology is used to focus transmission of sound beams to the exact (or inferred) location of their ears.

Additionally, the technology may incorporate RADAR-based gesture recognition, allowing users to convey intentions through gestures, further enhancing interactive communication. This facilitates feedback to the controller, in order to tune the system. For example, a set of predefined gestures may be established to indicate desired volume level, frequency equalization, training mode, spatialization parameters, etc. For example, if the user's head is not oriented as predicted by the spatial audio system, a user may conduct a gesture, e.g., hand motion, which is received and interpreted to perform a change of the spatial audio rendition to better match the actual user pose. Further, a user may determine that the sound is being targeted in front or behind the ear. A natural gesture may be defined to indicate that the target of the sound should be moved in 2D or 3D to better correspond to the ear location. Similarly, gestures may be defined for raising volume, controlling treble, midrange, and bass. (Note that bass is typically non-directional, and therefore one user's attempt to control the bass will impact other listeners in the environment. Therefore, consensus gestures may also be defined for other listeners.) The gesture interface may be supplemented by a speech recognition interface, a smartphone interface, a remote control interface, etc., all without relying on a camera. Where acceptable, a camera may also be employed.

Determination (prediction or estimation) of a human heart location within a radio frequency backscatter signal is known. Likewise, respiratory monitoring and localization is also known.

The present technology may employ so-called “through-wall RADAR” (though not necessarily involving transmission through walls) technology, preferably based on Wi-Fi, IEEE-802.11 protocol compliant standards. The RADAR permits localization of individuals within a listening environment using human body interaction with Wi-Fi signals. While both the Wi-Fi transmitter and receiver may be employed, in some cases, the receiver is separate, e.g., an SDR, to permit direct access to all receiver parameters, rather than those accessible according to manufacturer implementations of Wi-Fi standards. Similarly, the antennas may be directional antennas rather than omnidirectional or partly directional antennas often used on Wi-Fi radios. (Note that typical Multiple-Input, Multiple-Output (MIMO) beamforming algorithms impute dipole emission to the available antennas).

Through-wall RADAR is a technology that exploits the ubiquity of Wi-Fi technology, and its interaction with (e.g., scattering and attenuation) environmental objects such as human bodies, to provide radio detection and ranging. The capabilities also include Doppler and imaging. Modern Wi-Fi, according to specifications of 802.11n, 11ac, 11ax, 11be, 11ad, 11ay, etc., exploit multipath signal propagation and MIMO antenna arrays to permit increased channel data communication capacity. These antenna arrays may also permit radio frequency beamforming. The modern Wi-Fi therefore provides frequency division multiplexing on frequency subcarriers, time division multiplexing, and spatial division multiplexing. In performing complex calculations to encode and extract information from the radio waves, the typical Wi-Fi system inherently determines various environmental characteristics, and these characteristics are then suppressed to provide outputs dependent only on the data to be communicated. However, a number of technologies extract the environmental information. This environmental information is typically within the communication range of the Wi-Fi radio, and therefore is limited to about 100 meters. Practically, Wi-Fi RADAR is limited to about 10 meters for small objects. Because the Wi-Fi radio frequency transmissions can pass through walls, and a class of problems seeks to determine objects which are not visible through a barrier, these technologies are often called “through-wall RADAR”.

Guo, Lingchao, Zhaoming Lu, Shuang Zhou, Xiangming Wen, and Zhihong He. “When healthcare meets off-the-shelf WiFi: A non-wearable and low-costs approach for in-home monitoring.” arXiv preprint arXiv:2009.09715 (2020) provides a useful model for portions of the pose estimation task.

Some commercial Wi-Fi devices permit access to Channel State Information (CSI), which is used within the Wi-Fi device to control MIMO operation. CSI mainly represents the multipaths in which Wi-Fi signals are propagated, reflected, diffracted and scattered in a typical indoor environment. Thus, it can capture how Wi-Fi signals interact with humans. The receivers collect CSI for analysis.

The bandwidth and number of antennas of typical off-the-shelf Wi-Fi devices are limited, which limit available resolution for capturing fine-grained human pose figures and detailed respiration status curves. However, more advanced devices do include a large number of antennas, e.g., 8×8 MIMO, and customized installations permit disposing the antennas in a relatively large array. For example, a set of 8 antennas could be disposed along the horizontal edge of a large screen television or sound bar, yielding a maximum separation of ˜2 meters. For a television, antennas could also be disposed on the top and side edges, and the number of antennas increased to 16, for example.

Cooperative MIMO is a technology that can combine multiple wireless devices into a virtual antenna array to achieve MIMO communications. Cooperative MIMO (CO-MIMO) is a technology that can effectively exploit the spatial domain of mobile fading channels to bring significant performance improvements to wireless communication systems. It is also called network MIMO, distributed MIMO, virtual MIMO, and virtual antenna arrays. Cooperative MIMO uses distributed antennas on different radio devices to achieve close to the theoretical gains of MIMO. The basic idea of cooperative MIMO is to group multiple devices into a virtual antenna array to achieve MIMO communications. This, for example, increases the spatial separation of antennas, and generally the number of independent antennas. A cooperative MIMO transmission involves multiple point-to-point radio links, including links within a virtual array and possibly links between different virtual arrays. C-MIMO uses distributed antennas, which can increase the system capacity by decorrelating the MIMO subchannels and allow the system to exploit the benefits of macro-diversity in addition to micro-diversity. In many practical applications, such as cellular mobile and wireless ad hoc networks, the advantages of deploying cooperative MIMO technology outweigh the disadvantages.

One example of using cooperative MIMO in Wi-Fi communications is Coordinated Multipoint (CoMP), which is a technique that allows neighboring APs to share data and channel state information (CSI) to coordinate their transmissions in the downlink and jointly process the received signals in the uplink. In coordinated multipoint (CoMP), data and channel state information (CSI) is shared among neighboring cellular base stations (BSs) to coordinate their transmissions in the downlink and jointly process the received signals in the uplink. CoMP techniques can effectively turn otherwise harmful inter-cell interference into useful signals, enabling significant power gain, channel rank advantage, and/or diversity gains to be exploited. CoMP requires a high-speed backhaul network for enabling the exchange of information (e.g., data, control information, and CSI) between the BSs. This is typically achieved via an optical fiber fronthaul. CoMP has been introduced into 4G standards. CoMP can reduce interference, increase coverage, and enhance throughput for users located at the cell edge or in areas with poor signal quality. CoMP can be implemented in both 802.11ac (WiFi 5) and 802.11ax (WiFi 6) standards, as well as more advanced protocols.

MIMO means that the system uses multiple antennas to transmit and receive wireless signals. By using different waveforms or frequencies for each antenna, the system can distinguish the signals from each other and create a virtual array of antennas that has a larger aperture and higher resolution than the physical array. Cooperative MIMO can improve the capacity, cell edge throughput, coverage, and group mobility of a wireless network in a cost-effective manner. These advantages are achieved by using distributed antennas, which can increase the system capacity by decorrelating the MIMO subchannels and allow the system to exploit the benefits of macro-diversity in addition to micro-diversity. In Cooperative-MIMO, the decoding process involves collecting N_{R} linear combinations of N_{T} original data symbols, where N_{R} is usually the number of receiving nodes, and N_{T} is the number of transmitting nodes. The decoding process can be interpreted as solving a system of N_{R} linear equations, where the number of unknowns equals the number of data symbols (N_{T}) and interference signals. Thus, in order for data streams to be successfully decoded, the number of independent linear equations (N_{R}) must at least equal the number of data (N_{T}) and interference streams.

The IEEE 802.11ac standard, also known as Wi-Fi 5, includes support for four streams of cooperative MIMO. In addition, 802.11ac is limited to downlink transmission only, which means that only the access point (AP) can transmit to multiple clients simultaneously, but not vice versa. The IEEE 802.11ax standard, also known as Wi-Fi 6, extends the support for cooperative MIMO to 8 streams and uplink transmission as well, which means that both the AP and the clients can transmit to multiple devices simultaneously. This enables more efficient use of the wireless spectrum and higher data rates for both downlink and uplink. Wi-Fi 6E is an extension of Wi-Fi 6 that uses the 6 GHz band. It has the same standard as Wi-Fi 6, but with an additional spectrum. The 6% GHz band ranges from 5.925 GHz to 7.125 GHz, which gives it an extra 1,200 MHz of spectrum.

Wi-Fi 7 (IEEE-802.11be) is preferred as a basis for the Wi-Fi sensing according to the present technology. First, the support for 4096-QAM (4K-QAM) enables each symbol to carry 12 bits rather than 10 bits, and thus higher resolution. A 16×16 MIMO antenna array permits higher quality beamforming and spatial resolution. It offers contiguous and non-contiguous 320/160+160 MHz and 2401160+80 MHz bandwidth, thus supporting a broader band of radio frequency sensing. Multi-Link Operation (MLO), a feature that increases capacity by simultaneously sending and receiving data across different frequency bands and channels. (2.4 GHz, 5 GHz, 6 GHz), allows multiband sensing. Flexible Channel Utilization allows the system to avoid interference, which would be important in an environment with concurrent users, and perhaps multiple sensing radios active. Multi-Access Point (AP) Coordination (e.g. coordinated and joint transmission) permits larger effective distances between antennas, and therefore better spatial resolution and range. Of course, other standards or non-standard protocols, and future protocols, may be employed consistent with the discussion herein.

One example of using cooperative MIMO in Wi-Fi communications is Coordinated Multipoint (CoMP), which is a technique that allows neighboring APs to share data and channel state information (CSI) to coordinate their transmissions in the downlink and jointly process the received signals in the uplink4. CoMP can reduce interference, increase coverage, and enhance throughput for users located at the cell edge or in areas with poor signal quality. CoMP can be implemented in both 802.11 ac and 802.11ax standards, but is better supported in 802.11be.

In cooperative subspace coding, also known as linear network coding, nodes transmit random linear combinations of original packets with coefficients which can be chosen from measurements of the naturally random scattering environment. Alternatively, the scattering environment is relied upon to encode the transmissions. If the spatial subchannels are sufficiently uncorrelated from each other, the probability that the receivers will obtain linearly independent combinations (and therefore obtain innovative information) approaches 1. Although random linear network coding has excellent throughput performance, if a receiver obtains an insufficient number of packets, it is unlikely that it can recover any of the original packets. This can be addressed by sending additional random linear combinations (such as by increasing the rank of the MIMO channel matrix or retransmitting at a later time that is greater than the channel coherence time) until the receiver obtains a sufficient number of coded packets to permit decoding.

Cooperative subspace coding faces high decoding computational complexity. However, in cooperative MIMO radio, MIMO decoding already employs similar, if not identical, methods as random linear network decoding. Random linear network codes have a high overhead due to the large coefficient vectors attached to encoded blocks. But in Cooperative-MIMO radio, the coefficient vectors can be measured from known training signals, which is already performed for channel estimation. Finally, linear dependency among coding vectors reduces the number of innovative encoded blocks. However, linear dependency in radio channels is a function of channel correlation, which is a problem solved by cooperative MIMO.

By focusing initial analysis of correctly parameterizing the HRTF on dynamic components of the received signal, the static clutter may be treated as background, and subtracted from the signal of interest. After the heart, chest wall, and other dynamic elements are localized within the environment, typically at a range of 1-10 meters from the antenna(s), a search region within the static or pseudostatic space is then defined for the head. This same analysis can extract body position and pose, which may provide inferences for hear orientation. That is, by first localizing the heartbeat and respiration, a search space for the remainder of the body and its pose is simplified.

In some cases, the location of ears may be facilitated by additional features, such as eyeglasses, hats, earrings or ear buds, and signals representing these structures may also be detected. Further, in sone cases, the structures may be specially encoded to provide signatures in the return signal. For example, a passive radio frequency identification tag style backscatter modulator may be provided which imposes a coded signal in the returns, which can be readily extracted. Similarly, for spatial calibration, a set of such objects may be dispersed in the environment and specifically localized in a map of the environment. Such transponders may modulate backscatter with a unique or quasi-unique binary AM bitstream or more complex modulation. Typically, the bit rate should be lower than the frame rate of the Wi-Fi, so that the radio need not demodulate changes that occur within a frame, and rather can determine changes within a series of frames.

For example, a user entering the environment may receive a pair of self-adhesive patches that are affixed, e.g., behind the ear on the mastoid process. Each patch has a planar backscatter antenna with a passive device that encodes the return signal with a unique code for each user. The user also undergoes a brief calibration in which the unique code is recorded for the user, and the relationship of the patches to the ear canal is determined. Similarly, a full HRTF calibration may be performed. In a more sophisticated system, the patch includes a microphone, which encodes the backscatter signal with the actual sounds from the environment experienced by the patch on the listener near the ears. Of course, this patch is not required, and its presence obviates the need for heartbeat and respiration sensing. These detection types may coexist in a listening environment for different listeners, i.e., some listeners may register, while others are detected ad hoc.

Small beacon devices may also be provided, which are active transmitters, though this generally requires Wi-Fi transmission (to be compatible with the WiFi sensing system), which is power hungry. However, modern Wi-Fi protocols, such as 802.11ac, 802.11ax, 802.11be will inherently determine a vector between the access point and the radio, and certain protocols support indoor localization to determine distance as well, even without having multiple access points to triangulate or trilateralate position. In another case, a beacon may be an independent emitter that “interferes” with the WiFi, and is detected on that basis, as opposed to a engaging in cooperative communications.

While the present technology may operate using a single Wi-Fi radio system (typically with a number of antennas and receive channels), a multi-device cooperative system may also be provided. Further, the system may operate in a plurality of bands, e.g., 2.4 GHz, 5.8 GHz, and 6 Ghz. Where available, a 60 GHz band (V-band) radio (802.11ad, 802.11ay) may also be used. However, this is not required.

An implementation of the present technology is called “ComSense™”. ComSense™ employs Wi-Fi signals to accurately locate individuals, even behind walls and obstacles, utilizing signal processing and MIMO technology. Once an individual's location is determined, the system utilizes audio beamforming techniques to direct a focused sound beam to that specific location, ensuring private and clear communication. The through-wall RADAR functionality (whether or not actually transmitted through any wall) of ComSense™ extends to the determination of whether a subject has a heartbeat, providing an additional layer of information to distinguish individuals from inanimate objects and to isolate live humans from inanimate objects.

The technology is compatible with an array of Wi-Fi transmitters, such as may be included in loudspeakers distributed throughout a room, or other devices containing Wi-Fi, allowing for a dynamic and immersive audio experience. Other WiFi transceivers may be used, even those extrinsic to the Comsense™ system. Similarly, Bluetooth or Wi-Fi enabled speakers can receive coordinated audio signals for emission into the environment. These may of course be integrated with wired or internal speakers. ComSense™ has the capability to differentiate between individuals based on their specific audio needs. For example, it can adjust volume levels for subjects with hearing difficulties, providing personalized audio experiences.

A particular motivation for ComSense™ is that it permits operation without requiring use of imaging cameras that invade personal privacy. ComSense™ preserves privacy and adheres to privacy regulations by avoiding the use of cameras during normal use. No personal information or images are captured or shared, making it suitable for applications with strict privacy requirements. Training may use cameras in some cases, though non-imaging options are available to facilitate training that preserve privacy. While a camera might be used in initial setup, the camera may be removed or blocked during system use. In public environments, such as auditoriums or social spaces, the camera may remain available and used to assist in localization of people. However, the absence of camera for localization maintains privacy and adheres to privacy regulations, by ensuring no personal information or images are captured or shared. This also ensures security, in that no video streams are available to be intercepted.

ComSense™ allows different update rates for information on subjects' locations, providing flexibility in tracking and accommodating varying movement speeds. In some cases, this permits lower energy cost, and higher scalability for cost-effective hardware. In general, the updates for each listener will be automatic and continual, though in environments with large numbers of humans, selective updates may be useful. In some cases, the spatial audio is directed to a subset of the persons in an environment, and the system otherwise minimizes the sound level for other persons in the environment. While these other users may be tracked in order to map acoustic obstructions and interactions with intended targets, these persons need not be targeted by spatial audio streams.

By varying the heights of Wi-Fi transmitters and receivers, or otherwise exploiting room architecture with respect to radio reflective floors, ceilings or other structures, ComSense™ can achieve three-dimensional mapping of each subject's location and the position of their ears, enhancing the precision of audio delivery.

ComSense™ provides enhanced privacy and security in communication, particularly in situations where physical separation exists, without the need for cameras. The person location spatial information may also be used to provide improved situational awareness for law enforcement, emergency response teams, and security personnel while respecting privacy regulations, independent of spatial audio reproduction. For example, using a through-wall capability, the locations of persons obscured from view may be determined remotely. Further, the system may be used as an intercom without required receiver by the listener. Privacy of communications may be ensured by emission of masking sounds outside the region of the targeted listener(s). ComSense™ offers personalized audio experiences, accommodating individual audio preferences and needs.

The use of an array of Wi-Fi transmitters creates an immersive audio environment for enhanced communication and entertainment experiences. Each Wi-Fi transmitter may take the form of an interactive speaker. The entire network of networked speakers may be secure, and for example have a firewall to prevent exfiltration of personal information without specific authorization, maintain a log of communications, and perform other functions. On the other hand, the networked speakers may provide a Wi-Fi mesh network of access points for general use by persons in the environment. The system has potential applications in gaming, accessibility, personal security, and beyond. For example, the spatial audio need not be predetermined media content, and rather may be generated by a gaming system, wherein the spatial audio is exploited within the rules and play of the game. For example, a set of four players, may interact in a play zone, with the spatial audio system providing isolated communications to each respective player concurrently. Players may provide inputs to the system by use of gestures, body pose, activity, etc., that is captured by the RADAR.

The ComSense™ technology represents a significant advancement in communication and localization technology, with a wide range of potential applications across various industries. Its three-dimensional mapping capability adds a new dimension to precision in audio delivery and location tracking. ComSense™ uses Wi-Fi signals to accurately locate individuals, even behind walls and obstacles, using signal processing and MIMO technology. The location is advantageously used in audio beamforming to focusing sound beams to the exact locations of individuals for private and clear communication. This technology also allows the radar transceiver to be hidden or obscured. Using the Wi-Fi RADAR, human characteristics such as heartbeat and respiration may be detected, even where the individual is not within a line of sight. The ComSense™ system is compatibility with an array of Wi-Fi radios, such as distributed speakers, for dynamic and immersive audio experiences. It provides subject differentiation, customizing audio experiences based on individual audio needs, accommodating subjects with hearing difficulties.

In one aspect of the present invention, a system and method are provided for spatial audio technologies to create a complex immersive auditory scene that immerses one or more listeners, using a non-optical imaging sensor which defines a soundscape environment and the location of the listener's ears. For example, the sensor is a spatial RADAR sensor which spatially maps an environment.

The sensor is capable of not only determining location of persons within an environment, as well as objects within an environment, and especially sound reflective and absorptive materials. For example, data from the sensor may be used to generate a model for an nVidia VRWorks Audio implementation. developer.nvidia.com/vrworks/vrworks-audio; developer.nvidia.com/vrworks-audio-sdk-depth.

By mapping location of physical surfaces using a spatial sensor, the acoustic qualities of these surfaces using acoustic feedback sensing may be determined with higher reliability. A feedback system may be used during system calibration (and in some cases opportunistically during normal system operation) to sense the acoustic characteristics of object in the environment. For example, the acoustic system may generate a targeted beam directed at a location in the environment, and a microphone or directional microphone or microphone array listens for the response. The directed beam can scan the environment, and thus sound the properties of various surfaces. In some cases, the targeted object will vibrate in response to the beam, and the Wi-Fi sensing system may be used to detect the vibration, which will modulate the reflection. This is a source of spatial sensor fusion data to calibrate the Wi-Fi spatial model with the acoustic spatial model.

It is therefore an object to provide a spatialized sound method, comprising: mapping an environment using at least a Wi-Fi RADAR sensor, to determine at least a position of at least one listener's ears; receiving an audio program to be delivered to the listener; and transforming the audio program with a spatialization model, to generate an array of audio transducer signals for an audio transducer array representing spatialized audio, the spatialization model comprising parameters defining a head-related transfer function for the listener. The Wi-Fi RADAR sensor can also detect and characterize objects within the environment, and the spatial audio may be responsive to the characteristics of the objects. The spatial data is non-imaging, and therefore possible release of that data poses reduced privacy concerns as compared to imaging data. The physical state information for the at least one listener may be communicated through a network port to digital packet communication network.

It is also an object to provide a spatialized sound method, comprising: determining a position of at least one listener with a non-optical sensing technology such as Wi-Fi RADAR; receiving an audio program to be delivered to the listener and associated metadata; transforming the audio program with a spatialization model, to generate an array of audio transducer signals for an audio transducer array representing a spatialized audio program configured dependent on the received metadata, the spatialization model comprising parameters defining a head-related transfer function for the listener; and reproducing the spatialized audio program with a speaker array.

Another object provides a spatialized sound method, comprising: determining a position of at least one listener's heart with a Wi-Fi RADAR sensor based on a dynamic analysis of received radio waves; estimating a body pose of the at least one listener comprising the heart, based on a static analysis of the received radio waves; estimating a position of the listener's ears and an HRTF for the at least one lister; receiving an audio program to be delivered to the listener; transforming the audio program with a spatialization model dependent on the HRTF, to generate an array of audio transducer signals for an audio transducer array, the transformed audio program representing a spatialized audio program dependent on the determined positioner of the listener; and reproducing the spatialized audio program with a speaker array.

The method may further comprise receiving metadata with the audio program, the metadata representing a type of audio program, wherein the spatialization model is further dependent on the metadata. The metadata may comprise a metadata stream which varies during a course of presentation of the audio program. Data from the RADAR, LIDAR or acoustic sensor may be communicated to a remote server. An advertisement may be selectively delivered dependent on the data from the RADAR, LIDAR or acoustic sensor. The transformed audio program representing a spatialized audio program may be further dependent on at least one sensed object e.g., an inanimate object.

It is also an object to provide a spatialized sound system, comprising: a non-optical spatial mapping sensor, configured to map static and dynamic elements of an environment, to determine at least a position of at least one listener's ears in dependence on at least a dynamic anatomical feature of the listener; a signal processor configured to: transform a received audio program according to a spatialization model comprising parameters defining a head-related transfer function, to form spatialized audio; and generate an array of audio transducer signals for an audio transducer array representing the spatialized audio. The spatialization model may be further dependent on objects in the environment, and in particular objects sensed by the non-optical spatial mapping sensor. The system may further include a network port configured to communicate physical state information for the at least one listener through the digital packet communication network. A remote resource (e.g., a cloud processing center) may be used to process data from the non-optical spatial mapping sensor, communicated through the digital packet communication network. For example, the non-optical spatial mapping sensor is a Wi-Fi radio transceiver or coordinated set of radios, and the data communicated through the digital packet communication network is channel state information (CSI) data. The remote resource may return a spatial model of the environment for local processing of the spatial audio, or the spatialized audio itself.

The spatial mapping sensor may comprise an imaging or pseudo-imaging RADAR sensor having an antenna array. The imaging RADAR sensor having an antenna array comprises a RADAR operating in the 5 GHz, 6 GHz or 60 GHz band.

The audio transducer array may be provided within a single housing, and the spatial mapping sensor may be provided in the same housing. The spatial mapping sensor may comprise an imaging or pseudo-imaging RADAR sensor having an antenna array.

A body pose, sleep-wake state, cognitive state, or movement of the listener may be determined. An interaction between two listeners may be determined.

The physical state information is preferably not an optical image of an identifiable listener. Calibration data, on the other hand, may involve images or other personally identifiable information.

The spatial model may be calibrated based on images, LIDAR, structured lighting, acoustic sounding, human feedback, automated robotics, or other techniques. However, after calibration, the primary non-imaging sensor alone may be used to track movements.

Media content may be received through the network port selectively dependent on the physical state information.

Audio feedback may be received through at least one microphone, wherein the spatialization model parameters are further dependent on the audio feedback. Audio feedback may be analyzed for a listener command, and the command responded to. For example, an Amazon Alexa or Google Home client may be implemented within the system.

At least one advertisement may be communicated through the network port configured selectively dependent on the physical state information.

At least one financial account may be charged and/or debited selectively dependent on the physical state information.

The method may further comprise determining a location of ears of each a first listener and a second listener within the environment with a Wi-Fi RADAR system; and transforming the audio program with the spatialization model, to generate the array of audio transducer signals for the audio transducer array representing the spatialized audio, selectively dependent on the respective ear location and respective HRTF for each of the first listener and the second listener.

The method may further comprise determining presence of a first listener and a second listener; defining a first audio program for the first listener; defining a second audio program for the second listener; the first audio program and the second audio program being distinct; and transforming the first audio program and the second audio program with the spatialization model dependent on a determined position of both listener's ears, to generate the array of audio transducer signals for the audio transducer array representing the spatialized audio to deliver the first audio program to the first listener while suppressing the second audio program, and to deliver the second audio program to the second listener while suppressing the first audio program, selectively dependent on respective locations and HRTF for the first listener and the second listener.

The method may further comprise performing a statistical attention analysis of the physical state information for a plurality of listeners at a remote server, dependent on heart rate and heart rate variability, respiratory activity, body pose, and/or movement. The method may further comprise performing a statistical sentiment analysis of the physical state information for a plurality of listeners at a remote server. The method may further comprise performing a statistical analysis of the physical state information for a plurality of listeners at a remote server, and altering a broadcast signal for conveying media content dependent on the statistical analysis. The method may further comprise aggregating the physical state information for a plurality of listeners at a remote server, and adaptively defining a broadcast signal for conveying media content dependent on the aggregated physical state information.

The method may further comprise transforming the audio program with a digital signal processor or SIMD processor and/or GPU. The transforming may comprise processing the audio program and the physical state information with a digital signal processor.

The array of audio transducers signals may comprise a linear array of at least four audio transducers, e.g., 4, 5, 6, 7, 8, 9, 10, 12, 14, or 16 transducers. The audio transducer array may be a phased array of audio transducers having equal spacing along an axis.

The transforming may comprise cross-talk cancellation between a respective left ear and right ear of the at least one listener, though other means of channel separation, such as controlling the spatial emission patterns. For example, the spatial emission pattern for sounds intended for each ear may have a sharp fall-off along the sagittal plane. The acoustic amplitude pattern may have a cardioid shape with a deep and narrow notch aimed at the listener's nose. This spatial separation avoids the need for cross-talk cancellation, but is generally limited to a single listener. The transforming may comprise cross-talk cancellation between ears of at least two different listeners.

The audio spatialization may opportunistically target sound to objects in the environment, rather than line of sight to a listener. The location and acoustic characteristics of various object may be determined during a calibration period, in which the environment is sensed, and its spatial and acoustic characteristics determined.

The method may further comprise dynamically tracking a movement of the listener, and adapting the transforming dependent on the tracked movement in real time.

The HRTF of a listener may be adaptively determined.

A remote database record retrieval may be performed based on an identification or characteristic of the object, receiving parameters associated with the object, and employing the received parameters in the spatialization model.

The network port may be further configured to receive media content selectively dependent on the physical state information of the environment. The network port may be further configured to receive at least one media program selected dependent on the physical state information. The network port may be further configured to receive at least one advertisement selectively dependent on the physical state information.

A microphone may be configured to receive audio feedback, wherein the spatialization model parameters are further dependent on the audio feedback. The signal processor may be further configured to filter the audio feedback for a listener command (i.e., speech recognition), and responding to the command.

At least one automated processor may be provided, configured to charge and/or debit at least one financial account in an accounting database selectively dependent on the physical state information.

The signal processor or parallel processor may be further configured to determine a location of ears of each a first listener and a second listener within the environment based on radio wave reflections, penetration, and/or scattering, and to transform the audio program with the spatialization model, to generate the array of audio transducer signals for the audio transducer array representing the spatialized audio, selectively dependent on the respective ear location and respective HRTF for each of the first listener and the second listener.

The signal processor may be further configured to: determine presence and ear location of a first listener and a second listener; and transform a first audio program and a second audio program according to the spatialization model, to generate the array of audio transducer signals for the audio transducer array representing the spatialized audio to deliver the first audio program to the ears of first listener while suppressing the second audio program, and to deliver the second audio program to the ears of second listener while suppressing the first audio program, selectively dependent on respective ear locations and HRTF for the first listener and the second listener, and optionally at least one acoustic reflection off the object.

At least one automated processor may be provided, configured to perform at least one of a statistical attention analysis, and a statistical sentiment analysis of the physical state information for a plurality of listeners at a remote server. The automated processor may perform a statistical analysis of the physical state information for a plurality of listeners at a remote server, and to alter a broadcast signal for conveying media content dependent on the statistical analysis. The at least one automated processor may be configured to aggregate the physical state information for a plurality of listeners at a remote server, and to adaptively define a broadcast signal for conveying media content dependent on the aggregated physical state information.

The signal processor may comprise a single-instruction multiple-data (SIMD) parallel processor. The signal processor may be configured to perform a transform for cross-talk cancellation between a respective left ear and right ear of the at least one listener, and/or cross-talk cancellation between ears of at least two different listeners. The signal processor may track listener movement, and adapt the transformation dependent on the tracked movement.

Advantageously, the technology is integrated within a processor of a Wi-Fi access point, wherein the same processor (or multiprocessor or processor system) that determines the CSI also calculates spatial properties of the environment.

A remote database may be provided, configured to retrieve a record based on an identification or characteristic of the object, and communicate parameters associated with the object to the network port, wherein the signal processor may be further configured to employ the received parameters in the spatialization model.

The spatialized audio transducer may be a phased array or a sparse array. The array of audio transducers may be linear or curved. A sparse array is an array that has discontinuous spacing with respect to an idealized channel model, e.g., four or fewer sonic emitters, where the sound emitted from the transducers is internally modelled at higher dimensionality, and then reduced or superposed. In some cases, the number of sonic emitters is four or more, derived from a larger number of channels of a channel model, e.g., greater than eight.

3D acoustic fields are modelled from mathematical and physical constraints. The systems and methods provide a number of loudspeakers, i.e., free-field acoustic transmission transducers that emit into a space including both ears of the targeted listener. These systems are controlled by complex multichannel algorithms in real time.

The system may presume a fixed relationship between the sparse speaker array and the listener's ears, or a feedback system may be employed to track the listener's ears or head movements and position.

The algorithm employed provides surround-sound imaging and sound field control by delivering highly localized audio through an array of speakers. Typically, the speakers in a sparse array seek to operate in a wide-angle dispersion mode of emission, rather than a more traditional “beam mode,” in which each transducer emits a narrow angle sound field toward the listener. That is the transducer emission pattern is sufficiently wide to avoid sonic spatial nulls.

The system preferably supports multiple listeners within an environment, with ear position estimation for a plurality of listeners. For example, when two listeners are within the environment, nominally the same signal is sought to be presented to the left and right ears of each listener, regardless of their orientation in the room. In a non-trivial implementation, this requires that the multiple audio transducers cooperate to cancel left-ear emissions at each listener's right ear, and cancel right-ear emissions at each listener's left ear. However, heuristics may be employed to reduce the need for a minimum of a pair of transducers for each listener. In addition, the energy consumption of the system may be computed as a cost, to avoid high peak and average power outputs where not subjectively required for acceptable performance.

Typically, the spatial audio is not only normalized for binaural audio amplitude control, but also group delay, so that the correct sounds are perceived to be present at each ear at the right time. Therefore, in some cases, the signals may represent a compromise of fine amplitude and delay control.

The source content can thus be virtually steered to various angles so that different dynamically-varying sound fields can be generated for different listeners according to their location.

A signal processing method is provided for delivering spatialized sound in various ways using deconvolution filters to deliver discrete Left/Right ear audio signals from the speaker array. The method can be used to provide private listening areas in a public space, address multiple listeners with discrete sound sources, provide spatialization of source material for a single listener (virtual surround sound), and enhance intelligibility of conversations in noisy environments using spatial cues, to name a few applications.

In some cases, a microphone or an array of microphones may be used to provide feedback of the sound conditions at a voxel in space, such as at or near the listener's ears, such as in earrings or earbuds or a body worn apparatus. While it might initially seem that, with what amounts to a headset, one could simply use single transducers for each ear, the present technology does not constrain the listener to wear headphones, and the result is more natural. Further, the microphone(s) may be used to initially learn the room conditions, and then not be further required, or may be selectively deployed for only a portion of the environment. Finally, microphones may be used to provide interactive voice communications.

In a binaural mode, the speaker array produces two emitted signals, aimed generally towards the primary listener's ears-one discrete beam for each ear. The shapes of these beams are designed using a convolutional or inverse filtering approach such that the beam for one ear contributes almost no energy at the listener's other ear. This provides convincing virtual surround sound via binaural source signals. In this mode, binaural sources can be rendered accurately without headphones. A virtual surround sound experience is delivered without physical discrete surround speakers as well. Note that in a real environment, echoes of walls and surfaces color the sound and produce delays, and a natural sound emission will provide these cues related to the environment. The human ear has some ability to distinguish between sounds from front or rear, due to the shape of the ear and head, but the key feature for most source materials is timing and acoustic coloration. Thus, the liveness of an environment may be emulated by delay filters in the processing, with emission of the delayed sounds from the same array with generally the same beaming pattern as the main acoustic signal.

In one aspect, a method is provided for producing binaural sound from a speaker array in which a plurality of audio signals is received from a plurality of sources and each audio signal is filtered, through an HRTF based on the position and orientation of the listener's ears to the emitter array. The filtered audio signals are merged to form binaural signals. In a sparse transducer array, it may be desired to provide cross-over signals between the respective binaural channels, though in cases where the array is sufficiently directional to provide physical isolation of the listener's ears, and the position of the listener is well defined and constrained with respect to the array, cross-over may not be required. Typically, the audio signals are processed to provide cross talk cancellation.

When the source signal is prerecorded music or other processed audio, the initial processing may optionally remove the processing effects seeking to isolate original objects and their respective sound emissions, so that the spatialization is accurate for the soundstage. In some cases, the spatial locations inferred in the source are artificial, i.e., object locations are defined as part of a production process, and do not represent an actual position. In such cases, the spatialization may extend back to original sources, and seek to (re)optimize the process, since the original production was likely not optimized for reproduction through a spatialization system.

In a sparse linear speaker array, filtered/processed signals for a plurality of virtual channels are processed separately, and then combined, e.g., summed, for each respective virtual speaker into a single speaker signal, then the speaker signal is fed to the respective speaker in the speaker array and transmitted through the respective speaker to the listener.

The summing process may correct the time alignment of the respective signals. That is, the original complete array signals have time delays for the respective signals with respect to each ear. When summed without compensation, to produce a composite signal that signal would include multiple incrementally time-delayed representations, which arrive at the ears at different times, representing the same timepoint. Thus, the compression in space leads to an expansion in time. However, since the time delays are programmed per the algorithm, these may be algorithmically compressed to restore the time alignment. The result is that the spatialized sound has an accurate time of arrival at each ear, phase alignment, and a spatialized sound complexity.

In another aspect, a method is provided for producing a localized sound from a speaker array by receiving at least one audio signal, filtering each audio signal through a set of spatialization filters (each input audio signal is filtered through a different set of spatialization filters, which may be interactive or ultimately combined), wherein a separate spatialization filter path segment is provided for each speaker in the speaker array so that each input audio signal is filtered through a different spatialization filter segment, summing the filtered audio signals for each respective speaker into a speaker signal, transmitting each speaker signal to the respective speaker in the speaker array, and delivering the signals to one or more regions of the space (typically occupied by one or multiple listeners, respectively). In this way, the complexity of the acoustic signal processing path is simplified as a set of parallel stages representing array locations, with a combiner. An alternate method for providing two-speaker spatialized audio provides an object-based processing algorithm, which beam traces audio paths between respective sources, off scattering objects, to the listener's ears. This later method provides more arbitrary algorithmic complexity, and lower uniformity of each processing path.

In some cases, the spatial localization and/or spatialization and/or filters may be implemented as recurrent neural networks, convolutional neural networks, and/or deep neural networks, which produce spatialized audio streams, but without explicit discrete mathematical functions, and seeking an optimum overall effect rather than optimization of each effect in series or parallel. The network may be an overall network that receives the sound input and produces the sound output, or a channelized system in which each channel, which can represent space, frequency band, delay, source object, etc., is processed using a distinct network, and the network outputs combined. Further, the neural networks or other statistical optimization networks may provide coefficients for a generic signal processing chain, such as a digital filter, which may be finite impulse response (FIR) characteristics and/or infinite impulse response (IIR) characteristics, bleed paths to other channels, specialized time and delay equalizers (where direct implementation through FIR or IIR filters is undesired or inconvenient).

More typically, a discrete digital signal processing algorithm is employed to process the audio data, based on physical (or virtual) parameters. In some cases, the algorithm may be adaptive, based on automated or manual feedback. For example, a microphone may detect distortion due to resonances or other effects, which are not intrinsically compensated in the basic algorithm. Similarly, a generic HRTF may be employed, which is adapted based on actual parameters of the listener's head.

The RADAR spatial location and mapping sensor may be used to track both listeners (and either physically locate their ears in space, such as by using a camera, or inferentially locate their ears based on sensed information and statistical head and body pose models), as well as objects e.g., inanimate objects, such as floor, ceiling, walls, furniture, and the like. Advantageously, the spatialization algorithm considers both direct transmission of acoustic waves through the air and reflected waves off surfaces. Further, the spatialization algorithm may consider multiple listeners and multiple objects in a soundscape, and their dynamic changes over time. In most cases, the SLAM sensor does not directly reveal acoustic characteristics of an object. However, there is typically sufficient information and context to identify the object, and based on that identification, a database lookup may be performed to provide typical acoustic characteristics for that type of object. A microphone or microphone array may be used to adaptively tune the algorithm. For example, a known signal sequence may be emitted from the speaker array, and the environment response received at the microphone used to calculate acoustic parameters. Since the emitted sounds from the speaker array are known, the media sounds may also be used to tune the spatialization parameters, similar to typical adaptive echo cancellation. Indeed, echo cancellation algorithms may be used to parameterize time, frequency-dependent attenuation, resonances, and other factors. The SLAM sensor can assist in making physical sense of the 1D acoustic response received at a respective microphone.

In a further aspect, a speaker array system for producing localized sound comprises an input which receives a plurality of audio signals from at least one source; a computer with a processor and a memory which determines whether the plurality of audio signals should be processed by an audio signal processing system; a speaker array comprising a plurality of loudspeakers; wherein the audio signal processing system comprises: at least one HRTF, which either senses or estimates a spatial relationship of the listener to the speaker array; and combiners configured to combine a plurality of processing channels to form a speaker drive signal. The audio signal processing system implements spatialization filters; wherein the speaker array delivers the respective speaker signals (or the beamforming speaker signals) through the plurality of loudspeakers to one or more listeners.

By beamforming, it is intended that the emission of the transducer is not omnidirectional, and rather has an axis of emission, with separation between left and right ears greater than 2 or 3 dB, preferably greater than 4 to 6 dB, more preferably more than 8, 9 or 10 dB, and with active cancellation between transducers, higher separations may be achieved.

The plurality of audio signals can be processed by the digital signal processing system including binauralization before being delivered to the one or more listeners through the plurality of loudspeakers.

A Wi-Fi RADAR system for listener ear-tracking may be provided which adjusts the binaural processing system and acoustic processing system based on a change or inferred change in a location of the one or more listener's ears. The Wi-Fi RADAR system may operate on CSI data from the Wi-Fi processor, and without other direct access to raw radio wave data, using a neural network processor to translate a stream of CSI data into a reliable location of listener's ears. The Wi-Fi RADAR system may also map static radio wave interactive objects within an environment, and associate the map of the objects with acoustic characteristics. The acoustic characteristics may be determined adaptively during use and/or in a separate calibration phase of operation.

The binaural processing system may further comprise a binaural processor which computes the left HRTF and right HRTF, or a composite HRTF in real-time.

The method employs algorithms that produce binaural sound-targeted sound to the location of each ear-without the use of headphones, by using deconvolution or inverse filters and physical or virtual beamforming. In this way, a virtual surround sound experience can be delivered to the listener of the system. The system avoids the use of classical two-channel “cross-talk cancellation” to provide superior speaker-based binaural sound imaging.

Binaural 3D sound reproduction is a type of sound reproduction achieved by headphones. On the other hand, transaural 3D sound reproduction is a type of sound reproduction achieved by loudspeakers. See, Kaiser, Fabio. “Transaural Audio—The reproduction of binaural signals over loudspeakers.” PhD diss., Diploma Thesis, Universitst for Musik und darstellende Kunst Graz/Institut for Elekronische Musik und Akustik/IRCAM, March 2011, 2011. Transaural audio is a three-dimensional sound spatialization technique which is capable of reproducing binaural signals over loudspeakers. It is based on the cancellation of the acoustic paths occurring between loudspeakers and the listeners ears.

Studies in psychoacoustics reveal that well recorded stereo signals and binaural recordings contain cues that help create robust, detailed 3D auditory images. By focusing left and right channel signals at the appropriate ear, one implementation of 3D spatialized audio, called “MyBeam” (Comhear Inc., San Diego CA) maintains key psychoacoustic cues while avoiding crosstalk via precise beamformed directivity.

HRTF component cues generally comprise interaural time difference (ITD, the difference in arrival time of a sound between two locations), the interaural intensity difference (IID, the difference in intensity of a sound between two locations, sometimes called ILD), and interaural phase difference (IPD, the phase difference of a wave that reaches each ear, dependent on the frequency of the sound wave and the ITD). Once the listener's brain has analyzed IPD, ITD, and ILD, the location of the sound source can be determined with relative accuracy.

A preferred signal processing method allows a small speaker array to deliver sound in various ways using highly optimized inverse filters, delivering narrow beams of sound to the listener while producing negligible artifacts. Unlike earlier compact beamforming audio technologies, the method does not rely on ultra-sonic or high-power amplification. The technology may be implemented using low power technologies, producing 98 dB SPL at one meter, while utilizing around 20 watts of peak power. In the case of speaker applications, the primary use-case allows sound from a small (10″-20″) linear array of speakers to focus sound in narrow beams to: Direct sound in a highly intelligible manner where it is desired and effective; limit sound where it is not wanted or where it may be disruptive; and provide non-headphone based, high definition, steerable audio imaging in which a stereo or binaural signal is directed to the ears of the listener to produce vivid 3D audible perception.

In the case of microphone applications, the basic use-case allows sound from an array of microphones (ranging from a few small capsules to dozens in 1-, 2- or 3-dimensional arrangements) to capture sound in narrow beams. These beams may be dynamically steered and may cover many talkers and sound sources within its coverage pattern, amplifying desirable sources and providing for cancellation or suppression of unwanted sources.

In a multipoint teleconferencing or videoconferencing application, the technology allows distinct spatialization and localization of each participant in the conference, while reducing overlap. Such overlap can make it difficult to distinguish among the different participants without having each participant identify themselves each time he or she speaks, which can detract from the feel of a natural, in-person conversation.

The audio output system may virtualize a 12-channel beamforming array to two channels. In general, the algorithm downmixes each pair of 6 channels (designed to drive a set of 6 equally spaced-speakers in a line array) into a single speaker signal for a speaker that is mounted in the middle of where those 6 speakers would be. Typically, the virtual line array is 12 speakers, with 2 real speakers located between elements 3-4 and 9-10. The real speakers are mounted directly in the center of each set of 6 virtual speakers. If (s) is the center-to-center distance between speakers, then the distance from the center of the array to the center of each real speaker is: A=3*s. The left speaker is offset −A from the center, and the right speaker is offset A. The primary algorithm is simply a downmix of the 6 virtual channels, with a limiter and/or compressor applied to prevent saturation or clipping. For example, the left channel is: Lₒᵤₜ=Limit(L₁+L₂+L₃+L₄+L₅+L₆)

However, because of the change in positions of the source of the audio, the delays between the speakers need to be taken into account as described below. In some cases, the phase of some drivers may be altered to limit peaking, while avoiding clipping or limiting distortion.

Since six speakers are being combined into one at a different location, the change in distance travelled, i.e. delay, to the listener can be significant particularly at higher frequencies. The delay can be calculated based on the change in travelling distance between the virtual speaker and the real speaker. For this discussion, we will only concern ourselves with the left side of the array. The right side is similar but inverted. To calculate the distance from the listener to each virtual speaker, assume that the speaker, n, is numbered 1 to 6, where 1 is the speaker closest to the center, and 6 is the farthest left. The distance from the center of the array to the speaker is: d=((n−1)+0.5)*s

Using the Pythagorean theorem, the distance from the speaker to the listener can be calculated as follows: dₙ={square root over (l²+(((n−1)+0.5)*s)²)}. The distance from the real speaker to the listener is dᵣ=\sqrt{l²+(3*s)²}

The sample delay for each speaker can be calculated by the different between the two listener distances. This can them be converted to samples (assuming the speed of sound is 343 m/s and the sample rate is 48 kHz.

$$delay = \frac{( {d}_{n} - {d}_{r} )}{343 \frac{m}{s}} * 48000 Hz .$$

This can lead to a significant delay between listener distances. For example, if the speaker-to-speaker distance is 38 mm, and the listener is 500 mm from the array, the delay from the virtual far-left speaker (n=6) to the real speaker is:

$${d}_{n} = \sqrt{{\text{.5}}^{2} + {( 5.5 * \text{.038} )}^{2}} = \text{.541} m , \\ {d}_{r} = \sqrt{{\text{.5}}^{2} + {( 3 * \text{.038} )}^{2}} = \text{.513} m delay = \frac{\text{.541} - \text{.512}}{343} * 48000 = 4 samples$$

Though the delay seems small, the amount of delay is significant, particularly at higher frequencies, e.g., 12 kHz, an entire cycle (360°) may be as little as 3 or 4 samples. Speaker 1: −2 delay, Speaker 2: −1 delay, Speaker 3: −1 delay, Speaker 4: +1 delay, Speaker 5: +2 delay, Speaker 6: +4 delay (delay relative to real speaker).

Thus, when combining the signals for the virtual speakers into the physical speaker signal, the time offset is preferably compensated based on the displacement of the virtual speaker from the physical one. This can be accomplished at various places in the signal processing chain.

When using a virtual speaker array that is represented through a physical array having a smaller number of transducers, the ability to localize sound for multiple listeners is reduced. Therefore, where a large audience is considered, providing spatialized audio to each listener based on a respective HRTF for each listener becomes difficult. In such cases, the strategy is typically to provide a large physical separation between speakers, so that the line of sight for a respective listener for each speaker is different, leading to stereo audio perception. However, in some cases, such as where different listeners are targeted with different audio programs, a large baseline stereo system is ineffective. In a large physical space with a sparse population of listeners, the SLAM sensor permits effective localization for ears of each of the individual users.

The present technology therefore provides downmixing of spatialized audio virtual channels to maintain delay encoding of virtual channels while minimizing the number of physical drivers and amplifiers required.

At similar acoustic output, the power per speaker will, of course, be higher with the downmixing, and this leads to peak power handling limits. Given that the amplitude, phase, and delay of each virtual channel is important information, the ability to control peaking is limited. However, given that clipping or limiting is particularly dissonant, control over the other variables is useful in achieving a high power rating. Control may be facilitated by operating on a delay, for example in a speaker system with a 30 Hz lower range, a 125 mS delay may be imposed, to permit calculation of all significant echoes and peak clipping mitigation strategies. Where video content is also presented, such a delay may be reduced. However, delay is not required.

In some cases, the listener is not centered with respect to the physical speaker transducers, or multiple listeners are dispersed within an environment. Further, the peak power to a physical transducer resulting from a proposed downmix may exceed a limit. The downmix algorithm in such cases, and others, may be adaptive or flexible, and provide different mappings of virtual transducers to physical speaker transducers.

For example, due to listener location or peak level, the allocation of virtual transducers in the virtual array to the physical speaker transducer downmix may be unbalanced, such as, in an array of 12 virtual transducers, 7 virtual transducers downmixed for the left physical transducer, and 5 virtual transducers for the right physical transducer. This has the effect of shifting the axis of sound, and also shifting the additive effect of the adaptively assigned transducer to the other channel. If the transducer is out of phase with respect to the other transducers, the peak will be abated, while if it is in phase, constructive interference will result.

The reallocation may be of the virtual transducer at a boundary between groups, or may be a discontinuous virtual transducer. Similarly, the adaptive assignment may be of more than one virtual transducer.

In addition, the number of physical transducers may be an even or odd number greater than 2, and generally less than the number of virtual transducers. In the case of three physical transducers, generally located at nominal left, center, and right, the allocation between virtual transducers and physical transducers may be adaptive with respect to group size, group transition, continuity of groups, and possible overlap of groups (i.e., portions of the same virtual transducer signal being represented in multiple physical channels) based on location of listener (or multiple listeners), spatialization effects, peak amplitude abatement issues, and listener preferences.

The system may employ various technologies to implement an optimal HRTF. In the simplest case, an optimal prototype HRTF is used regardless of listener and environment. In other cases, the characteristics of the listener(s) are determined by logon, direct input, camera, biometric measurement, or other means, and a customized or selected HRTF selected or calculated for the particular listener(s). This is typically implemented within the filtering process, independent of the downmixing process, but in some cases, the customization may be implemented as a post-process or partial post-process to the spatialization filtering. That is, in addition to downmixing, a process after the main spatialization filtering and virtual transducer signal creation may be implemented to adapt or modify the signals dependent on the listener(s), the environment, or other factors, separate from downmixing and timing adjustment.

As discussed above, limiting the peak amplitude is potentially important, as a set of virtual transducer signals, e.g., 6, are time aligned and summed, resulting in a peak amplitude potentially six times higher than the peak of any one virtual transducer signal. One way to address this problem is to simply limit the combined signal or use a compander (non-linear amplitude filter). However, these produce distortion, and will interfere with spatialization effects. Other options include phase shifting of some virtual transducer signals, but this may also result in audible artifacts, and requires imposition of a delay. Another option provided is to allocate virtual transducers to downmix groups based on phase and amplitude, especially those transducers near the transition between groups. While this may also be implemented with a delay, it is also possible to near instantaneously shift the group allocation, which may result in a positional artifact, but not a harmonic distortion artifact. Such techniques may also be combined, to minimize perceptual distortion by spreading the effect between the various peak abatement options.

In one general aspect, a method may include sensing characteristics of an environment having at least one human by receiving radio frequency signals, using the sensed characteristics to analyze at least one human dynamic physiological pattern of each human, estimating a body pose and head position within the environment of each human based on the sensed characteristics and the at least one human dynamic physiological pattern, and using an estimated position of the ears of each human in conjunction with an HRTF to generate spatialized audio.

In another general aspect, an audio spatialization system may include a RADAR device configured to emit RADAR signals toward a head of an user and receive signals from the head of the user, where the RADAR device is configured to determine one or more HRTF locations along an azimuthal path of an azimuth extending around the head of the user based on the reflected signals, and an audio device configured to emit sounds toward the head of the user and receive sounds from ear canal entrances of the user, where the audio device is configured to measure one or more HRTFs corresponding to the one or more HRTF locations based on the received sounds.

In a further general aspect, a communication system may include a Wi-Fi-transmitter based RADAR system operating within an environment, a heartbeat detection mechanism for distinguishing human individuals from inanimate objects, at least one processor to locate ears of the distinguished human individuals, and an audio beamforming system for directing sound beams to the locations the ears of the human individuals.

In a still further general aspect, a non-transitory computer-readable medium is provided that includes instructions that, when executed by one or more processors of a device, cause the device to: sense characteristics of an environment having at least one human by receiving radio frequency signals; use the sensed characteristics to analyze at least one human dynamic physiological pattern of each human; estimate a body pose and head position within the environment of each human based on the sensed characteristics and the at least one human dynamic physiological pattern; use an estimated position of the ears of each human in conjunction with an HRTF to generate spatialized audio.

In another general aspect, the system may include one or more processors configured to sense characteristics of an environment having at least one human by receiving radio frequency signals, use the sensed characteristics to analyze at least one human dynamic physiological pattern of each human, estimate a body pose and head position within the environment of each human based on the sensed characteristics and the at least one human dynamic physiological pattern, and use an estimated position of the ears of each human in conjunction with an HRTF to generate spatialized audio.

It is an object to provide a spatialized audio method, comprising: analyzing characteristics of an environment comprising at least one human, each human having a dynamic physiological patterns, by transmitting radio frequency signals and analyzing received radio frequency signals; estimating a body pose, head and ear position within the environment of each human based on the analyzed characteristics of the environment and the sensed dynamic physiological patterns and the at least one human dynamic physiological pattern of each human; and generating spatialized audio for each human in the environment using an estimated head and ear position within the environment of each human in conjunction with a head-related transfer function.

The dynamic physiological patterns of each human may comprise a heartbeat pattern, and/or a respiration pattern. The sensed characteristics may comprise a Doppler shift of the radio frequency signals due to movements associated with the dynamic physiological patterns of each human.

The radio frequency signals may be channelized into a plurality of radio frequency subchannels, the method further comprising determining channel state information for the plurality of radio frequency subchannels. The plurality of radio frequency subchannels may be orthogonal frequency channels, and the channel state information may comprises phase information and amplitude information.

The radio frequency signals may comprise radio frequency waves having a frequency over 5 GHz, e.g., 5.8 GHZ, 5.9 GHz. 6 GHz, 7 GHz, or 60 GHz. The radio frequency signals comprise radio frequency waves emitted and analyzed by a radio compliant with IEEE-802.11ax or IEEE-802.11be. The radio may be compliant with IEEE-802.11bf.

The estimating may comprise feeding the received radio frequency signals to a neural network responsive to a human heartbeat and human respiration, the neural network being trained with training data comprising received radio frequency signals tagged with human ear location. The estimating may also comprise feeding the received radio frequency signals to a neural network responsive to extract a human body pose for each human.

The generated spatialized audio may comprise aggregated virtualized audio transducer signals.

It is another object to provide a spatialized audio system comprising: a radar device configured to emit radar signals into a region comprising a listener and receive scattered radar signals from the listener; at least one automated processor configured to process the received scattered radar signals to determine one or more ear locations for determination of a head-related transfer function (HRTF); and a spatialized audio emitter configured to emit spatialized audio sounds dependent on the head related transfer function. The radar device may be further configured to determine one or more distances between the radar device and the listener. The spatialized audio system may further comprise an audio feedback device configured to receive audio signals from locations proximate to ear canals of the listener, to calibrate the determination of the HRTF and the emission of the spatialized audio sounds. The audio feedback device may be removed after calibration, or be maintained during use.

The radar device may be configured to extract a heartbeat pattern and a respiration pattern from the listener, and infer an ear location based on the extracted heartbeat pattern and respiration pattern from the listener. The at least one processor may implement a neural network trained with received scattered radar signals tagged with ear location of the listener in the region. The source audio for the spatialized audio emitter may be received through the radio compliant with IEEE-802.11 ax or IEEE-802.11be.

It is a further object to provide a system for targeting spatialized audio to ears of a listener comprising: an input port configured to receive an audio signal; one or more processors configured to: sense characteristics of an environment comprising a listener by receiving radio frequency signals; analyze at least one dynamic physiological pattern of the listener in the sensed characteristics; estimate a body pose and ear position within the environment of the listener, based on the sensed characteristics and the at least one dynamic physiological pattern; and define a head-related transfer function for the listener dependent on the estimated body pose and ear position; and an output port configured to communicate a signal defining spatialized audio for the listener.

A still further object provides method of estimating a body pose, comprising: defining a set of objects within an environment; detecting scattering of radio waves in the environment from a body and the set of objects comprising dynamically varying signals from a heartbeat and from respiration; processing the detected scattered radio waves, with a predictive machine learning model trained on a data set associating detected scattered radio waves and corresponding body pose; and outputting a signal representing a predicted body pose of the body, responsive to the dynamically varying signals from the heartbeat and from the respiration.

Another object provides a method of determining an emotional or attentional state of an observer, comprising: receiving RF signals scattered from the observer, comprising signal responsive to heartbeat and respiration; processing the received RF signals to determine heart rate, heart rate variability, and respiration; and determining the emotional or attentional state of the observer based on the RF signals.

A machine learning system can be trained to estimate or predict body pose, emotional state, attentional state, etc., using training data. The training data, e.g., labelled training data, is typically data obtained with a similar, identical or the same radio frequency system and environment as the end use. When the training data is from the same system, normalization may be avoided, and complex multipath returns provide useful information. In many cases, it is preferred to extract position and orientation of the heartbeat based on deterministic algorithms, using vector math to calculate displacement and Doppler vectors and locations. This data may then be fed to a trained machine learning algorithm, which then yields the information relating to pose, attention, or emotional state. In similar manner, other characteristics may be learned, such as caloric consumption during exercise, falls, syncope, respiratory distress, apnea, etc.

### BRIEF DESCRIPTION OF THE DRAWINGS

FIGS. 1A and 1B show diagrams illustrating the wave field synthesis (WFS) mode operation used for private listening (FIG. 1A) and the use of WFS mode for multi-user, multi-position audio applications (FIG. 1B).

FIG. 2 is a block diagram showing the WFS signal processing chain.

FIG. 3 is a diagrammatic view of an exemplary arrangement of control points for WFS mode operation.

FIG. 4 is a diagrammatic view of a first embodiment of a signal processing scheme for WFS mode operation.

FIG. 5 is a diagrammatic view of a second embodiment of a signal processing scheme for WFS mode operation.

FIGS. 6A-6E are a set of polar plots showing measured performance of a prototype speaker array with the beam steered to 0 degrees at frequencies of 10000, 5000, 2500, 1000, and 600 Hz, respectively.

FIG. 7A is a diagram illustrating the basic principle of binaural mode operation.

FIG. 7B is a diagram illustrating binaural mode operation as used for spatialized sound presentation.

FIG. 8 is a block diagram showing an exemplary binaural mode processing chain.

FIG. 9 is a diagrammatic view of a first embodiment of a signal processing scheme for the binaural modality.

FIG. 10 is a diagrammatic view of an exemplary arrangement of control points for binaural mode operation.

FIG. 11 is a block diagram of a second embodiment of a signal processing chain for the binaural mode.

FIGS. 12A and 12B illustrate simulated frequency domain and time domain representations, respectively, of predicted performance of an exemplary speaker array in binaural mode measured at the left ear and at the right ear.

FIG. 13 shows the relationship between the virtual speaker array and the physical speakers.

FIG. 14 shows a schematic representation of a spatial sensor-based spatialized audio adaptation system.

FIG. 15 is a network framework for capturing human pose figures. The upper part is for training supervision using video data, while the lower part is for human pose extraction from WiFi signals.

FIG. 16 is a flowchart of an embodiment of the invention.

### DETAILED DESCRIPTION OF THE PREFERRED EMBODIMENTS

### Audio Spatialization

In binaural mode, the speaker array provides two sound outputs aimed towards the primary listener's ears. These locations are determined as discussed herein, preferably using a Wi-Fi RADAR to predict the location of the listener's ears based on various data and inferences, such as heart and chest wall location, as well as body pose, as well as direct measurement of head location and orientation.

Thus, the location of the listener's ears within the environment may be estimated using Wi-Fi localization, and various environmental and anatomical constraints used to increase reliability of the estimate and constrain the space within the ears may be contained. In some cases, the Wi-Fi sensing may be augmented with other sensors and beacons, such as cameras, retroreflectors, radio frequency identification transponders, and the like.

The inverse filter design method comes from a mathematical simulation in which a speaker array model approximating the real-world is created and virtual microphones are placed throughout the target sound field. A target function across these virtual microphones is created or requested. Solving the inverse problem using regularization, stable and realizable inverse filters are created for each speaker element in the array. The source signals are convolved with these inverse filters for each array element.

In a beamforming, or wave field synthesis (WFS), mode, the transform processor array provides sound signals representing multiple discrete sources to separate physical locations in the same general area. Masking signals may also be dynamically adjusted in amplitude and time to provide optimized masking and lack of intelligibility of listener's signal of interest. The WFS mode also uses inverse filters. Instead of aiming just two beams at the listener's ears, this mode uses multiple beams aimed or steered to different locations around the array.

The technology involves a digital signal processing (DSP) strategy that allows for both binaural rendering and WFS/sound beamforming, either separately or simultaneously in combination. As noted above, the virtual spatialization is then combined for a small number of physical transducers, e.g., 2 or 4.

For both binaural and WFS mode, the signal to be reproduced is processed by filtering it through a set of digital filters. These filters may be generated by numerically solving an electro-acoustical inverse problem. The specific parameters of the specific inverse problem to be solved are described below. In general, however, the digital filter design is based on the principle of minimizing, in the least squares sense, a cost function of the type J=E+βV.

The cost function is a sum of two terms: a performance error E, which measures how well the desired signals are reproduced at the target points, and an effort penalty βV, which is a quantity proportional to the total power that is input to all the loudspeakers. The positive real number β is a regularization parameter that determines how much weight to assign to the effort term. Note that, according to the present implementation, the cost function may be applied after the summing, and optionally after the limiter/peak abatement function is performed.

By varying β from zero to infinity, the solution changes gradually from minimizing the performance error only to minimizing the effort cost only. In practice, this regularization works by limiting the power output from the loudspeakers at frequencies at which the inversion problem is ill-conditioned. This is achieved without affecting the performance of the system at frequencies at which the inversion problem is well-conditioned. In this way, it is possible to prevent sharp peaks in the spectrum of the reproduced sound. If necessary, a frequency dependent regularization parameter can be used to attenuate peaks selectively.

### Wave Field Synthesis/Beamforming Mode

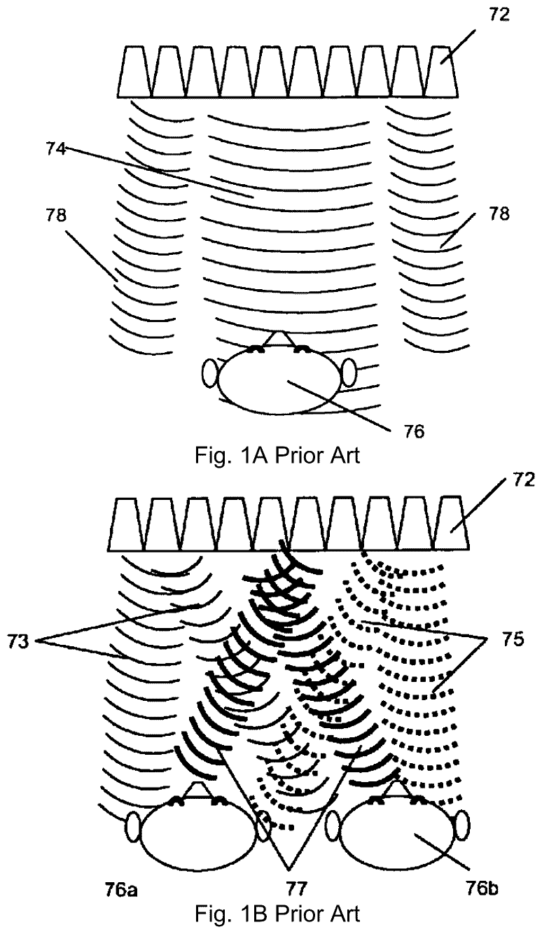

WFS sound signals are generated for a linear array of virtual speakers, which define several separated sound beams. In WFS mode operation, different source content from the loudspeaker array can be steered to different angles by using narrow beams to minimize leakage to adjacent areas during listening. As shown in FIG. 1A, private listening is made possible using adjacent beams of music and/or noise delivered by loudspeaker array 72. The direct sound beam 74 is heard by the target listener 76, while beams of masking noise 78, which can be music, white noise or some other signal that is different from the main beam 74, are directed around the target listener to prevent unintended eavesdropping by other persons within the surrounding area. Masking signals may also be dynamically adjusted in amplitude and time to provide optimized masking and lack of intelligibility of listener's signal of interest as shown in later figures which include the DRCE DSP block.

When the virtual speaker signals are combined, a significant portion of the spatial sound cancellation ability is lost; however, it is at least theoretically possible to optimize the sound at each of the listener's ears for the direct (i.e., non-reflected) sound path.

In the WFS mode, the array provides multiple discrete source signals. For example, three people could be positioned around the array listening to three distinct sources with little interference from each others' signals. FIG. 1B illustrates an exemplary configuration of the WFS mode for multi-user/multi-position application. With only two speaker transducers, full control for each listener is not possible, though through optimization, an acceptable (improved over stereo audio) is available. As shown, array 72 defines discrete sounds beams 73, 75, and 77, each with different sound content, to each of listeners 76a and 76b. While both listeners are shown receiving the same content (each of the three beams), different content can be delivered to one or the other of the listeners at different times. When the array signals are summed, some of the directionality is lost, and in some cases, inverted. For example, where a set of 12 speaker array signals are summed to 4 speaker signals, directional cancellation signals may fail to cancel at most locations. However, preferably adequate cancellation is preferably available for an optimally located listener.

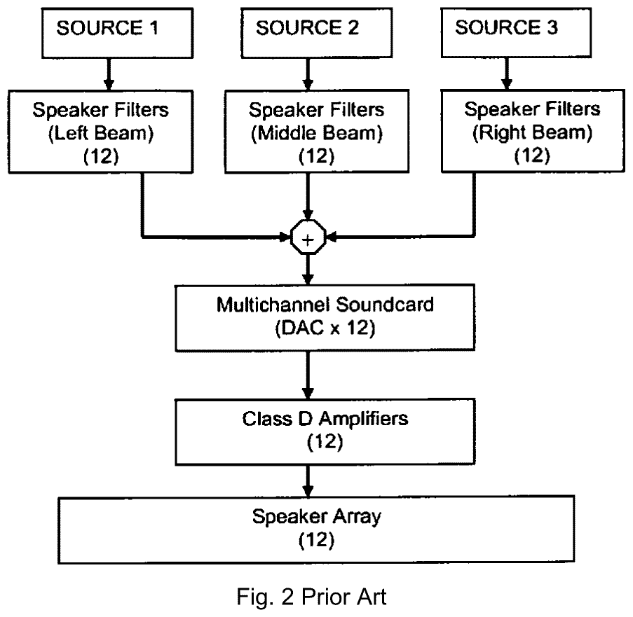

The WFS mode signals are generated through the DSP chain as shown in FIG. 2. Discrete source signals 801, 802, and 803 are each convolved with inverse filters for each of the loudspeaker array signals. The inverse filters are the mechanism that allows that steering of localized beams of audio, optimized for a particular location according to the specification in the mathematical model used to generate the filters. The calculations may be done real-time to provide on-the-fly optimized beam steering capabilities which would allow the users of the array to be tracked with audio. In the illustrated example, the loudspeaker array 812 has twelve elements, so there are twelve filters 804 for each source. The resulting filtered signals corresponding to the same n^{th} loudspeaker signal are added at combiner 806, whose resulting signal is fed into a multi-channel soundcard 808 with a DAC corresponding to each of the twelve speakers in the array. The twelve signals are then divided into channels, i.e., 2 or 4, and the members of each subset are then time adjusted for the difference in location between the physical location of the corresponding array signal, and the respective physical transducer, and summed, and subject to a limiting algorithm. The limited signal is then amplified using a class D amplifier 810 and delivered to the listener(s) through the two or four speaker array 812.

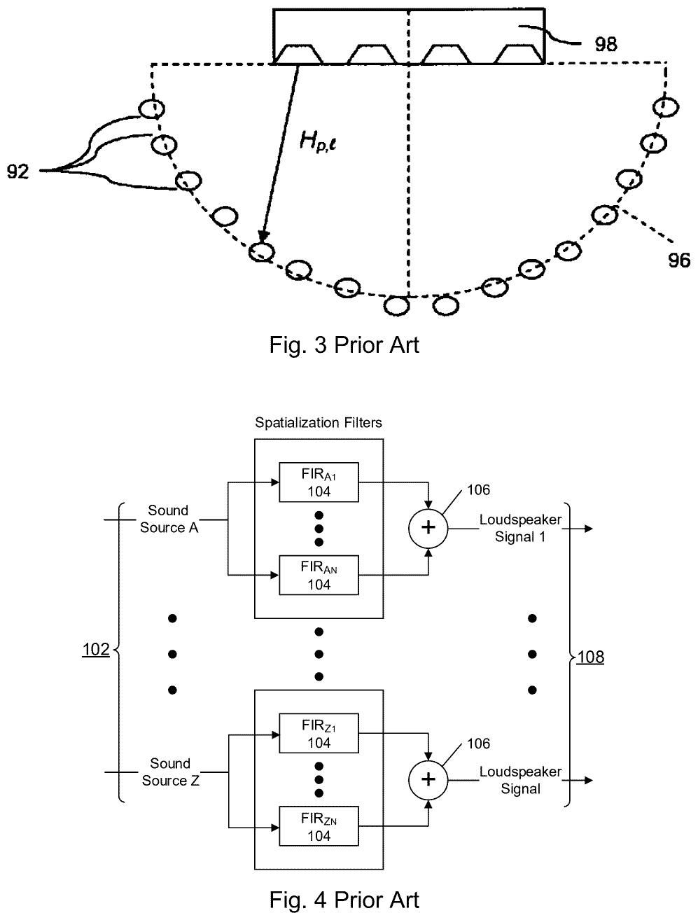

FIG. 3 illustrates how spatialization filters are generated. Firstly, it is assumed that the relative arrangement of the N array units is given. A set of M virtual control points 92 is defined where each control point corresponds to a virtual microphone. The control points are arranged on a semicircle surrounding the array 98 of N speakers and centered at the center of the loudspeaker array. The radius of the arc 96 may scale with the size of the array. The control points 92 (virtual microphones) are uniformly arranged on the arc with a constant angular distance between neighboring points.

An M×N matrix H(t) is computed, which represents the electro-acoustical transfer function between each loudspeaker of the array and each control point, as a function of the frequency f, where H_{p,}l corresponds to the transfer function between the l^{th} speaker (of N speakers) and the p^{th} control point 92. These transfer functions can either be measured or defined analytically from an acoustic radiation model of the loudspeaker. One example of a model is given by an acoustical monopole, given by the following equation:

$${H}_{p , ℓ ( f )} = \frac{exp [ - j 2 π {fr}_{p , ℓ} / c ]}{4 π {r}_{p , ℓ}}$$

where c is the speed of sound propagation, f is the frequency and r_{p,l} is the distance between the l^{th} loudspeaker and the p^{th} control point.

Instead of correcting for time delays after the array signals are fully defined, it is also possible to use the correct speaker location while generating the signal, to avoid reworking the signal definition.

A more advanced analytical radiation model for each loudspeaker may be obtained by a multipole expansion, as is known in the art. (See, e.g., V. Rokhlin, “Diagonal forms of translation operators for the Helmholtz equation in three dimensions”, Applied and Computations Harmonic Analysis, 1:82-93, 1993.)

A vector p(t) is defined with M elements representing the target sound field at the locations identified by the control points 92 and as a function of the frequency f. There are several choices of the target field. One possibility is to assign the value of 1 to the control point(s) that identify the direction(s) of the desired sound beam(s) and zero to all other control points.

The digital filter coefficients are defined in the frequency (f) domain or digital-sampled (z)-domain and are the N elements of the vector a(t) or a(z), which is the output of the filter computation algorithm. The filer may have different topologies, such as FIR, IIR, or other types. The vector a is computed by solving, for each frequency for sample parameter z, a linear optimization problem that minimizes e.g., the following cost function J(f)=∥H(f)a(f)−p(f)∥²+β∥a(f)∥². The symbol ∥ . . . ∥ indicates the L² norm of a vector, and β is a regularization parameter, whose value can be defined by the designer. Standard optimization algorithms can be used to numerically solve the problem above.

Referring now to FIG. 4, the input to the system is an arbitrary set of audio signals (from A through Z), referred to as sound sources 102. The system output is a set of audio signals (from 1 through N) driving the N units of the loudspeaker array 108. These N signals are referred to as “loudspeaker signals”.

For each sound source 102, the input signal is filtered through a set of N digital filters 104, with one digital filter 104 for each loudspeaker of the array. These digital filters 104 are referred to as “spatialization filters”, which are generated by the algorithm disclosed above and vary as a function of the location of the listener(s) and/or of the intended direction of the sound beam to be generated.

The digital filters may be implemented as finite impulse response (FIR) filters; however, greater efficiency and better modelling of response may be achieved using other filter topologies, such as infinite impulse response (IIR) filters, which employ feedback or re-entrancy. The filters may be implemented in a traditional DSP architecture, or within a graphic processing unit (GPU, developer.nvidia.com/vrworks-audio-sdk-depth) or audio processing unit (APU, www.nvidia.com/en-us/drivers/apu/). Advantageously, the acoustic processing algorithm is presented as a ray tracing, transparency, and scattering model.

For each sound source 102, the audio signal filtered through the n^{th} digital filter 104 (i.e., corresponding to the n^{th} loudspeaker) is summed at combiner 106 with the audio signals corresponding to the different audio sources 102 but to the same n^{th} loudspeaker. The summed signals are then output to loudspeaker array 108.

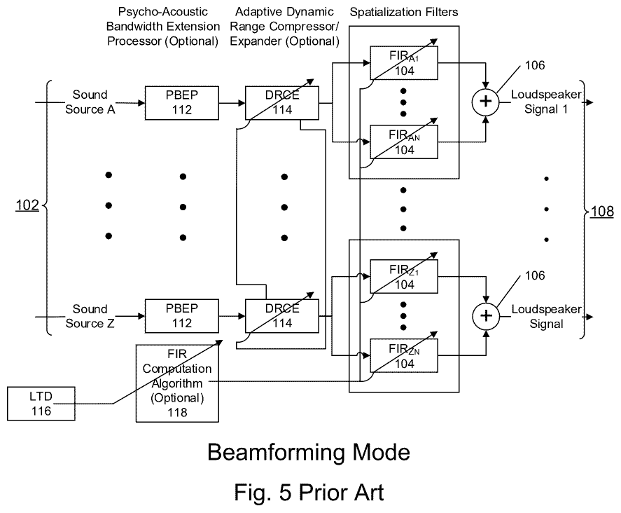

FIG. 5 illustrates an alternative embodiment of the binaural mode signal processing chain of FIG. 4 which includes the use of optional components including a psychoacoustic bandwidth extension processor (PBEP) and a dynamic range compressor and expander (DRCE), which provides more sophisticated dynamic range and masking control, customization of filtering algorithms to particular environments, room equalization, and distance-based attenuation control.

The PBEP 112 allows the listener to perceive sound information contained in the lower part of the audio spectrum by generating higher frequency sound material, providing the perception of lower frequencies using higher frequency sound). Since the PBE processing is non-linear, it is important that it comes before the spatialization filters 104. If the non-linear PBEP block 112 is inserted after the spatial filters, its effect could severely degrade the creation of the sound beam. It is important to emphasize that the PBEP 112 is used in order to compensate (psycho-acoustically) for the poor directionality of the loudspeaker array at lower frequencies rather than compensating for the poor bass response of single loudspeakers themselves, as is normally done in prior art applications. The DRCE 114 in the DSP chain provides loudness matching of the source signals so that adequate relative masking of the output signals of the array 108 is preserved. In the binaural rendering mode, the DRCE used is a 2-channel block which makes the same loudness corrections to both incoming channels. As with the PBEP block 112, because the DRCE 114 processing is non-linear, it is important that it comes before the spatialization filters 104. If the non-linear DRCE block 114 were to be inserted after the spatial filters 104, its effect could severely degrade the creation of the sound beam. However, without this DSP block, psychoacoustic performance of the DSP chain and array may decrease as well.

Another optional component is a listener tracking device (LTD) 116, which allows the apparatus to receive information on the location of the listener(s) and to dynamically adapt the spatialization filters in real time. The LTD 116 may be a video tracking system which detects the listener's head movements or can be another type of motion sensing system as is known in the art. The LTD 116 generates a listener tracking signal which is input into a filter computation algorithm 118. The adaptation can be achieved either by re-calculating the digital filters in real time or by loading a different set of filters from a pre-computed database. Alternate user localization includes RADAR (e.g., heartbeat) or LIDAR tracking RFID/NFC tracking, breathsounds, etc.

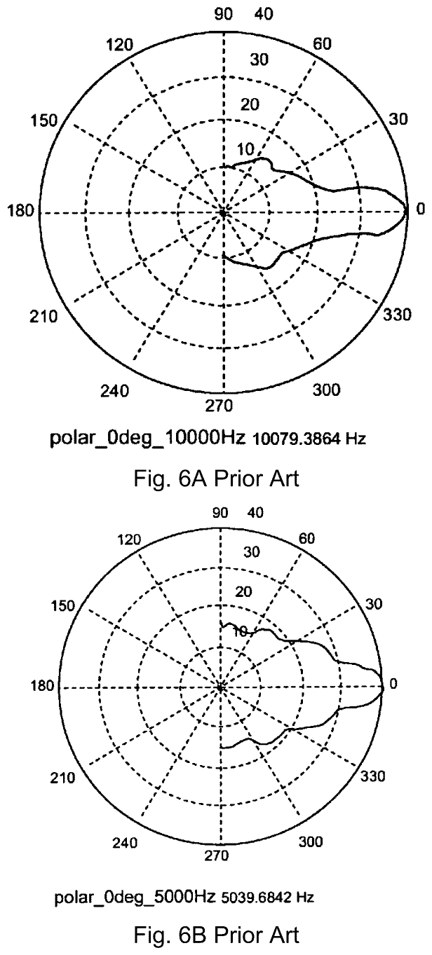

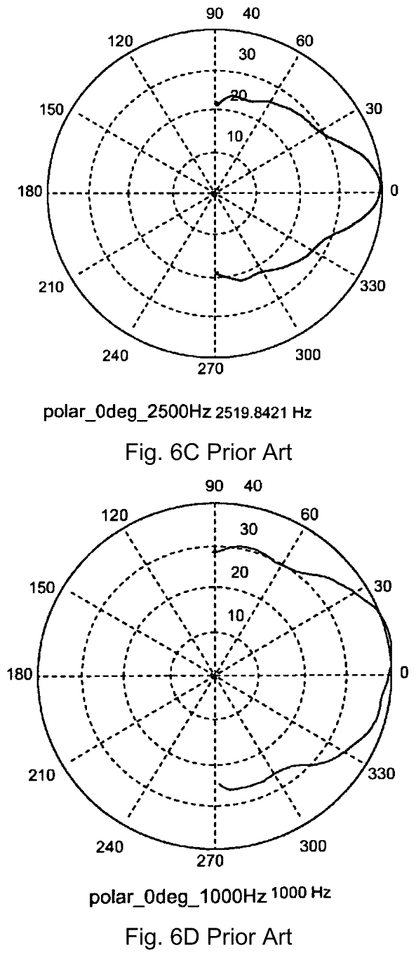

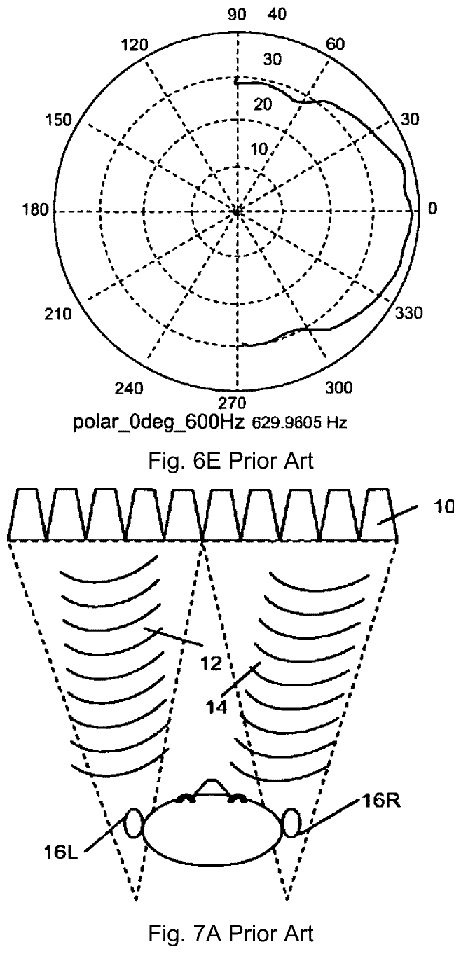

FIGS. 6A-6E are polar energy radiation plots of the radiation pattern of a prototype array being driven by the DSP scheme operating in WFS mode at five different frequencies, 10,000 Hz, 5,000 Hz, 2,500 Hz, 1,000 Hz, and 600 Hz, and measured with a microphone array with the beams steered at 0 degrees.

### Binaural Mode

The DSP for the binaural mode involves the convolution of the audio signal to be reproduced with a set of digital filters representing an HRTF.

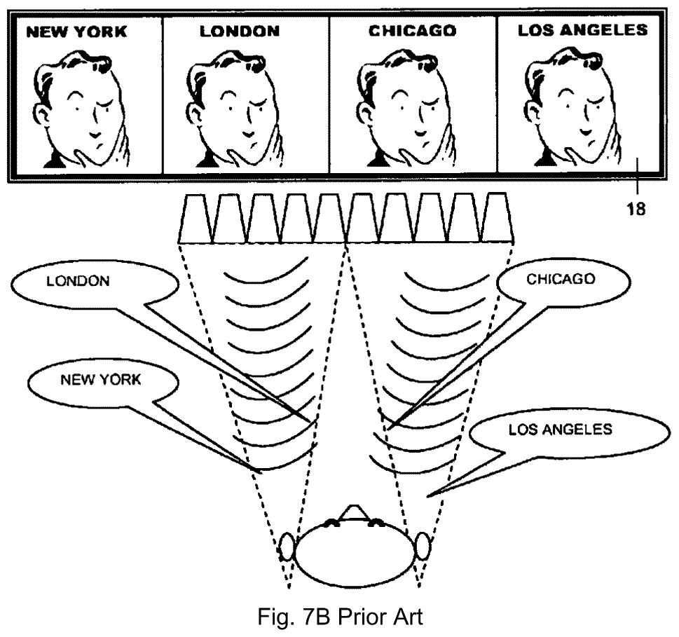

FIG. 7A illustrates the underlying approach used in binaural mode operation, where an array of speaker locations 10 is defined to produce specially-formed audio beams 12 and 14 that can be delivered separately to the listener's ears 16L and 16R. Using this mode, cross-talk cancellation is inherently provided by the beams. However, this is not available after summing and presentation through a smaller number of speakers.

FIG. 7B illustrates a hypothetical video conference call with multiple parties at multiple locations. When the party located in New York is speaking, the sound is delivered as if coming from a direction that would be coordinated with the video image of the speaker in a tiled display 18. When the participant in Los Angeles speaks, the sound may be delivered in coordination with the location in the video display of that speaker's image. On-the-fly binaural encoding can also be used to deliver convincing spatial audio headphones, avoiding the apparent mis-location of the sound that is frequently experienced in prior art headphone set-ups.

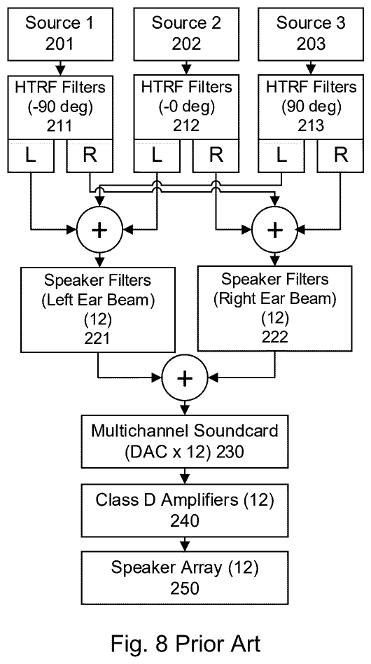

The binaural mode signal processing chain, shown in FIG. 8, consists of multiple discrete sources, in the illustrated example, three sources: sources 201, 202, and 203, which are then convolved with binaural HRTF encoding filters 211, 212, and 213 corresponding to the desired virtual angle of transmission from the nominal speaker location to the listener. There are two HRTF filters for each source—one for the left ear and one for the right ear. The resulting HRTF-filtered signals for the left ear are all added together to generate an input signal corresponding to sound to be heard by the listener's left ear. Similarly, the HRTF-filtered signals for the listener's right ear are added together. The resulting left and right ear signals are then convolved with inverse filter groups 221 and 222, respectively, with one filter for each virtual speaker element in the virtual speaker array. The virtual speakers are then combined into a real speaker signal, by a further time-space transform, combination, and limiting/peak abatement, and the resulting combined signal is sent to the corresponding speaker element via a multichannel sound card 230 and class D amplifiers 240 (one for each physical speaker) for audio transmission to the listener through speaker array 250.

In the binaural mode, the invention generates sound signals feeding a virtual linear array. The virtual linear array signals are combined into speaker driver signals. The speakers provide two sound beams aimed towards the primary listener's ears—one beam for the left ear and one beam for the right ear.

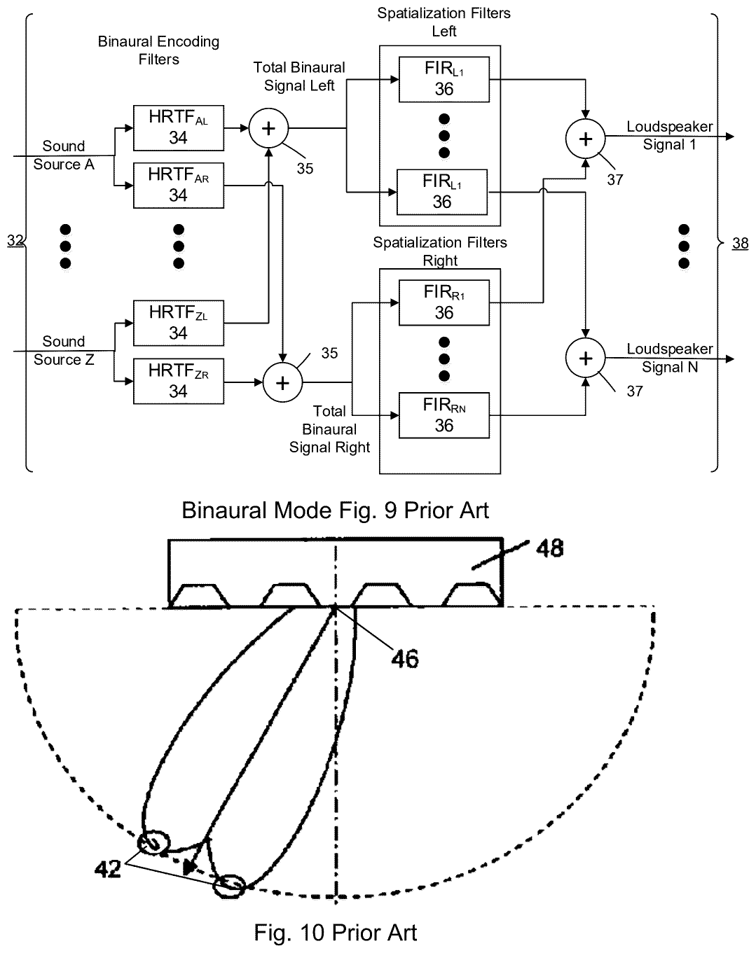

FIG. 9 illustrates the binaural mode signal processing scheme for the binaural modality with sound sources A through Z.

As described with reference to FIG. 8, the inputs to the system are a set of sound source signals 32 (A through Z) and the output of the system is a set of loudspeaker signals 38 (1 through N), respectively.

For each sound source 32, the input signal is filtered through two digital filters 34 (HRTF-L and HRTF-R) representing a left and right HRTF, calculated for the angle at which the given sound source 32 is intended to be rendered to the listener. For example, the voice of a talker can be rendered as a plane wave arriving from 30 degrees to the right of the listener. The HRTF filters 34 can be either taken from a database or can be computed in real time using a binaural processor. After the HRTF filtering, the processed signals corresponding to different sound sources but to the same ear (left or right), are merged together at combiner 35 This generates two signals, hereafter referred to as “total binaural signal-left”, or “TBS-L” and “total binaural signal-right” or “TBS-R” respectively.

Each of the two total binaural signals, TBS-L and TBS-R, is filtered through a set of N digital filters 36, one for each loudspeaker, computed using the algorithm disclosed below. These filters are referred to as “spatialization filters”. It is emphasized for clarity that the set of spatialization filters for the right total binaural signal is different from the set for the left total binaural signal.

The filtered signals corresponding to the same n^{th} virtual speaker but for two different ears (left and right) are summed together at combiners 37. These are the virtual speaker signals, which feed the combiner system, which in turn feed the physical speaker array 38.

The algorithm for the computation of the spatialization filters 36 for the binaural modality is analogous to that used for the WFS modality described above. The main difference from the WFS case is that only two control points are used in the binaural mode. These control points correspond to the location of the listener's ears and are arranged as shown in FIG. 10. The distance between the two points 42, which represent the listener's ears, is in the range of 0.1 m and 0.3 m, while the distance between each control point and the center 46 of the loudspeaker array 48 can scale with the size of the array used, but is usually in the range between 0.1 m and 3 m.

The 2×N matrix H(f) is computed using elements of the electro-acoustical transfer functions between each loudspeaker and each control point, as a function of the frequency f. These transfer functions can be either measured or computed analytically, as discussed above. A 2-element vector p is defined. This vector can be either [1,0] or [0,1], depending on whether the spatialization filters are computed for the left or right ear, respectively. The filter coefficients for the given frequency f are the N elements of the vector a(f) computed by minimizing the following cost function:

$$J ( f ) = {‖ H ( f ) a ( f ) - p ( f ) ‖}^{2} + β {‖ a ( f ) ‖}^{2} .$$

If multiple solutions are possible, the solution is chosen that corresponds to the minimum value of the L² norm of a(f).

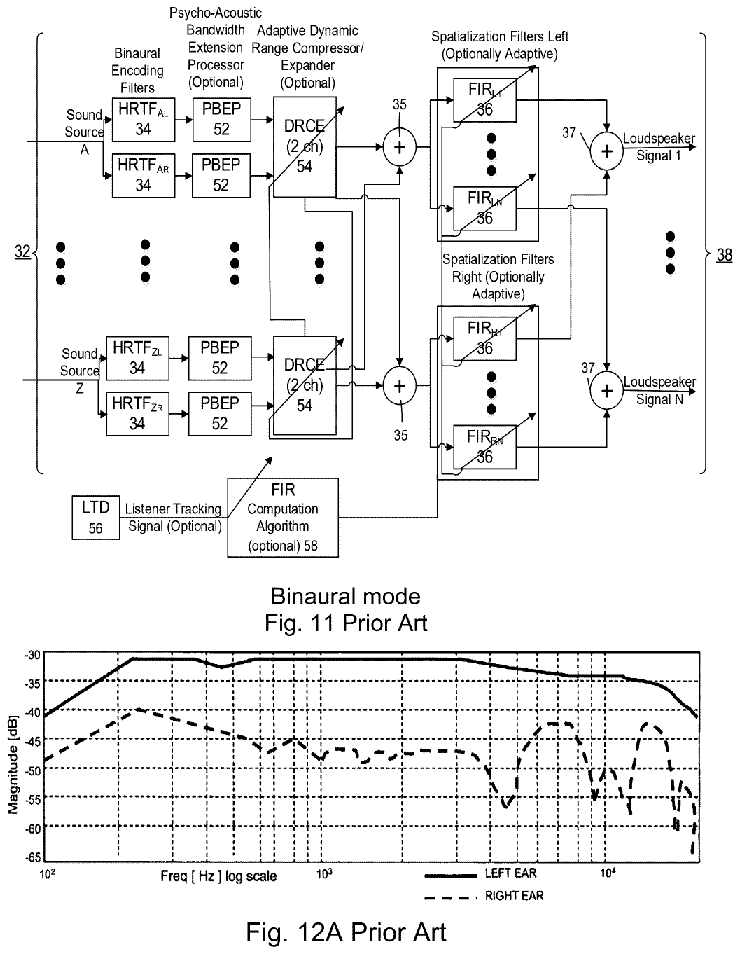

FIG. 11 illustrates an alternative embodiment of the binaural mode signal processing chain of FIG. 9 which includes the use of optional components including a psychoacoustic bandwidth extension processor (PBEP) and a dynamic range compressor and expander (DRCE). The PBEP 52 allows the listener to perceive sound information contained in the lower part of the audio spectrum by generating higher frequency sound material, providing the perception of lower frequencies using higher frequency sound). Since the PBEP processing is non-linear, it is important that it comes before the spatialization filters 36. If the non-linear PBEP block 52 is inserted after the spatial filters, its effect could severely degrade the creation of the sound beam.

It is important to emphasize that the PBEP 52 is used in order to compensate (psycho-acoustically) for the poor directionality of the loudspeaker array at lower frequencies rather than compensating for the poor bass response of single loudspeakers themselves.

The DRCE 54 in the DSP chain provides loudness matching of the source signals so that adequate relative masking of the output signals of the array 38 is preserved. In the binaural rendering mode, the DRCE used is a 2-channel block which makes the same loudness corrections to both incoming channels.

As with the PBEP block 52, because the DRCE 54 processing is non-linear, it is important that it comes before the spatialization filters 36. If the non-linear DRCE block 54 were to be inserted after the spatial filters 36, its effect could severely degrade the creation of the sound beam. However, without this DSP block, psychoacoustic performance of the DSP chain and array may decrease as well.

Another optional component is a listener tracking device (LTD) 56, which allows the apparatus to receive information on the location of the listener(s) and to dynamically adapt the spatialization filters in real time. The LTD 56 may be a video tracking system which detects the listener's head movements or can be another type of motion sensing system as is known in the art. The LTD 56 generates a listener tracking signal which is input into a filter computation algorithm 58. The adaptation can be achieved either by re-calculating the digital filters in real time or by loading a different set of filters from a pre-computed database.

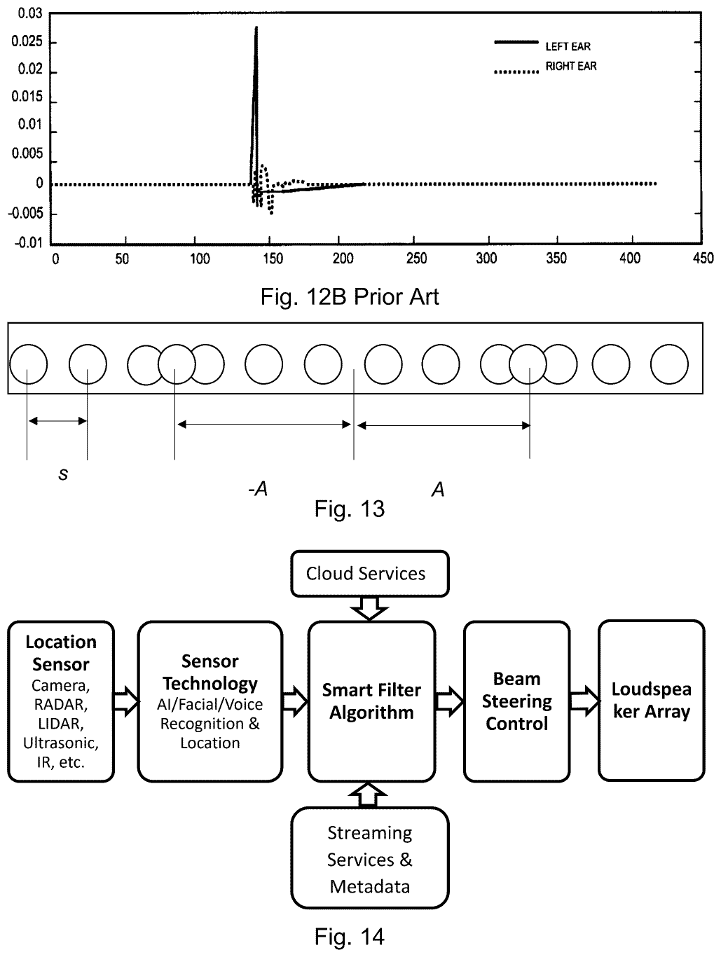

FIGS. 12A and 12B illustrate the simulated performance of the algorithm for the binaural modes. FIG. 12A illustrates the simulated frequency domain signals at the target locations for the left and right ears, while FIG. 12B shows the time domain signals. Both plots show the clear ability to target one ear, in this case, the left ear, with the desired signal while minimizing the signal detected at the listener's right ear.

WFS and binaural mode processing can be combined into a single device to produce total sound field control. Such an approach would combine the benefits of directing a selected sound beam to a targeted listener, e.g., for privacy or enhanced intelligibility, and separately controlling the mixture of sound that is delivered to the listener's ears to produce surround sound. The device could process audio using binaural mode or WFS mode in the alternative or in combination. Although not specifically illustrated herein, the use of both the WFS and binaural modes would be represented by the block diagrams of FIG. 5 and FIG. 11, with their respective outputs combined at the signal summation steps by the combiners 37 and 106. The use of both WFS and binaural modes could also be illustrated by the combination of the block diagrams in FIG. 2 and FIG. 8, with their respective outputs added together at the last summation block immediately prior to the multichannel soundcard 230.

### Example 1

A 12-channel spatialized virtual audio array is implemented in accordance with U.S. Pat. No. 9,578,440. This virtual array provides signals for driving a linear or curvilinear equally-spaced array of e.g., 12 speakers situated in front of a listener. The virtual array is divided into two or four. In the case of two, the “left” e.g., 6 signals are directed to the left physical speaker, and the “right” e.g., 6 signals are directed to the right physical speaker. The virtual signals are to be summed, with at least two intermediate processing steps.

The first intermediate processing step compensates for the time difference between the nominal location of the virtual speaker and the physical location of the speaker transducer. For example, the virtual speaker closest to the listener is assigned a reference delay, and the further virtual speakers are assigned increasing delays. In a typical case, the virtual array is situated such that the time differences for adjacent virtual speakers are incrementally varying, though a more rigorous analysis may be implemented. At a 48 kHz sampling rate, the difference between the nearest and furthest virtual speaker may be, e.g., 4 cycles.

The second intermediate processing step limits the peaks of the signal, in order to avoid over-driving the physical speaker or causing significant distortion. This limiting may be frequency selective, so only a frequency band is affected by the process. This step should be performed after the delay compensation. For example, a compander may be employed. Alternately, presuming only rare peaking, a simple limited may be employed. In other cases, a more complex peak abatement technology may be employed, such as a phase shift of one or more of the channels, typically based on a predicted peaking of the signals which are delayed slightly from their real-time presentation. Note that this phase shift alters the first intermediate processing step time delay; however, when the physical limit of the system is reached, a compromise is necessary.

With a virtual line array of 12 speakers, and 2 physical speakers, the physical speaker locations are between elements 3-4 and 9-10. If (s) is the center-to-center distance between speakers, then the distance from the center of the array to the center of each real speaker is: A=3s. The left speaker is offset −A from the center, and the right speaker is offset A.

The second intermediate processing step is principally a downmix of the six virtual channels, with a limiter and/or compressor or other process to provide peak abatement, applied to prevent saturation or clipping. For example, the left channel is: Lₒᵤₜ=Limit(L₁+L₂+L₃+L₄+L₅+L₆)
and the right channel is: Rₒᵤₜ=Limit(R₁+R₂+R₃+R₄+R₅+R₆).

Before the downmix, the difference in delays between the virtual speakers and the listener's ears, compared to the physical speaker transducer and the listener's ears, need to be taken into account. This delay can be significant particularly at higher frequencies, since the ratio of the length of the virtual speaker array to the wavelength of the sound increases. To calculate the distance from the listener to each virtual speaker, assume that the speaker, n, is numbered 1 to 6, where 1 is the speaker closest to the center, and 6 is the farthest from center. The distance from the center of the array to the speaker is: d=((n−1)+0.5)*s. Using the Pythagorean theorem, the distance from the speaker to the listener can be calculated as follows: dₙ={square root over (l²+(((n−1)+0.5)*s)²)}.

The distance from the real speaker to the listener is: dᵣ=\sqrt{l²+(3*s)²}.

The system, in this example, is intended to deliver spatialized audio to each of two listeners within the environment. A RADAR sensor, e.g., a Vayyar 60 GHz sensor is used to locate the respective listeners. venturebeat.com/2018/05/02/vayyar-unveils-a-new-sensor-for-capturing-your-life-in-3d. Various types of analysis can be performed to determine which objects represent people, versus inanimate objects, and for the people, what the orientation of their heads are. For example, depending on power output and proximity, the RADAR can detect heartbeat (and therefore whether the person is face toward or away from the sensor for a person with normal anatomy). Limited degrees of freedom of limbs and torso can also assist in determining anatomical orientation, e.g., limits on joint flexion. With localization of the listener, the head location is determined, and based on the orientation of the listener, the location of the ears inferred. Therefore, using a generic HRTF and inferred ear location, spatialized audio can be directed to a listener. For multiple listeners, the optimization is more complex, but based on the same principles. The acoustic signal to be delivered at a respective ear of a listener is maximized with acceptable distortion, while minimizing perceptible acoustic energy at the other ears, and the ears of other listeners. A perception model may be imposed to permit non-obtrusive white or pink noise, in contrast to voice, narrowband or harmonic sounds, which may be perceptually intrusive.

The SLAM sensor also permits modelling of the inanimate objects, which can reflect or absorb sound. Therefore, both direct line-of sight paths from the transducers to the ear(s) and reflected/scattered paths can be employed within the optimization. The SLAM sensor permits determination of static objects and dynamically moving objects, and therefore permits the algorithm to be updated regularly, and to be reasonably accurate for at least the first reflection of acoustic waves between the transducer array and the listeners.

The sample delay for each speaker can be calculated by the different between the two listener distances, as discussed above. Thus, when combining the signals for the virtual speakers into the physical speaker signal, the time offset is preferably compensated based on the displacement of the virtual speaker from the physical one. The time offset may also be accomplished within the spatialization algorithm, rather than as a post-process.

### Example 2

FIG. 14 demonstrates the control flow for using intelligent spatial sensor technology in a spatialized audio system. The sensor detects the location of listeners around the room. This information is passed to an AI/facial recognition component, which determines how best to present the audio to those listeners. This may involve the use of cloud services for processing. The cloud services are accessed through a network communication port via the Internet. The processing for determining how best to present 3D sound to each listener, to increase the volume to specific listeners (e.g., hearing-impaired listeners), or other effects based on the user's preferences, may be performed locally within a sound bar or its processor, remotely in a server or cloud system, or in a hybrid architecture spanning both. The communication may be wired or wireless (e.g., Wi-Fi or Bluetooth).

Incoming streaming audio may contain metadata that the intelligent loudspeaker system control would use for automated configuration. For example, 5.1 or 7.1 surround sound from a movie would invoke the speaker to produce a spatialized surround mode aimed at the listener(s) (single, double or triple binaural beams). If the audio stream were instead a news broadcast, the control could auto-select Mono Beaming mode (width of beam dependent of listener(s) position) plus the option to add speech enhancement equalization; or a narrow high sound pressure level beam could be aimed at a listener who is hard of hearing (with or without equalization) and a large portion of the room could be ‘filled’ with defined wavefield synthesis derived waves (e.g., a “Stereo Everywhere” algorithm). Numerous configurations are possible by modifying speaker configuration parameters such as filter type (narrow, wide, asymmetrical, dual/triple beams, masking, wave field synthesis), target distance, equalization, HRTF, lip sync delay, speech enhancement equalization, etc. Furthermore, a listener could enhance a specific configuration by automatically enabling bass boost in the case of a movie or game, but disabling it in the case of a newscast or music.

The type of program may be determined automatically or manually. In a manual implementation, the user selects a mode through a control panel, remote control, speech recognition interface, or the like. FIG. 14 shows that the smart filter algorithm may also receive metadata, which may be, for example, a stream of codes which accompany the media, which define a target sonic effect or sonic type, over a range of changing circumstances. Thus, in a movie, different scenes or implied sound sources may encode different sonic effects. It is noted that these cannot be directly or simply encoded in the source media, as the location and/or acoustic environment is not defined until the time of presentation, and different recipients will have different environments. Therefore, a real-time spatialization control system is employed, which receives a sensor signal or signals defining the environment of presentation and listener location, to modify the audio program in real time to optimize the presentation. It is noted that the same sensors may also be used to control a 3D television presentation to ensure proper image parallax at viewer locations. The sensor data may be a visual image type, but preferably, the sensors do not capture visual image data, which minimizes the privacy risk if that data is communicated outside of the local control system. As such, the sensor data, or a portion thereof, may be communicated to a remote server or for cloud processing with consumer acceptance. The remote or cloud processing allows application of a high level of computational complexity to map the environment, including correlations of the sensor data to acoustic interaction. This process may not be required continuously, but may be updated periodically without explicit user interaction.

The sensor data may also be used for accounting, marketing/advertising, and other purposes independent of the optimization of presentation of the media to a listener. For example, a fine-grained advertiser cost system may be implemented, which charges advertisers for advertisements that were listened to, but not for those in which no awake listener was available. The sensor data may therefore convey listener availability and sleep/wake state. The sleep/wake state may be determined by movement, or in some cases, by breathing and heart rate. The sensor may also be able to determine the identity of listeners, and link the identity of the listener to their demographics or user profile. The identity may therefore be used to target different ads to different viewing environments, and perhaps different audio programs to different listeners. For example, it is possible to target different listeners with different language programs if they are spatially separated. Where multiple listeners are in the same environment, a consensus algorithm may optimize a presentation of a program for the group, based on the identifications and in some cases their respective locations.

Generally, the beam steering control may be any spatialization technology, though the real-time sensor permits modification of the beam steering to in some cases reduce complexity where it is unnecessary, with a limiting case being no listener present, and in other cases, a single listener optimally located for simple spatialized sound, and in other cases, higher complexity processing, for example multiple listeners receiving qualitatively different programs. In the latter case, processing may be offloaded to a remote server or cloud, permitting use of a local control that is computationally less capable than a “worst case” scenario.

The loudspeaker control preferably receives far field inputs from a microphone or microphone array, and performs speech recognition on received speech in the environment, while suppressing response to media-generated sounds. The speech recognition may be Amazon Alexa, Microsoft Cortana, Hey Google, or the loke, or may be a proprietary platform. For example, since the local control includes a digital signal processor, a greater portion of the speech recognition, or the entirety of the speech recognition, may be performed locally, with processed commands transmitted remotely as necessary. This same microphone array may be used for acoustic tuning of the system, including room mapping and equalization, listener localization, and ambient sound neutralization or masking.

Once the best presentation has been determined, the smart filter generation uses techniques similar to those described above, and otherwise known in the art, to generate audio filters that will best represent the combination of audio parameters effects for each listener. These filters are then uploaded to a processor the speaker array for rendering, if this is a distinct processor.

Content metadata provided by various streaming services can be used to tailor the audio experience based on the type of audio, such as music, movie, game, and so on, and the environment in which it is presented, and in some cases based on the mood or state of the listener. For example, the metadata may indicate that the program is an action movie. In this type of media, there are often high intensity sounds intended to startle, and may be directional or non-directional. For example, the changing direction of a moving car may be more important than accuracy of the position of the car in the soundscape, and therefore the spatialization algorithm may optimize the motion effect over the positional effect. On the other hand, some sounds, such as a nearby explosion, may be non-directional, and the spatialization algorithm may instead optimize the loudness and crispness over spatial effects for each listener. The metadata need not be redefined, and the content producer may have various freedom over the algorithm(s) employed.

Thus, according to one aspect, the desired left and right channel separation for a respective listener is encoded by metadata associated with a media presentation. Where multiple listeners are present, the encoded effect may apply for each listener, or may be encoded to be different for different listeners. A user preference profile may be provided for a respective listener, which then presents the media. According to the user preferences, in addition to the metadata. For example, a listener, may have different hearing response in each ear, and the preference may be to normalize the audio for the listener response. In other cases, different respective listeners may have different preferred sound separation. Indicated by their preference profile. According to another embodiment, the metadata encodes a “type” of media, and the user profile maps the media type to a user-preferred spatialization effect or spatialized audio parameters.

As discussed above, the spatial location sensor has two distinct functions: location of persons and objects for the spatialization process, and user information which can be passed to a remote service provider. The remote service provider can then use the information, which includes the number and location of persons (and perhaps pets) in the environment proximate to the acoustic transducer array, as well as their poses, activity state, response to content, etc., and may include inanimate objects. The local system and/or remote service provider may also employ the sensor for interactive sessions with users (listeners), which may be games (similar to Microsoft Xbox with Kinect, or Nintendo Wii), exercise, or other types of interaction.

Preferably, the spatial sensor is not a camera, and as such, the personal privacy issues raised by having such a sensor with remote communication capability. The sensor may be a RADAR (e.g., imaging RADAR, MIMO Wi-Fi RADAR [WiVi, WiSee]), LIDAR, Microsoft Kinect sensor (includes cameras), ultrasonic imaging array, camera, infrared sensing array, passive infrared sensor, or other known sensor. It is noted that in principal, any dynamically varying RF source may be used in a bistatic radar, such as Bluetooth emissions at 2.4 GHz, the present technology may exploit some of the computation and computational capability intrinsically available in modern WiFi transceivers, and therefore may be achieved using a firmware update for an existing WiFi 5, 6, 6E, or 7 design (and beyond).

The spatial sensor may determine a location of a listener in the environment, and may also identify a respective listener. The identification may be based on video pattern recognition in the case of a video imager, a characteristic backscatter in the case of RADAR or radio frequency identification, or other known means. Preferably the system does not provide a video camera, and therefore the sensor data may be relayed remotely for analysis and storage, without significant privacy violation. This, in turn, permits mining of the sensor data, for use in marketing, and other purposes, with low risk of damaging misuse of the sensor data.

The invention can be implemented in software, hardware or a combination of hardware and software. The invention can also be embodied as computer readable code on a computer readable medium. The computer readable medium can be any data storage device that can store data which can thereafter be read by a computing device. Examples of the computer readable medium include read-only memory, random-access memory, CD-ROMs, magnetic tape, optical data storage devices, and carrier waves. The computer readable medium can also be distributed over network-coupled computer systems so that the computer readable code is stored and executed in a distributed fashion.

### Localization of Listener's Ears

In order to capture human poses, CSI information from the radios is used to construct CSI maps. For setup, a synchronized camera may be used to extract human skeletons and annotate Wi-Fi signals. After calibration and setup, the camera may be removed or deactivated, to ensure or guaranty image privacy.

In general, it is preferred to employ traditional algorithms to extract information from the radio frequency signals that correspond to discrete information, such as location maps. However, given that the end goal is not to map an environment, but rather to deliver spatialized sound, neural network technology which avoids human comprehensible intermediate representations of the data may be used. For example, a neural network may be trained using an instrumented human or phantom (or concurrent multiples) in an environment (typically with other sensors such as camera, LIDAR, structured lighting), to directly interpret received radio waveforms to provide spatial audio from an audio source to the listener's ears. However, training such a system to perform adequately in each environment is time consuming, and may not be required, as compared to a step-by-step process which performs a similar set of functions. Advantageously, a subset of the functions may be performed by a pretrained neural network, e.g., pose extraction from returned radio signals, rather than the entire task.

Therefore, in one embodiment, a sequence of functions is performed, in which a neural network is implemented to map the CSI maps (and any other available data, e.g., from other sensors) to human pose figures, and especially ear location.

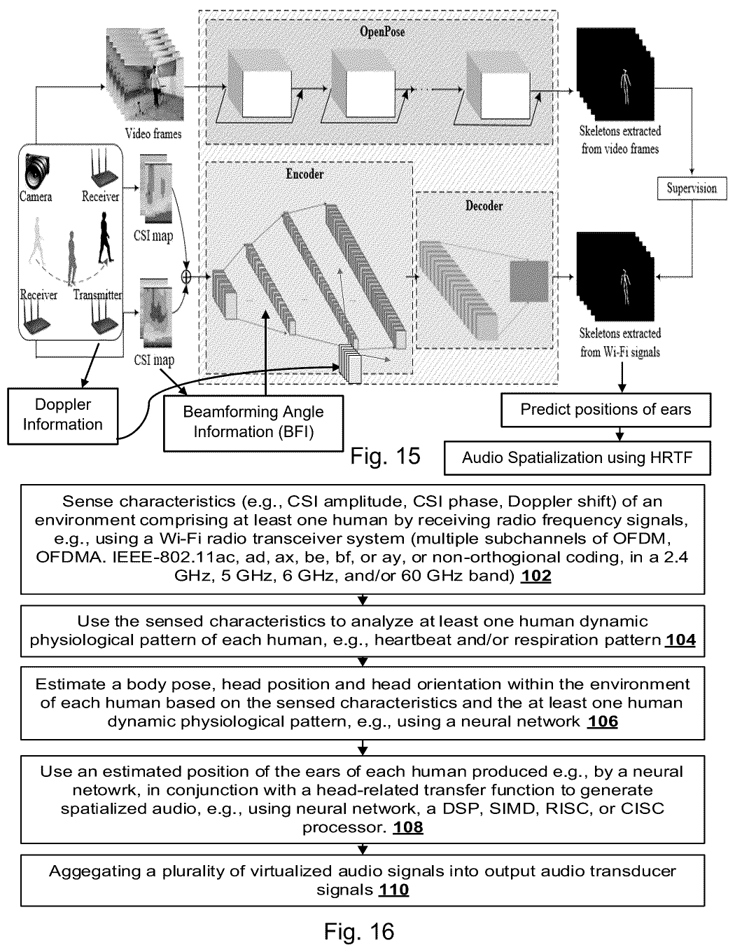

FIG. 15 shows a block diagram of a system, similar to Guo et al., 2020, though enhanced according to the present technology. It is impossible to manually annotate human poses in CSI maps. However, a neural network may extract hidden relationships between the physical objects within an environment, and the radio frequency reflection, absorption, scattering, Doppler shifts, etc., within the environment. A ground truth may be derived from one of more video cameras concurrently monitoring the environment Open-Pose may be used to extract the human skeletons from the videos, so as to provide automated ground truth annotations for the radio frequency signals, and in particular various types of CSI, including phase and amplitude. Beamforming angle information (BFI) and Doppler shifts may also be analyzed. Because the skeletons have multiple features, the extraction of the skeletons is more fault tolerant. In the case of a living skeleton, i.e., a human, the return radio frequency signals will include indicial of heartbeat and respiration.

Human spatial positions, dynamic characteristics, and temporal correlation of human poses is taken into consideration in formulation of the neural network. Convolutional neural networks are used to extract spatial static and dynamic features. The neural network is designed to map the CSI phase and amplitude, as well as Doppler and beamforming angle information maps, into human skeleton figures. The encoder network summarizes the information from the original points of view, e.g., the receivers, and utilizes strided convolutional networks and a squeeze and excitation (SE) block. The decoder network following the encoder network may decode poses from the view of the camera by utilizing resize convolutions with nearest neighbor interpolation operation to eliminate Checkerboard Artifacts. While ear position may be extracted within the convolutional neural network itself, a successive neural network may be used based on the extracted skeleton to determine the ear positions. The ear positions are then used to generate spatialized audio streams. The audio spatialization may be generated based on the ear position and an HRTF within a consolidated neural network system, or within a more traditional digital signal processor, RISC, CISC, or SIMD processor system.

FIG. 16 shows a flowchart of an example process. The characteristics of an environment having at least one human are sensed by receiving radio frequency signals (block 102). For example, device may sense characteristics of an environment having at least one human by receiving radio frequency signals, as described above. The characteristics, for a frequency division multiplexed signal having a plurality of frequency subchannels may include phase channel state information, amplitude channel state information, Doppler information (generally correlated across channels, though present in individual channels), and beamforming angle information. The radio frequency subchannels may be orthogonal in a continuous band, or as discontinuous subbands across the band. The band may be 20, 40, 60, 80, 100, 120, 140, 160, 240 or 320 MHz wide, or other intermediate or larger frequency ranges, within a 2.4 GHz, 5 GHz, 6 Ghz, of 60 GHz band, for example. The radio frequency subchannels may also be non-orthogonal. The sensed characteristics may be used to analyze at least one human dynamic physiological pattern of each human (block 104). For example, the at least one human dynamic physiological pattern may be a heartbeat pattern, a respiratory pattern, a gesture pattern, etc., of each human. A body pose within the environment and head position of each human may be estimated based on the sensed characteristics and the at least one human dynamic physiological pattern (block 106). For example, the heartbeat pattern and respiratory pattern are used to define a region of a chest of each human. That chest region then constrains the remainder of the human body, which is continuous with the chest in an anatomical pattern. By constraining the location of the body, ambiguous possible ear locations which are not associated with a living human body are excluded. An estimated position of the ears of each human is processed in conjunction with an HRTF to generate spatialized audio (block 108). The spatialized audio signals may be generated as a plurality of virtual audio signals, which are then aggregated into output audio transducer signals (block 110). The radio frequency signals are preferably compliant with at least one of IEEE-802.ac, ad, ax, be, bf, and ay. The radio frequency signal may be analyzed using a neural network, to extract a human heartbeat, a human respiration pattern, a human body, a human pose, and/or human ear locations.

CARM [19] focuses on the creation of a CSI activity model used to recognize human activities. WiDance [20] creatively captures complete information corresponding to the Doppler frequency shifts caused by human movements, and creates a prototype of contactless dance game. WiFall [21] completes high-precision level fall detection. Wi-Chase [22] can carry out the applicable subcarriers in the Wi-Fi signals, and uses them in the recognition of human activities. WiFit [23] recognizes the exercise types, and is able to calculate the sporting quantity of different groups under different environmental conditions. [24] realizes human activity recognition on the basis of an attention-based Bidirectional Long Short-Term Memory (Bi-LSTM) network, and reaches the highest recognition accuracy of different activities compared to other methods. [25] uses the temporal information contained in the CSI time series to monitor events in different indoor environments. WiFiMap+ [26] recognizes high-level indoor semantics in the environments and human activities based on Wi-Fi signals.

Widar [27], [28] mainly uses CSI dynamics to conduct human speed tracking and human localization. Widar2.0 [29] develops an efficient algorithm, and uses it to estimate Doppler frequency shifts, Angle of Arrival (AoA), Time of Flight (ToF) and other parameters. At the same time, the original parameters are converted into a high accuracy position through a designed pipeline. IndoTrack [30] and [31] use AoA and spatial temporal Doppler frequency shifts for accurate human tracking. PADS [32] leverages spatial diversity across multiple antennas and all CSI information (including phase and amplitude) to adjust and extract sensitive indicators, and finally realizes not only robust but also accurate target detection. These systems typically abstract a human into a single point reflector so as to realize the localizing, tracking, and even monitoring the walking speed of the human body. However, the techniques may be modified to reveal pose estimation data.

Wi-Sleep [33] is the first system that utilizes CSI amplitude for sleep breathing detection and its subsequent work [34] adds sleep posture and sleep apnea detection module. Phasebeat [35] mainly uses the CSI phase difference between two receiving antennas to capture respiration. The main concern of these systems is the difference in human respiration rates at a given period of time, not the detailed breath status. [36] mainly introduces the Fresnel Zone model, based on which a respiration sensing model using Wi-Fi is constructed. According to the Fresnel zone model, respiration detection based on CSI amplitude may fail in some areas. FullBreathe [37] aims to address the undetectable region problem by exploiting the complementary property between CSI amplitude and phase data, but it presents the detection ability ratio metric instead of detailed respiration status to evaluate system performance. Farsense [8] employs the ratio of CSI from two antennas and also leverages the complementary property between CSI amplitude and phase to eliminate the “blind spots problem and expands the sensing range, but it focuses on sense range rather than detailed respiration status. BreathTrack [12] tracks the detailed respiration status, but it utilizes a hardware correction method to obtain accurate CSI, which limits its usage in real life.

Capturing human poses from images is a known problem called human pose estimation in the computer vision literature, such as DensePose [10], AlphaPose [11], and CPN [38], which infers the human position from an image then regressing the keypoint heatmaps.

Recently, researchers have paid more attention to estimate human poses using wireless signals. RF-Pose [39] utilizes a RADAR implemented with frequency modulated continuous wave (FMCW) equipment [40] to estimate human poses, and so does RF-Pose3D [41]. The equipment works in Wi-Fi frequencies (5.46-7.24 GHz), and each antenna array of it utilizes 4 transmitting antennas, and 16 receiving antennas to improve the spatial resolution. All these are not available on off-the-shelf Wi-Fi devices, which makes it difficult to estimate human poses by off-the-shelf Wi-Fi devices. However, such modifications of Wi-Fi radio operation may be available by modification of firmware. Note that the capabilities of FMCW RADAR are not unique, and specially formed packets of Wi-Fi, or even random streams of Wi-Fi packets, provide digital stream spread spectrum (DSSS) type capabilities.

CSI is widely used to describe the transmission of Wi-Fi signals between a pair of transmitter and receiver, which refers to the multipath propagation of some carrier frequencies [43]. CSI measurements can be obtained from the received packets based on the Intel 5300 NIC with modified firmware and driver[6]. CSI represents the samples of Channel Frequency Response (CFR) in each Orthogonal Frequency Division Multiplexing (OFDM) subcarrier, as a function of the number of paths, the channel response of each path over time, attenuation, and propagation delay. Preferably, the traditional function is modified to consider Doppler shifts, which may be detectable by direct measurement, changes in intersymbol interference, bleed from adjacent channels, etc. To be specific, CSI is a three-dimensional matrix of complex values. One CSI measurement specifies the amplitude and phase of the channel response for the corresponding subcarrier between a single transmitter-receiver antenna pair. Furthermore, N CSI are measured for all the subcarriers, and a complex vector is finally formed. A time series of CSI measurements can capture how wireless signals travel through surrounding humans and objects in the space domain, time domain and frequency domain. Therefore, it can be applied in different wireless sensing systems [43]. For example, as the amplitudes of CSI vary in the time domain resulting in different patterns for different postures or gestures, they can be applied to recognize postures or gestures. Signal transmission direction and delay are corresponding to the phase shifts of CSI, which can be used for human localization and tracking.

According to the description in [37], CSI can be divided into static and dynamic components. Among them, the static component Hₛ(f, t) mainly consists of the Line of Sight (LoS) path and other reflection paths from static objects, while the dynamic component H_{d}(f, t) covers the paths reflected from the moving body parts or a human's chest who remains still. The dynamic component can be sheltered by the static component since the frequency response of the LoS path is much stronger than other reflection paths. Due to hardware imperfection of off-the-shelf Wi-Fi devices, different time-varying phase offsets are often included in consecutive CSI measurements [47]. Conjugate Multiplication (CM) of CSI between antennas may be used to eliminate the phase offset[30]: However, analysis of the phase offset may itself yield useful information.

CSI amplitude and phase are not only affected by one path, but multipaths. According to the Fresnel zone model, a pair of transmitter and receiver, and the surrounding space are divided into concentric ellipses, which are called Fresnel zone regions. Fresnel zone model reveals the propagation and the deflection of Wi-Fi signals in the Fresnel zone regions. At the same time, different path lengths result in different amplitude attenuation and phase shift, which leads to the constructive and destructive effect at the receiver.

If an object moves in multiple Fresnel zone regions, the signal displayed in the receiver will take on the form of a sine wave. In addition, it is considered that the best location for CSI amplitude-based respiration sensing is in the middle of a Fresnel zone region, while the worst is at the boundary [36]. Reference [37] theoretically and experimentally shows that CSI amplitude and CSI phase are orthogonal and complementary to each other.

A single hidden layer neural network has an input layer which provides a path for each discrete data input. In some cases, preprocessing is used to modify the raw inputs, such as by filtering, or other algorithm. Each node of the input layer is connected to all nodes of the hidden layer, and each node of the hidden layer is connected to each node of the output layer. The results of the output layer are then combined. In some cases, the connections may be pared, to reduce complexity, but in practice, calculations are performed in parallel so that paring does not yield significant efficiency. Each connection is weighted, i.e., between the input layer nodes and the hidden layer nodes, between the hidden layer nodes and the output layer nodes, and in some cases, in the combined output function of the output layer nodes. The network is trained with training data which uses test data at the input to “reliably” product desired results from the output, in what is typically a statistical process with a reliability metric. Deep neural networks have multiple hidden layers, and therefore more complexity and discriminative power, and are typically trained in a sequence. It is also possible to implement a complex neural network with a cloud of non-hierarchically organized hidden layer nodes, though the algorithms for defining connections between the nodes and the corresponding training are less well developed than the organized layer implementations. There are various styles of organized neural networks, for example, recurrent neural networks include memory, convolutional neural networks include interconnections implying a problem or solution space, etc.

For a Convolutional Neural Network (CNN), each neuron contained in it is related to several neurons in the previous layer, a significant difference between CNNs and the ordinary neural networks. For CNNs, all the neurons in the same layer are equally weighted. The computation of the neuron values can be thought of as the convolution of a weight kernel and the neurons from the previous layer. CNNs make ensure local independence of data to reduce the computational complexity, which make deeper networks possible accordingly.

When generating images, neural networks are typically built against high levels of description and low resolution and then fill in the details. The so-called deconvolution operation refers to the method of converting low-resolution images to obtain high-resolution images. However, for deconvolution, there is often uneven overlap, which is generally referred to as “Checkerboard Artifacts” [48]. One approach to solve this problem is basically to resize the image and then do a convolution. This approach is called resize convolution, a roughly similar method works well in image super-resolution [49].

The present technology may be implemented using general purpose processors, digital signal processors (typically characterized by a fast pipelined multiply operation to permit high bandwidth transform and matrix calculations), single instruction, multiple data processors (SIMD, a typical implementation of graphics processing units (GPU), and the basis for general purpose graphics processing unit (GPGPU) systems). However, while the processor per se is not unique, the execution typically requires a customized system for efficient implementation, and in particular, unless the processing power available is far in excess of required calculations, the software and operating needs to be a real time deterministic system. Further, it is efficient to combine the ear localization and spatialization algorithms in a consolidated system. Finally, because the radio frequency system sounds the entire environment, parameters of the spatialization independent of the HRTF may also be calculated in the system, such as wall locations, object locations, inferences on object acoustic interactions (reflective, resonant, absorptive, non-linear distortive, etc.) may be provided and used to control the spatialization process.

The convolution operator of CNNs uses spatial information and channel information in the local receptive fields of each layer to enable the network to construct information features. The main purpose of Squeeze-and-Excitation (SE) block is to improve the quality of the representations extracted by a neural network by modelling the interdependencies between the convolution feature channels. It mainly emphasizes the useful information and suppresses the less useful ones by performing feature recalibration [50].

According to [51], when the LoS path between a pair of transceivers and the walk path of a human are parallel, the transceivers will be unable to realize sensing the human. Consequently, if antennas in at least three significantly different locations are provided, the parallel condition will not occur for all receivers.

Tuman pose information is mainly included in CSI amplitude, and human position information is mainly included in CSI phase. Capturing human pose figures can provide not only human pose information but also human position information. Both CSI amplitude and CSI phase are preferably employed, because CSI amplitude and CSI phase are independent and each encode useful information.

WiFi CSI has no direct information about human poses. However, a neural network is capable of extracting the required information. The neural network is trained based on a ground truth source, such as video images or other reliable information source. The video may be from multiple vantage points, and may employ structured lighting or other techniques to ensure quantitative accuracy. Over a range of activities and conditions within the environment, the neural network is trained to identify the landmarks and other information in the radio datastream, in particular CSI information, though perhaps other available information. For example, one or more software defined radio (SDR) receivers in the environment may record various waveforms, which may be analyzed independently of the Wi-Fi receiver. Because the human pose changes relatively slowly, and the data in the Wi-Fi signal is not important for the localization task, the SDR may analyze a relatively narrow radio frequency band at a time (e.g., 20 MHz, 40 Mhz, 60 MHz), and accumulate results over the entire range over time.

After completing the training, the system is capable of estimating human pose figures, and ear location, using only WiFi CSI as input. In addition, because Wi-Fi signals can traverse obstacles, the system we build can also capture human pose figures even through a wall.

Principal Component Analysis (PCA) may be applied on the CSI amplitude of a pair of antennas to remove redundant and unrelated information, while retaining human pose information. A second principal component analysis may be carried out, to capture changes of human poses. There is a correlation between the specific frequency, and the rate of length changes of the reflection paths corresponding to humans [19], so we mainly utilize Discrete Wavelet Transform (DWT) to extract the temporal-frequency features contained in the second principal component. Conjugate multiplication may be used to deal with the time-variant random phase offset.

A CSI map is constructed composed of amplitude information and relative phase information. M×T pixels are contained in each channel, where M and T respectively represent the number of subcarriers and the length corresponding to a specific time segment. Multiple CSI samples (e.g., 20) may be combined for the CSI map construction.

OpenPose [52] or a similar system may be used to extract the human skeletons from video images, to provide ground truth annotations for CSI. For the network, it is necessary to transform the information between the view of the off-the-shelf Wi-Fi devices and the information from the view of the camera. This may be performed by transitional spatial algorithms, or using a neural network, or a combination of both.

The encoder network summarizes the information from the original points of view (e.g., multiple receivers) and utilizes strided convolutional networks and a SE block [50]. In the process of training, the input of the neural network is (C₁, C₂), and the output is the predicted human skeleton figure P. Supervised by S, the human skeleton figure extracted by OpenPose, the neural network is then optimized.

For example, the average of binary cross entropy loss for each pixel may be applied as the loss function to minimize the difference between the predicted figure and the corresponding annotation.

The curves of CSI and complementarity of CSI amplitude and phase may be used in respiration tracking. Using the spatial normalization based on the camera or other inputs, the location of the respiration in the space may be determined. This should be consistent with the heartbeat, and the pose and position estimation, and a consistency algorithm may be employed to remove artifacts. In respiration tracking alone, the static component may be removed with a Hampel filter. After that, the periodicity of the respiration status is used to select the most sensitive signal. To remove the environmental noises, the selected signal is filtered by a wavelet filter. Of course, since the goal is not respiratory monitoring per se (though in some cases, it may be), these same filters may be modified to highlight the location information and suppress the respiratory status from consideration.

IEEE-802.11bf is a newly emerging standard for sensing using WiFi 7-type transceivers. In general, the WLAN sensing can be classified into two main categories, which are implemented based on different wireless signal characteristics, namely the received signal strength indicator (RSSI) and channel state information (CSI). Specifically, the RSSI corresponds to the measured received signal strength at the receiver, but does not captures the complexity of the received signal. CSI is able to provide finer-grained wireless channel information at the physical layer, and CSI contains both channel amplitude and phase information over different subcarriers that provide the capability to discriminate multi-path characteristics. For instance, by processing the spatial-, frequency-, and time-domain CSI at multiple antennas, subcarriers, and time samples via fast Fourier transform (FFT), detailed multi-path parameters such as angle-of-arrival (AoA), time-of-flight (ToF), and doppler frequency shift (DFS) can be extracted. Other advanced super-resolution techniques such as estimation of signal parameters via rotation invariance techniques (ESPRIT), multiple signal classification (MUSIC), and space alternating generalized expectation-maximization (SAGE) algorithm can also be utilized to extract more accurate target-related parameters from the CSI.

Du, Rui, Haocheng Hua, Hailiang Xie, Xianxin Song, Zhonghao Lyu, Mengshi Hu, Yan Xin et al. “An overview on IEEE 802.11 bf: WLAN sensing.” IEEE Communications Surveys & Tutorials (2024).

Ropitault, Tanguy, Claudio RCM da Silva, Steve Blandino, Anirudha Sahoo, Nada Golmie, Kangjin Yoon, Carlos Aldana, and Chunyu Hu. “IEEE 802.11 bf WLAN Sensing Procedure: Enabling the Widespread Adoption of WiFi Sensing.” IEEE Communications Standards Magazine 8, no. 1 (2024): 58-64.

Sahoo, Anirudha, Tanguy Ropitault, Steve Blandino, and Nada Golmie. “Sensing Performance of the IEEE 802.11 bf Protocol and Its Impact on Data Communication.” In 2024 IEEE 100th Vehicular Technology Conference (VTC2024-Fall), pp. 1-7. IEEE, 2024.

Tai, Ching-Lun, Jingyuan Zhang, Douglas M. Blough, and Raghupathy Sivakumar. “Target Tracking with Integrated Sensing and Communications in IEEE 802.11 bf.” In 2024 IEEE 99th Vehicular Technology Conference (VTC2024-Spring), pp. 1-5. IEEE, 2024.

Sahoo, Anirudha, Tanguy Ropitault, Steve Blandino, and Nada Golmie. “Performance Evaluation of IEEE 802.11 bf Protocol in the sub-7 GHz Band.” arXiv preprint arXiv:2403.19825 (2024).

Blandino, Steve, Jihoon Bang, Jian Wang, Samuel Berweger, Jack Chuang, Jelena Senic, Tanguy Ropitault, Camillo Gentile, and Nada Golmie. “Low Overhead DMG Sensing for Vital Signs Detection.” In ICASSP 2024-2024 IEEE International Conference on Acoustics, Speech and Signal Processing (ICASSP), pp. 13041-13045. IEEE, 2024.

Zhuang, Yixin, Yue Tian, and Wenda Li. “A Novel Non-Contact Multi-User Online Indoor Positioning Strategy Based on Channel State Information.” Sensors 24, no. 21 (2024): 6896.

PicoScenes supports a Wi-Fi RADAR (802.11bf Mono-Static Sensing) Mode (6.2.5.6). For NI USRP devices with multiple RF channels, Wi-Fi RADAR mode, or Wi-Fi mono-static sensing mode can be activated. As the RADAR word implies, PicoScenes, in RADAR mode, uses one RF chain of the USRP to transmit the Wi-Fi frames, whilst using the other RF chain(s) to receive the signals and then decode the frames. This mode is dedicated for Wi-Fi sensing. The following command shows how to use the RADAR mode with Wi-Fi 7 40 MHz CBW frames injection and receiving. Directional antennas are recommended to increase transmit-to-receive antenna isolation, though various full duplex radio communication technology may also be employed. Picoscenes also supports a Wi-Fi MIMO RADAR (802.11bf Mono-Static Sensing and MIMO) Mode (6.2.5.7). Since multiple USRP can be combined into one virtual and large USRP, the RADAR mode can also utilize multiple RF chains to build a Wi-Fi MIMO RADAR.

Wi-BFI can extract the beamforming feedback information (BFI) from commercial Wi-Fi devices. The BFI is a compressed representation of the CSI that is used for beamforming and MIMO operations. The BFI is encoded in the beamforming feedback angles (BFAs), which are reported by the receiver to the transmitter in special frames. Wi-BFI can decode the BFAs from both 802.11ac and 802.11ax devices operating on radio channels with 160/80/40/20 MHz bandwidth. The tool can also reconstruct the BFI from the BFAs and store it in a file or display it on a screen.

A pair of synchronized CSI maps is superimposed and then fed into the encoder neural network. For example, six convolutional layers may be utilized in the encoder network to extract features, followed by a fully connected layer to directly convert figures. Additionally, ReLu activation functions are applied to each layer. A SE block [50] may be utilized after the last convolution layer in order to extract high-level features. The decoder neural network utilizes resize convolutions with nearest neighbor interpolation operation and contains e.g., seven layers in total. The neural network may be implemented using TensorFlow [55].

Jiang, Wenjun, Hongfei Xue, Chenglin Miao, Shiyang Wang, Sen Lin, Chong Tian, Srinivasan Murali, Haochen Hu, Zhi Sun, and Lu Su. “Towards 3D human pose construction using WiFi.” In Proceedings of the 26th Annual International Conference on Mobile Computing and Networking, pp. 1-14. 2020 also addresses the use of Wi-Fi for human pose estimation, by presenting WiPose. WiPose can reconstruct 3D skeletons composed of the joints on both limbs and torso of the human body. WiPose can encode the prior knowledge of human skeleton into the posture construction process to ensure the estimated joints satisfy the skeletal structure of the human body. Second, to achieve cross environment generalization, WiPose takes as input a 3D velocity profile which can capture the movements of the whole 3D space, and thus separate posture-specific features from the static objects in the ambient environment. WiPose employs a recurrent neural network (RNN) and a smooth loss to enforce smooth movements of the generated skeletons.

The Channel State Information (CSI) from the collected Wi-Fi signals, is fed into the proposed deep learning model. The CSI data is denoised to remove the phase offset of the CSI signals. Then, the denoised CSI data is divided into nonoverlapping small segments and transformed into a representation that can be fed into the deep learning model.

After preprocessing, the raw CSI data extracted from M distributed antennas is transformed into a sequence of input data. After that, a four-layer convolutional neural networks (CNNs) is used to extract spatial features. After the four-layer CNNs, a sequence of feature vectors is obtained. Since a body movement usually spans multiple time slots, there are high temporal dependencies between the consecutive data samples. To learn the relationship between consecutive data samples, the vector is further fed into a recurrent neural network (RNN), e.g., Long ShortTerm Memory (LSTM) [12]. The learned features are then applied to a given skeletal structure to construct the posture of the subject through recursively estimating the rotation of the body segments, a process called forward kinematics. The movement of the subject between a pair of transmitter and receiver will lead to Doppler effect, which shifts the frequency of the signal collected by the receiver. The Doppler frequency shift (DFS) f_{D}(t) is defined as the change in the length of the signal propagation path. DFS profiles are still domain-dependent since they might be different for different wireless links. A deduction of the static components from the conjugate multiplication, a short-time Fourier transform is performed on the remaining dynamic components to extract DFS profile.

Wi-Vi is a see-through-wall device that employs Wi-Fi signals in the 2.4 GHz ISM band. Adib, Fadel, and Dina Katabi. “See through walls with WiFi!” In Proceedings of the ACM SIGCOMM 2013 conference on SIGCOMM, pp. 75-86. 2013. Wi-Vi limits itself to a 20 MHz-wide Wi-Fi channel, and avoids ultra-wideband solutions used to address the flash effect. It also disposes of the large antenna array, typical in past systems, and uses instead a smaller 3-antenna MIMO radio. These limitations are not required in a modern implementation, which can make use of higher frequencies and larger bandwidths, larger number of antennas, and array processors.

Wi-Vi eliminates the flash effect by adapting MIMO communications to through-wall imaging. In MIMO, multiple antenna systems can encode their transmissions so that the signal is nulled (i.e., sums up to zero) at a particular receive antenna. MIMO systems use this capability to eliminate interference to unwanted receivers. Nulling may also be used to eliminate reflections from static objects, including a wall. Specifically, a Wi-Vi device has two transmit antennas and a single receive antenna. Wi-Vi operates in two stages. In the first stage, it measures the channels from each of its two transmit antennas to its receive antenna. In stage 2, the two transmit antennas use the channel measurements from stage 1 to null the signal at the receive antenna. Since wireless signals (including reflections) combine linearly over the medium, only reflections off objects that move between the two stages are captured in stage 2. Reflections off static objects, including the wall, are nulled in this stage.

Note that according to the present technology, the system can “scan” through a large set of parameters, to spatially isolate regions. Because of the high dimensionality of the modern Wi-Fi radios, the scan may be multivariate, and need not isolate individual voxels or unitary condition sets, and these may be tested in parallel and/or as sets of parameters.

Wi-Vi tracks moving objects without an extensive antenna array using inverse synthetic aperture RADAR (ISAR), which uses the movement of the target to emulate an antenna array. In ISAR, there is only one receive antenna; hence, at any point in time, a single measurement is captured. Since the target is moving, consecutive measurements in time emulate an inverse antenna array. By processing such consecutive measurements using standard antenna array beam steering, Wi-Vi can identify the spatial direction of the human. Wi-Vi leverages its ability to track motion to enable a through-wall gesture-based communication channel. Specifically, a human can communicate messages to a Wi-Vi receiver via gestures without carrying any wireless device. After applying a matched filter, the message signal looks similar to standard BPSK encoding (a positive signal for a “1” bit, and a negative signal for a “0” bit) and can be decoded by considering the sign of the signal.

The problem of disentangling correlated super-imposed signals is well studied in signal processing. The basic approach for processing such signals relies on the smoothed MUSIC algorithm. Smoothed MUSIC computes the power received along a particular direction. MUSIC first computes the correlation matrix R[n]: R[n]=E[hhH], where H refers to the Hermitian (conjugate transpose) of the vector. It then performs an eigen decomposition of R[n] to remove the noise and keep the strongest eigenvectors, which in our case correspond to the few moving humans, as well as the DC value. For example, in the presence of only one human, MUSIC would produce one main eigenvector (in addition to the DC eigenvector). On the other hand, if two or three humans were present, it would discover two or three eigenvectors with large eigenvalues (in addition to the DC eigenvector). MUSIC partitions the eigenvector matrix U[n] into two subspaces: the signal space US[n] and the noise space UN[n], where the signal space is the span of the signal eigenvectors, and the noise space is the span of the noise eigenvectors. MUSIC then projects all directions θ on the null space, then takes the inverse. This causes the A's corresponding to the real signals (i.e., moving humans) to spike. In comparison to the conventional MUSIC algorithm described above, smoothed MUSIC performs an additional step before it computes the correlation matrix. It partitions each array h of size w into overlapping sub-arrays of size w′<w. It then computes the correlation matrices for each of these sub-arrays. Finally, it combines the different correlation matrices by summing them up before performing the eigen decomposition. The additional step performed by smoothed MUSIC is intended to de-correlate signals arriving from spatially different entities. Specifically, by taking different shifts for the same antenna array, reflections from different bodies get shifted by different amounts depending on the distance and orientation of the reflector, which helps de-correlating them. The smoothed MUSIC algorithm is conceptually similar to the standard antenna array beamforming; both approaches aim at identifying the spatial angle of the signal. However, by projecting on the null space and taking the inverse norm, MUSIC achieves sharper peaks, and hence is often termed a super-resolution technique. Because smoothed MUSIC is similar to antenna array beamforming, it can be used even to detect a single moving object, i.e., the presence of a single person. To enable Wi-Vi to automatically detect the number of humans in a closed room, a machine learning classifier may be trained using images. The MUSIC algorithm does not incur significant side lobes which would otherwise mask part of signal reflected from different objects.

The system architecture for the location detection comprises one or more IEEE-802.11ax compatible Wi-Fi radios, e.g., Intel ax210, running PicoScenes environment, running with an Intel 14900K processor, ASUS ROG Maximus Z790 Formula motherboard, 64 GB DDR5 memory, and a nVidia RTX4090 for use as a GPGPU processor. Multiple ax210 devices are installed using a Mini PCI-E to PCI-E 1× adapter or M.2 to PCI-E 1× adapter. Software includes Ubuntu and MatLab (PicoScenes MATLAB Toolbox Core (PMT-Core)).

The array of Wi-Fi antennas are strategically positioned in the listening environment.

As an alternate to a Wi-Fi implementation, an SDR receiver (or transmitter and receiver) may be used to generate the interrogation signals and receive the responses. Various algorithms such as beamforming, time difference of arrival (TDOA), or frequency modulated continuous wave (FMCW) may be employed for RADAR-based localization. Signal processing techniques like Fast Fourier Transform (FFT) can be used to analyze RADAR echoes. Triangulation methods, such as multilateration or trilateration, can be used to estimate user positions based on signal strength or time-of-flight measurements. Machine learning techniques, such as fingerprinting or neural networks, can enhance localization accuracy.

Anthropometric data is incorporated into the system to account for variations in ear size and shape. The data is used to create HRTFs individualized for each user. As noted above, generic HRTFs may also be used, with corresponding degradation of performance. The spatial audio algorithm or system is then used to implement real-time audio processing to ensure low-latency spatialized audio rendering. The real-time performance ensures that the user may be tracked as he or she moves within a listening environment.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

### REFERENCES (EACH OF WHICH IS EXPRESSLY INCORPORATED HEREIN BY REFERENCE IN ITS ENTIRETY)

D. G. Fowles, A profile of older Americans: 1986. (1986).
B. Fan, C. Liu, A new predicting model for China's gross population, Chinese Journal of Population Science 6 (2003) 73-76.
T. Tamura, T. Togawa, M. Murata, A bed temperature monitoring system for assessing body movement during sleep, clinical physics and physiological measurement 9 (2) (1988) 139. doi:10.1088/0143-0815/9/2/006.
M. S. Lee, M. Trajkovic, S. Dagtas, S. Gutta, T. Brodsky, V. Philomin, Y. Lin, H. Strubbe, E. CohenSolal, Computer vision based elderly care monitoring system (2003).
A. R. M. Forkan, I. Khalil, A probabilistic model for early prediction of abnormal clinical events using vital sign correlations in homebased monitoring, in: 2016 IEEE International Conference on Pervasive Computing and Communications (PerCom), 2016, pp. 1-9. doi: 10.1109/PERCOM.2016.7456519.
D. Halperin, W. Hu, A. Sheth, D. Wetherall, Predictable 802.11 packet delivery from wireless channel measurements, ACM SIGCOMM Computer Communication Review 41 (4) (2011) 159-170. doi:10.1145/1851182.1851203.
S. Tan, L. Zhang, Z. Wang, J. Yang, MultiTrack: Multi-user tracking and activity recognition using commodity WiFi, in: Proceedings of the 2019 CHI Conference on Human Factors in Computing Systems, 2019, p. 536. doi:10.1145/3290605.3300766.
Y. Zeng, D. Wu, J. Xiong, E. Yi, R. Gao, D. Zhang, FarSense: Pushing the range limit of WiFi-based respiration sensing with CSI ratio of two antennas, Proceedings of the ACM on Interactive, Mobile, Wearable and Ubiquitous Technologies 3 (3) (2019) 121. doi:10.1145/3351279.
X. Shen, L. Guo, Z. Lu, X. Wen, Z. He, WiRIM: Resolution improving mechanism for human sensing with commodity Wi-Fi, IEEE ACCESS 7 (2019) 168357-168370. doi:10.1109/access.2019.2954651.
R. Alp Gu″ler, N. Neverova, I. Kokkinos, Densepose: Dense human pose estimation in the wild, in: Proceedings of the IEEE Conference on Computer Vision and Pattern Recognition, 2018, pp. 7297-7306. doi:10.1109/CVPR.2018.00762.
H.-S. Fang, S. Xie, Y.-W. Tai, C. Lu, RMPE: Regional multi-person pose estimation, in: Proceedings of the IEEE International Conference on Computer Vision, 2017, pp. 2353-2362. doi:10.1109/iccv.2017.256.
D. Zhang, Y. Hu, Y. Chen, B. Zeng, Breathtrack: Tracking indoor human breath status via commodity WiFi, IEEE Internet of Things Journal 6 (2) (2019) 3899-3911. doi:10.1109/JIOT.2019.2893330.
R. Alsina-Pag'es, J. Navarro, F. Al'ias, M. Herv'as, homesound: Realtime audio event detection based on high performance computing for behaviour and surveillance remote monitoring, Sensors 17 (4) (2017) 854. doi:10.3390/s17040854.
D. M. Hutton, Smart environments: technology, protocols, and applications, Kybernetes 34 (6) (2005) 903-904. doi:10.1108/03684920510595580.
T. Yamazaki, The ubiquitous home, International Journal of Smart Home 1 (1) (2007) 17-22.
B. Brumitt, B. Meyers, J. Krumm, A. Kern, S. Shafer, Easyliving: Technologies for intelligent environments, in: International Symposium on Handheld and Ubiquitous Computing, 2000, pp. 12-29. doi: 10.1007/3-540-39959-3_2.
M. Pham, Y. Mengistu, H. M. Do, W. Sheng, Cloud-based smart home environment (CoSHE) for home healthcare, in: 2016 IEEE International Conference on Automation Science and Engineering (CASE), 2016, pp. 483-488. doi:10.1109/COASE.2016.7743444.
Y. Zhou, D. Vongsa, Y. Zhou, Z. Cheng, L. Jing, A healthcare system for detection and analysis of daily activity based on wearable sensor and smartphone, in: 2015 IEEE 12th Intl Conf on Ubiquitous Intelligence and Computing and 2015 IEEE 12th Intl Conf on Autonomic and Trusted Computing and 2015 IEEE 15th Intl Conf on Scalable Computing and Communications and Its Associated Workshops (UIC-ATC-ScalCom), 2015, pp. 1109-1114. doi:10.1109/UIC-ATC-ScalCom-CBDCom-IoP.2015.203.
W. Wang, A. X. Liu, M. Shahzad, K. Ling, S. Lu, Understanding and modeling of WiFi signal based human activity recognition, in: Proceedings of the 21st Annual International Conference on Mobile Computing and Networking (MobiCom), 2015, pp. 65-76. doi:10.1145/2789168. 2790093.
K. Qian, C. Wu, Z. Zhou, Y. Zheng, Z. Yang, Y. Liu, Inferring motion direction using commodity Wi-Fi for interactive exergames, in: Proceedings of the 2017 CHI Conference on Human Factors in Computing Systems, 2017, pp. 1961-1972. doi:10.1145/3025453.3025678.
Y. Wang, K. Wu, L. M. Ni, Wifall: Device-free fall detection by wireless networks, IEEE Transactions on Mobile Computing 16 (2) (2016) 581-594. doi:10.1109/TMC.2016.2557792.
S. Arshad, C. Feng, Y. Liu, Y. Hu, R. Yu, S. Zhou, H. Li, Wi-chase: A WiFi based human activity recognition system for sensorless environments, in: 2017 IEEE 18th International Symposium on A World of Wireless, Mobile and Multimedia Networks (WoWMoM), 2017, pp. 1-6. doi:10.1109/WoWMoM.2017.7974315.
S. Li, X. Li, Q. Lv, D. Zhang, WiFit: A bodyweight exercise monitoring system with commodity Wi-Fi, in: Proceedings of the 2018 ACM International Joint Conference and 2018 International Symposium on Pervasive and Ubiquitous Computing and Wearable Computers, 2018,pp. 396-399. doi:10.1145/3267305.3267563.
Z. Chen, L. Zhang, C. Jiang, Z. Cao, W. Cui, WiFi CSI based passive human activity recognition using attention based BLS™, IEEE Transactions on Mobile Computing 18 (11) (2019) 2714-2724. doi: 10.1109/TMC.2018.2878233.
Q. Xu, Y. Han, B. Wang, M. Wu, K. R. Liu, Indoor events monitoring using channel state information time series, IEEE Internet of Things Journal 6 (3) (2019) 4977-4990. doi:10.1109/JIOT.2019.2894332.
W. Zhang, S. Zhou, L. Yang, L. Ou, Z. Xiao, WiFiMap+: High-level indoor semantic inference with WiFi human activity and environment, IEEE Transactions on Vehicular Technology 68 (8) (2019) 7890-7903. doi:10.1109/TVT.2019.2926844.
K. Qian, C. Wu, Z. Yang, C. Yang, Y. Liu, Decimeter level passive tracking with WiFi, in: Proceedings of the 3rd Workshop on Hot Topics in Wireless, 2016, pp. 44-48. doi:10.1145/2980115.2980131.
K. Qian, C. Wu, Z. Yang, Y. Liu, K. Jamieson, Widar: Decimeter level passive tracking via velocity monitoring with commodity Wi-Fi, in: Proceedings of the 18th ACM International Symposium on Mobile Ad Hoc Networking and Computing, 2017, p. 6. doi:10.1145/3084041. 3084067.
K. Qian, C. Wu, Y. Zhang, G. Zhang, Z. Yang, Y. Liu, Widar2.0: Passive human tracking with a single Wi-Fi link, in: Proceedings of the 16th Annual International Conference on Mobile Systems, Applications, and Services, 2018, pp. 350-361. doi:10. 1145/3210240.3210314.
X. Li, D. Zhang, Q. Lv, J. Xiong, S. Li, Y. Zhang, H. Mei, IndoTrack: Device-free indoor human tracking with commodity Wi-Fi, Proceedings of the ACM on Interactive, Mobile, Wearable and Ubiquitous Technologies 1 (3) (2017) 72. doi:10.1145/3130940.
X. Li, D. Zhang, J. Xiong, Y. Zhang, S. Li, Y. Wang, H. Mei, Trainingfree human vitality monitoring using commodity Wi-Fi devices, Proceedings of the ACM on Interactive, Mobile, Wearable and Ubiquitous Technologies 2 (3) (2018) 121. doi:10.1145/3264931.
K. Qian, C. Wu, Z. Yang, Y. Liu, F. He, T. Xing, Enabling contactless detection of moving humans with dynamic speeds using CSI, ACM Transactions on Embedded Computing Systems (TECS) 17 (2) (2018) 52. doi:10.1145/3157677.
X. Liu, J. Cao, S. Tang, J. Wen, Wi-Sleep: Contactless sleep monitoring via WiFi signals, in: Real-Time Systems Symposium (RTSS), 2014, pp. 346-355. doi:10.1109/RTSS.2014.30.
X. Liu, J. Cao, S. Tang, J. Wen, P. Guo, Contactless respiration monitoring via off-the-shelf WiFi devices, IEEE Transactions on Mobile Computing 15 (10) (2016) 2466-2479. doi:10.1109/TMC.2015.2504935.
X. Wang, C. Yang, S. Mao, PhaseBeat: Exploiting CSI phase data for vital sign monitoring with commodity WiFi devices, in: 2017 IEEE 37th International Conference on Distributed Computing Systems (ICDCS), 2017, pp. 1230-1239. doi:10.1109/ICDCS.2017.206.
H. Wang, D. Zhang, J. Ma, Y. Wang, Y. Wang, D. Wu, T. Gu, B. Xie, Human respiration detection with commodity WiFi devices: Do user location and body orientation matter?, in: Proceedings of the 2016 ACM International Joint Conference on Pervasive and Ubiquitous Computing, 2016, pp. 25-36. doi:10.1145/2971648.2971744.
Y. Zeng, D. Wu, R. Gao, T. Gu, D. Zhang, FullBreathe: Full human respiration detection exploiting complementarity of CSI phase and amplitude of WiFi signals, Proceedings of the ACM on Interactive, Mobile, Wearable and Ubiquitous Technologies 2 (3) (2018) 148. doi:10.1145/3264958.
Y. Chen, Z. Wang, Y. Peng, Z. Zhang, G. Yu, J. Sun, Cascaded pyramid network for multi-person pose estimation, in: Proceedings of the IEEE Conference on Computer Vision and Pattern Recognition, 2018, pp. 7103-7112. doi:10.1109/cvpr.2018.00742.
M. Zhao, T. Li, M. Abu Alsheikh, Y. Tian, H. Zhao, A. Torralba, D. Katabi, Through-wall human pose estimation using radio signals, in: Proceedings of the IEEE Conference on Computer Vision and Pattern Recognition, 2018, pp. 7356-7365. doi:10.1109/CVPR.2018.00768.
F. Adib, C.-Y. Hsu, H. Mao, D. Katabi, F. Durand, Capturing the human figure through a wall, ACM Transactions on Graphics (TOG) 34 (6) (2015) 219. doi:10.1145/2816795.2818072.
M. Zhao, Y. Tian, H. Zhao, M. A. Alsheikh, T. Li, R. Hristov, Z. Kabelac, D. Katabi, A. Torralba, Rf-based 3D skeletons, in: Proceedings of the 2018 Conference of the ACM Special Interest Group on Data Communication, 2018, pp. 267-281. doi:10.1145/3230543.3230579.
L. Guo, Z. Lu, X. Wen, S. Zhou, Z. Han, From signal to image: Capturing fine-grained human poses with commodity Wi-Fi, IEEE Communications Letters 24 (4) (2020) 802-806. doi:10.1109/lcomm.2019.2961890.
Y. Ma, G. Zhou, S. Wang, WiFi sensing with channel state information: A survey, ACM Computing Surveys 52 (3) (2019) 46. doi:10.1145/3310194.
S. Yue, H. He, H. Wang, H. Rahul, D. Katabi, Extracting multi-person respiration from entangled RF signals, Proceedings of the ACM on Interactive, Mobile, Wearable and Ubiquitous Technologies 2 (2) (2018) 86. doi:10.1145/3214289.
Y. Xie, Z. Li, M. Li, Precise power delay profiling with commodity WiFi, in: Proceedings of the 21st Annual International Conference on Mobile Computing and Networking, 2015, pp. 53-64. doi:10.1145/2789168. 2790124.
B. I. Mityashev, The scattering of electromagnetic waves from rough surfaces, Ussr Computational Mathematics and Mathematical Physics 4 (6) (1964) 247-249. doi:10.1016/0041-5553(64)90099-0.
Y. Xie, Z. Li, M. Li, Precise power delay profiling with commodity WiFi, in: ACM/IEEE International Conference on Mobile Computing and Networking., 2015, pp. 53-64. doi:10.1145/2789168.2790124.
A. Odena, V. Dumoulin, C. Olah, Deconvolution and checkerboard artifacts, Distill 1 (10) (2016) e3. doi:10.23915/distill.00003.
A. Aitken, C. Ledig, L. Theis, J. Caballero, Z. Wang, W. Shi, Checkerboard artifact free sub-pixel convolution: A note on sub-pixel convolution, resize convolution and convolution resize, arXiv: Computer Vision and Pattern Recognition (2017). arXiv:1707.02937.
J. Hu, L. Shen, G. Sun, Squeeze-and-excitation networks, in: Proceedings of the IEEE conference on computer vision and pattern recognition, 2018, pp. 7132-7141. doi:10.1109/CVPR.2018.00745.
D. Wu, D. Zhang, C. Xu, H. Wang, X. Li, Device-free WiFi human sensing: From pattern-based to model-based approaches, IEEE Communications Magazine 55 (10) (2017) 91-97. doi:10.1109/MCOM.2017.1700143.
Z. Cao, G. Hidalgo Martinez, T. Simon, S. Wei, Y. A. Sheikh, OpenPose: realtime multi-person 2D pose estimation using part affinity fields (2019). doi:10.1109/TPAMI.2019.2929257.
J. Liu, Y. Wang, Y. Chen, J. Yang, X. Chen, J. Cheng, Tracking vital signs during sleep leveraging off-the-shelf WiFi, in: Proceedings of the 16th ACM International Symposium on Mobile Ad Hoc Networking and Computing, 2015, pp. 267-276. doi:10.1145/2746285.2746303.
D. Halperin, W. Hu, A. Sheth, D. Wetherall, Tool release: Gathering 802.11 n traces with channel state information, ACM SIGCOMM Computer Communication Review 41 (1) (2011) 53-53. doi:10.1145/1925861.1925870.
M. Abadi, P. Barham, J. Chen, Z. Chen, A. Davis, J. Dean, M. Devin, S. Ghemawat, G. Irving, M. Isard, et al., Tensorflow: A system for largescale machine learning, in: Proceedings of the 12th USENIX Conference on Operating Systems Design and Implementation, 2016, pp. 265-283.
M. A. Al-qaness, M. Abd Elaziz, S. Kim, A. A. Ewees, A. A. Abbasi,
Y. A. Alhaj, A. Hawbani, Channel state information from pure communication to sense and track human motion: A survey, Sensors 19 (15) (2019) 3329. doi:10.3390/s19153329.
S. Ren, K. He, R. Girshick, J. Sun, Faster R-CNN: Towards real-time object detection with region proposal networks, in: Advances in neural information processing systems, 2015, pp. 91-99.
K. He, G. Gkioxari, P. Doll'ar, R. Girshick, Mask R-CNN, in: Proceedings of the IEEE international conference on computer vision, 2017, pp. 2961-2969. doi:10.1109/ICCV.2017.322.
J. Redmon, S. Divvala, R. Girshick, A. Farhadi, You only look once: Unified, real-time object detection, in: Proceedings of the IEEE conference on computer vision and pattern recognition, 2016, pp. 779-788. doi:10.1109/CVPR.2016.91.
Y. Zhou, N. Hu, C. J. Spanos, Veto-consensus multiple kernel learning, in: Thirtieth AAAI Conference on Artificial Intelligence, 2016, pp. 2407-2414.
L. Guo, X. Wen, Z. Lu, X. Shen, Z. Han, WiRol: Spatial region of interest human sensing with commodity WiFi, in: 2019 IEEE Wireless Communications and Networking Conference (WCNC), 2019, pp. 1-6. doi:10.1109/WCNC.2019.8886099.
S. Yue, H. He, H. Wang, H. Rahul, D. Katabi, Extracting multi-person respiration from entangled RF signals, Proceedings of the ACM on Interactive, Mobile, Wearable and Ubiquitous Technologies 2 (2) (2018) 86. doi:10.1145/3214289.
X. Wang, C. Yang, S. Mao, Tensorbeat: Tensor decomposition for monitoring multiperson breathing beats with commodity WiFi, ACM Transactions on Intelligent Systems and Technology (TIST) 9 (1) (2017) 8. doi:10.1145/3078855.

[n.d.]. Quaternions and spatial rotation. en.wikipedia.org/wiki/Quaternions_and_spatial_rotation.

[n.d.]. VICON Motion Systems. www.vicon.com.
Karim Abdel-Malek and Jasbir Singh Arora. 2013. Human Motion Simulation: Predictive Dynamics. Academic Press.
Fadel Adib, Chen-Yu Hsu, Hongzi Mao, Dina Katabi, and Frédo Durand. 2015. Capturing the human figure through a wall. ACM Transactions on Graphics (TOG) 34, 6 (2015), 219.
Fadel Adib and Dina Katabi. 2013. See through walls with WiFi! Vol. 43. ACM.
Fadel Adib, Hongzi Mao, Zachary Kabelac, Dina Katabi, and Robert C Miller. 2015. Smart homes that monitor breathing and heart rate. In Proceedings of the 33rd annual ACM conference on human factors in computing systems. ACM, 837-846.
Zhe Cao, Tomas Simon, Shih-En Wei, and Yaser Sheikh. 2017. Realtime multiperson 2d pose estimation using part affinity fields. In Proceedings of the IEEE Conference on Computer Vision and Pattern Recognition. 7291-7299.
Xianjie Chen and Alan L Yuille. 2014. Articulated pose estimation by a graphical model with image dependent pairwise relations. In Advances in neural information processing systems. 1736-1744.
Xiaochuan Fan, Kang Zheng, Yuewei Lin, and Song Wang. 2015. Combining local appearance and holistic view: Dual-source deep neural networks for human pose estimation. In Proceedings of the IEEE conference on computer vision and pattern recognition. 1347-1355.
Hao-Shu Fang, Shuqin Xie, Yu-Wing Tai, and Cewu Lu. 2017. Rmpe: Regional multi-person pose estimation. In Proceedings of the IEEE International Conference on Computer Vision. 2334-2343.
Georgia Gkioxari, Bharath Hariharan, Ross Girshick, and Jitendra Malik. 2014. Using k-poselets for detecting people and localizing their keypoints. In Proceedings of the IEEE Conference on Computer Vision and Pattern Recognition. 3582-3589.
Klaus Greff, Rupesh K Srivastava, Jan Koutnik, Bas R Steunebrink, and Jürgen Schmidhuber. 2016. LSTM: A search space odyssey. IEEE transactions on neural networks and learning systems 28, 10 (2016), 2222-2232.
Daniel Halperin, Wenjun Hu, Anmol Sheth, and David Wetherall. 2011. Tool release: Gathering 802.11 n traces with channel state information. ACM SIGCOMM Computer Communication Review 41, 1 (2011), 53-53.
Kaiming He, Georgia Gkioxari, Piotr Dollár, and Ross Girshick. 2017. Mask r-cnn. In Proceedings of the IEEE international conference on computer vision. 2961-2969.
Kaiming He, Xiangyu Zhang, Shaoqing Ren, and Jian Sun. 2016. Deep residual learning for image recognition. In Proceedings of the IEEE conference on computer vision and pattern recognition. 770-778.
Feng Hong, Xiang Wang, Yanni Yang, Yuan Zong, Yuliang Zhang, and Zhongwen Guo. 2016. WFID: Passive device-free human identification using WiFi signal. In Proceedings of the 13th International Conference on Mobile and Ubiquitous Systems: Computing, Networking and Services. ACM, 47-56.
Chen-Yu Hsu, Yuchen Liu, Zachary Kabelac, Rumen Hristov, Dina Katabi, and Christine Liu. 2017. Extracting gait velocity and stride length from surrounding radio signals. In Proceedings of the 2017 CHI Conference on Human Factors in Computing Systems. ACM, 2116-2126.
Eldar Insafutdinov, Leonid Pishchulin, Bjoern Andres, Mykhaylo Andriluka, and Bernt Schiele. 2016. Deepercut: A deeper, stronger, and faster multi-person pose estimation model. In European Conference on Computer Vision. Springer, 34-50.
Sergey Ioffe and Christian Szegedy. 2015. Batch normalization: Accelerating deep network training by reducing internal covariate shift. arXiv preprint arXiv:1502.03167 (2015).
Wenjun Jiang, Chenglin Miao, Fenglong Ma, Shuochao Yao, Yaqing Wang, Ye Yuan, Hongfei Xue, Chen Song, Xin Ma, Dimitrios Koutsonikolas, et al. 2018. Towards environment independent device free human activity recognition. In Proceedings of the 24th Annual International Conference on Mobile Computing and Networking. ACM, 289-304.
Diederik P Kingma and Jimmy Ba. 2014. Adam: A method for stochastic optimization. arXivpreprint arXiv:1412.6980 (2014).
Manikanta Kotaru, Kiran Joshi, Dinesh Bharadia, and Sachin Katti. 2015. Spotfi: Decimeter level localization using wifi. In ACM SIGCOMM computer communication review, Vol. 45. ACM, 269-282.
Tianxing Li, Chuankai An, Zhao Tian, Andrew T Campbell, and Xia Zhou. 2015. Human sensing using visible light communication. In Proceedings of the 21st Annual International Conference on Mobile Computing and Networking. 331-344.
Tianxing Li, Qiang Liu, and Xia Zhou. 2016. Practical human sensing in the light. In Proceedings of the 14th Annual International Conference on Mobile Systems, Applications, and Services. 71-84.
Xiang Li, Daqing Zhang, Qin Lv, Jie Xiong, Shengjie Li, Yue Zhang, and Hong Mei. 2017. IndoTrack: Device-free indoor human tracking with commodity Wi-Fi. Proceedings of the ACM on Interactive, Mobile, Wearable and Ubiquitous Technologies 1, 3 (2017), 72.
Daniel Maturana and Sebastian Scherer. 2015. Voxnet: A 3d convolutional neural network for real-time object recognition. In 2015 IEEE/RSJ International Conference on Intelligent Robots and Systems (IROS). IEEE, 922-928.
Pedro Melgarejo, Xinyu Zhang, Parameswaran Ramanathan, and David Chu. 2014. Leveraging directional antenna capabilities for fine-grained gesture recognition. In Proceedings of the 2014 ACM International Joint Conference on Pervasive and Ubiquitous Computing. ACM, 541-551.
Pierre Merriaux, Yohan Dupuis, Rémi Boutteau, Pascal Vasseur, and Xavier Savatier. 2017. A study of vicon system positioning performance. Sensors 17, 7 (2017), 1591.
George Papandreou, Tyler Zhu, Nori Kanazawa, Alexander Toshev, Jonathan Tompson, Chris Bregler, and Kevin Murphy. 2017. Towards accurate multi-person pose estimation in the wild. In Proceedings of the IEEE Conference on Computer Vision and Pattern Recognition. 4903-4911.
Leonid Pishchulin, Eldar Insafutdinov, Siyu Tang, Bjoern Andres, Mykhaylo Andriluka, Peter V Gehler, and Bernt Schiele. 2016. Deepcut: Joint subset partition and labeling for multi person pose estimation. In Proceedings of the IEEE Conference on Computer Vision and Pattern Recognition. 4929-4937.
Qifan Pu, Sidhant Gupta, Shyamnath Gollakota, and Shwetak Patel. 2013. Wholehome gesture recognition using wireless signals. In Proceedings of the 19th annual international conference on Mobile computing & networking. ACM, 27-38.
Kun Qian, Chenshu Wu, Zheng Yang, Yunhao Liu, Fugui He, and Tianzhang Xing. 2018. Enabling contactless detection of moving humans with dynamic speeds using CSI. ACM Transactions on Embedded Computing Systems (TECS) 17, 2 (2018), 52.
Kun Qian, Chenshu Wu, Zheng Yang, Yunhao Liu, and Kyle Jamieson. 2017. Widar: Decimeter-level passive tracking via velocity monitoring with commodity Wi-Fi. In Proceedings of the 18th ACM International Symposium on Mobile Ad Hoc Networking and Computing. ACM, 6.
Kun Qian, Chenshu Wu, Zheng Yang, Yunhao Liu, and Zimu Zhou. 2014. PADS: Passive detection of moving targets with dynamic speed using PHY layer information. In 2014 20th IEEE international conference on parallel and distributed systems (ICPADS). IEEE, 1-8.
Kun Qian, Chenshu Wu, Zimu Zhou, Yue Zheng, Zheng Yang, and Yunhao Liu. 2017. Inferring motion direction using commodity wi-fi for interactive exergames. In Proceedings of the 2017 CHI Conference on Human Factors in Computing Systems. ACM, 1961-1972.
Leonid Sigal, Alexandru 0 Balan, and Michael J Black. 2010. Humaneva: Synchronized video and motion capture dataset and baseline algorithm for evaluation of articulated human motion. International journal of computer vision 87, 1-2 (2010), 4.
Nitish Srivastava, Geoffrey Hinton, Alex Krizhevsky, Ilya Sutskever, and Ruslan Salakhutdinov. 2014. Dropout: a simple way to prevent neural networks from overfitting. The journal of machine learning research 15, 1 (2014), 1929-1958.
Jonathan J Tompson, Arjun Jain, Yann LeCun, and Christoph Bregler. 2014. Joint training of a convolutional network and a graphical model for human pose estimation. In Advances in neural information processing systems. 1799-1807.
Deepak Vasisht, Swarun Kumar, and Dina Katabi. 2016. Decimeter-level localization with a single WiFi access point. In 13th USENIX Symposium on Networked Systems Design and Implementation (NSDI 16). 165-178.
Ruben Villegas, Jimei Yang, Duygu Ceylan, and Honglak Lee. 2018. Neural kinematic networks for unsupervised motion retargetting. In Proceedings of the IEEE Conference on Computer Vision and Pattern Recognition. 8639-8648.
Fei Wang, Sanping Zhou, Stanislav Panev, Jinsong Han, and Dong Huang. 2019. Person-in-WiFi: Fine-grained Person Perception using WiFi. In Proceedings of the IEEE International Conference on Computer Vision.
Ju Wang, Hongbo Jiang, Jie Xiong, Kyle Jamieson, Xiaojiang Chen, Dingyi Fang, and Binbin Xie. 2016. LiFS: low human-effort, device-free localization with finegrained subcarrier information. In Proceedings of the 22nd Annual International Conference on Mobile Computing and Networking. ACM, 243-256.
Wei Wang, Alex X Liu, and Muhammad Shahzad. 2016. Gait recognition using wifi signals. In Proceedings of the 2016 ACM International Joint Conference on Pervasive and Ubiquitous Computing. ACM, 363-373.
Wei Wang, Alex X Liu, Muhammad Shahzad, Kang Ling, and Sanglu Lu. 2015. Understanding and modeling of wifi signal based human activity recognition. In Proceedings of the 21st annual international conference on mobile computing and networking. ACM, 65-76.
Zhe Wang, Yang Liu, Qinghai Liao, Haoyang Ye, Ming Liu, and Lujia Wang. 2018. Characterization of a RS-LiDAR for 3D Perception. In 2018 IEEE 8th Annual International Conference on CYBER Technology in Automation, Control, and Intelligent Systems (CYBER). IEEE, 564-569.
Shih-En Wei, Varun Ramakrishna, Takeo Kanade, and Yaser Sheikh. 2016. Convolutional pose machines. In Proceedings of the IEEE Conference on Computer Vision and Pattern Recognition. 4724-4732.
Chenshu Wu, Zheng Yang, Zimu Zhou, Xuefeng Liu, Yunhao Liu, and Jiannong Cao. 2015. Non-invasive detection of moving and stationary human with wifi. IEEE Journal on Selected Areas in Communications 33, 11 (2015), 2329-2342.
Dan Wu, Daqing Zhang, Chenren Xu, Yasha Wang, and Hao Wang. 2016. WiDir: walking direction estimation using wireless signals. In Proceedings of the 2016 ACM international joint conference on pervasive and ubiquitous computing. ACM, 351-362.
Yaxiong Xie, Jie Xiong, Mo Li, and Kyle Jamieson. 2019. mD-Track: Leveraging Multi-Dimensionality for Passive Indoor Wi-Fi Tracking. In The 25th Annual International Conference on Mobile Computing and Networking. ACM, 1-16.
Jie Xiong and Kyle Jamieson. 2013. Array track: A fine-grained indoor location system. In Presented as part of the 10th USENIX Symposium on Networked Systems Design and Implementation (NSDI 13). 71-84.
Bing Xu, Naiyan Wang, Tianqi Chen, and Mu Li. 2015. Empirical evaluation of rectified activations in convolutional network. arXiv preprint arXiv:1505.00853 (2015).
Zheng Yang, Zimu Zhou, and Yunhao Liu. 2013. From RSSI to CSI: Indoor localization via channel response. ACM Computing Surveys (CSUR) 46, 2 (2013), 25.
Sangki Yun, Yi-Chao Chen, and Lili Qiu. 2015. Turning a mobile device into a mouse in the air. In Proceedings of the 13th Annual International Conference on Mobile Systems, Applications, and Services. ACM, 15-29.
Yunze Zeng, Parth H Pathak, and Prasant Mohapatra. 2016. WiWho: wifi-based person identification in smart spaces. In Proceedings of the 15th International Conference on Information Processing in Sensor Networks. IEEE Press, 4.
Fusang Zhang, Daqing Zhang, Jie Xiong, Hao Wang, Kai Niu, Beihong Jin, and Yuxiang Wang. 2018. From fresnel diffraction model to fine-grained human respiration sensing with commodity wi-fi devices. Proceedings of the ACM on Interactive, Mobile, Wearable and Ubiquitous Technologies 2, 1 (2018), 53.
Ouyang Zhang and Kannan Srinivasan. 2016. Mudra: User-friendly Fine-grained Gesture Recognition using WiFi Signals. In Proceedings of the 12th International on Conference on emerging Networking EXperiments and Technologies. ACM, 83-96.
Zhengyou Zhang. 2012. Microsoft kinect sensor and its effect. IEEE multimedia 19, 2 (2012), 4-10.
Mingmin Zhao, Fadel Adib, and Dina Katabi. 2016. Emotion recognition using wireless signals. In Proceedings of the 22nd Annual International Conference on Mobile Computing and Networking. ACM, 95-108.
Mingmin Zhao, Tianhong Li, Mohammad Abu Alsheikh, Yonglong Tian, Hang Zhao, Antonio Torralba, and Dina Katabi. 2018. Through-wall human pose estimation using radio signals. In Proceedings of the IEEE Conference on Computer Vision and Pattern Recognition. 7356-7365.
Mingmin Zhao, Yonglong Tian, Hang Zhao, Mohammad Abu Alsheikh, Tianhong Li, Rumen Hristov, Zachary Kabelac, Dina Katabi, and Antonio Torralba. 2018. RF-based 3D skeletons. In Proceedings of the 2018 Conference of the ACM Special Interest Group on Data Communication. ACM, 267-281.
Mingmin Zhao, Shichao Yue, Dina Katabi, Tommi S Jaakkola, and Matt T Bianchi. 2017. Learning sleep stages from radio signals: A conditional adversarial architecture. In International Conference on Machine Learning. 4100-4109.
Xiaolong Zheng, Jiliang Wang, Longfei Shangguan, Zimu Zhou, and Yunhao Liu. 2016. Smokey: Ubiquitous smoking detection with commercial wifi infrastructures. In IEEE INFOCOM 2016—The 35th Annual IEEE International Conference on Computer Communications. IEEE, 1-9.
Xiaolong Zheng, Jiliang Wang, Longfei Shangguan, Zimu Zhou, and Yunhao Liu. 2017. Design and implementation of a CSI-based ubiquitous smoking detection system. IEEE/ACM Transactions on Networking 25, 6 (2017), 3781-3793.
Yue Zheng, Yi Zhang, Kun Qian, Guidong Zhang, Yunhao Liu, Chenshu Wu, and Zheng Yang. 2019. Zero-Effort Cross-Domain Gesture Recognition with Wi-Fi. In Proceedings of the 17th Annual International Conference on Mobile Systems, Applications, and Services. ACM, 313-325.
Rui Zhou, Xiang Lu, Pengbiao Zhao, and Jiesong Chen. 2017. Device-free presence detection and localization with SVM and CSI fingerprinting. IEEE Sensors Journal 17, 23 (2017), 7990-7999.
Zimu Zhou, Zheng Yang, Chenshu Wu, Longfei Shangguan, and Yunhao Liu. 2013. Omnidirectional coverage for device-free passive human detection. IEEE Transactions on Parallel and Distributed Systems 25, 7 (2013), 1819-1829.
Roshan Ayyalasomayajula, Aditya Arun, Chenfeng Wu, Shrivatsan Rajagopalan, Shreya Ganesaraman, Aravind Seetharaman, Ish Kumar Jain, and Dinesh Bharadia. 2020. LocAP: Autonomous Millimeter Accurate Mapping of WiFi Infrastructure. In 17th USENIX Symposium on Networked Systems Design and Implementation (NSDI 20) (Santa Clara, CA). 1115-1129. www.usenix.org/conference/nsdi20/presentation/ayyalasomayajula
Zhenghua Chen, Le Zhang, Chaoyang Jiang, Zhiguang Cao, and Wei Cui. 2019. WiFi CSI Based Passive Human Activity Recognition Using Attention Based BLS™. IEEE Transactions on Mobile Computing 18, 11 (2019), 2714-2724. doi.org/10.1109/TMC.2018.2878233 Marco Cominelli, Felix Kosterhon, Francesco Gringoli, Renato Lo Cigno, and Arash Asadi. 2021. IEEE 802.11 CSI randomization to preserve location privacy: An empirical evaluation in different scenarios. Elsevier Computer Networks 191 (2021), 1-12. doi.org/10.1016/j.comnet.2021.107970
Cho K, Cominelli M, Gringoli F, Widmer J and Jamieson K. Scalable Multi-Modal Learning for Cross-Link Channel Prediction in Massive IoT Networks. Proceedings of the Twenty-fourth International Symposium on Theory, Algorithmic Foundations, and Protocol Design for Mobile Networks and Mobile Computing. (221-229). doi.org/10.1145/3565287.3610280
Haque K, Meneghello F and Restuccia F. Wi-BFI. Proceedings of the 17th ACM Workshop on Wireless Network Testbeds, Experimental evaluation &Characterization. (104-111). doi.org/10.1145/3615453.3616514
Schumann R, Li F and Grzegorzek M. WiFi Sensing with Single-Antenna Devices for Ambient Assisted Living. Proceedings of the 8th international Workshop on Sensor-Based Activity Recognition and Artificial Intelligence. (1-8). doi.org/10.1145/3615834.3615841
Kakhki, Arash Molavi, and H. Reza Karimi. “A comparison of linear and non-linear transmitter and receiver antenna array processing for interference nulling and diversity with non-zero CSI feedback delay.” In Proceedings of the 2009 International Conference on Wireless Communications and Mobile Computing: Connecting the World Wirelessly, pp. 1112-1115. 2009.
G. Charvat, L. Kempel, E. Rothwell, C. Coleman, and E. Mokole. A through-dielectric radar imaging system. IEEE Trans. Antennas and Propagation, 2010.
G. Charvat, L. Kempel, E. Rothwell, C. Coleman, and E. Mokole. An ultrawideband (UWB) switched-antenna-array radar imaging system. In IEEE ARRAY, 2010.
K. Chetty, G. Smith, and K. Woodbridge. Through-the-wall sensing of personnel using passive bistatic wifi radar at standoff distances. IEEE Trans. Geoscience and Remote Sensing, 2012.
J. Choi, M. Jain, K. Srinivasan, P. Levis, and S. Katti. Achieving single channel, full duplex wireless communication. In ACM MobiCom, 2010.
S. Gollakota, F. Adib, D. Katabi, and S. Seshan. Clearing the RF smog: Making 802.11 robust to cross-technology interference. In ACM SIGCOMM, 2011.
S. Hong, J. Mehlman, and S. Katti. Picasso: full duplex signal shaping to exploit fragmented spectrum. In ACM SIGCOMM, 2012.
M. Jain, J. Choi, T. Kim, D. Bharadia, S. Seth, K. Srinivasan, P. Levis, S. Katti, and P. Sinha. Practical, real-time, full duplex wireless. In ACM MobiCom, 2011.
H. Junker, P. Lukowicz, and G. Troster. Continuous recognition of arm activities with body-worn inertial sensors. In IEEE ISWC, 2004.
Y. Kim and H. Ling. Human activity classification based on micro-doppler signatures using a support vector machine. IEEE Trans. Geoscience and Remote Sensing, 2009.
K. Lin, S. Gollakota, and D. Katabi. Random access heterogeneous MIMO networks. In ACM SIGCOMM, 2010.
B. Lyonnet, C. Ioana, and M. Amin. Human gait classification using microdoppler time-frequency signal representations. In IEEE Radar Conference, 2010.
B. Michoud, E. Guillou, and S. Bouakaz. Real-time and markerless 3D human motion capture using multiple views. Human Motion-Understanding, Modeling, Capture and Animation, 2007.
A. Oppenheim, R. Schafer, J. Buck, et al. Discrete-time signal processing. Prentice hall Englewood Cliffs, NJ: 1989.
T. Ralston, G. Charvat, and J. Peabody. Real-time through-wall imaging using an ultrawideband multiple-input multiple-output (MIMO) phased array radar system. In IEEE ARRAY, 2010.
S. Ram, C. Christianson, Y. Kim, and H. Ling. Simulation and analysis of human micro-dopplers in through-wall environments. IEEE Trans. Geoscience and Remote Sensing, 2010.
S. Ram, Y. Li, A. Lin, and H. Ling. Doppler-based detection and tracking of humans in indoor environments. Journal of the Franklin Institute, 2008.
S. Ram and H. Ling. Through-wall tracking of human movers using joint doppler and array processing. IEEE Geoscience and Remote Sensing Letters, 2008.
T.-J. Shan, M. Wax, and T. Kailath. On spatial smoothing for direction-of-arrival estimation of coherent signals. IEEE Trans. On Acoustics, Speech and Signal Processing, 1985.
F. Soldovieri and R. Solimene. Through-wall imaging via a linear inverse scattering algorithm. IEEE Geoscience and Remote Sensing Letters, 2007.
R. Solimene, F. Soldovieri, G. Prisco, and R. Pierri. Three-dimensional through-wall imaging under ambiguous wall parameters. IEEE Trans. Geoscience and Remote Sensing, 2009.
P. Stoica and R. L. Moses. Spectral Analysis of Signals. Prentice Hall, 2005.
W. C. Stone. Nist construction automation program report no. 3: Electromagnetic signal attenuation in construction materials. In NIST Construction Automation Workshop 1995.
K. Tan, H. Liu, J. Fang, W. Wang, J. Zhang, M. Chen, and G. Voelker. SAM: Enabling Practical Spatial Multiple Access in Wireless LAN. In ACM MobiCom, 2009.
D. Titman. Applications of thermography in non-destructive testing of structures. NDT & E International, 2001.
H. Wang, R. Narayanan, and Z. Zhou. Through-wall imaging of moving targets using uwb random noise radar. IEEE Antennas and Wireless Propagation Letters, 2009.
J. Xiong and K. Jamieson. ArrayTrack: a fine-grained indoor location system. In Usenix NSDI, 2013.
Y. Yang and A. Fathy. See-through-wall imaging using ultra wideband short-pulse radar system. In IEEE Antennas and Propagation Society International Symposium, 2005.
Y. Yang and A. Fathy. Design and implementation of a low-cost real-time ultra-wide band see-through-wall imaging radar system. In IEEE/MTT-S International Microwave Symposium, 2007.
H. Cai and Y. Mostofi. Exploiting object similarity for robotic visual recognition.
IEEE Transactions on Robotics, 37(1):16-33, 2020.
G. Charvat, A. Temme, M. Feigin, and R. Raskar. Time-of-flight microwave camera. Scientific reports, 5(1):1-6, 2015.
W. C. Chew. Waves and fields in inhomogenous media, volume 16. Wiley-IEEE Press, 1995.
S. Depatla, L. Buckland, and Y. Mostofi. X-ray vision with only WiFi power measurements using Rytov wave models. IEEE Transactions on Vehicular Technology, 64(4):1376-1387, 2015.
R. O. Duda and P. E. Hart. Use of the Hough transformation to detect lines and curves in pictures. Communications of the ACM, 15(1):11-15, 1972.
A. Edelstein and M. Rabbat. Background subtraction for online calibration of baseline RSS in RF sensing networks. IEEE Transactions on Mobile Computing, 12(12):2386-2398, 2012.
J. W. Goodman. Introduction to Fourier Optics. Roberts & Co Publishers, Englewood, Colorado, 2005.
J. Guan, S. Madani, S. Jog, S. Gupta, and H. Hassanieh. Through fog high resolution imaging using millimeter wave radar. In Proceedings of the IEEE/CVF Conference on Computer Vision and Pattern Recognition, pages 11464-11473, 2020.
J. Guan, A. Paidimarri, A. Valdes-Garcia, and B. Sadhu. 3D imaging using mmWave 5G signals. In 2020 IEEE Radio Frequency Integrated Circuits Symposium (RFIC), pages 147-150. IEEE, 2020.
D. Halperin, W. Hu, A. Sheth, and D. Wetherall. Tool release: Gathering 802.11n traces with channel state information. ACM SIGCOMM CCR, 41(1):53, January 2011.
P. M. Holl and F. Reinhard. Holography of WiFi radiation. Physical review letters, 118(18):183901, 2017.
P. V. Hough. Method and means for recognizing complex patterns, Dec. 18, 1962. U.S. Pat. No. 3,069,654.
D. Huang, R. Nandakumar, and S. Gollakota. Feasibility and limits of WiFi imaging. In Proceedings of the 12th ACM Conference on Embedded Network Sensor Systems, pages 266-279, 2014.
O. T. Ibrahim, W. Gomaa, and M. Youssef. CrossCount: A Deep learning system for device-free human counting using WiFi. IEEE Sensors Journal, 19(21):9921-9928, 2019.
D. Janakiram, A. Kumar, et al. Outlier detection in wireless sensor networks using Bayesian belief networks. In 2006 1st International Conference on Communication Systems Software & Middleware, pages 1-6. IEEE, 2006.
C. R. Karanam, B. Korany, and Y. Mostofi. Magnitude-based angle-of-arrival estimation, localization, and target tracking. In 2018 17th ACM/IEEE International Conference on Information Processing in Sensor Networks (IPSN), pages 254-265. IEEE, 2018.
C. R. Karanam and Y. Mostofi. 3D through-wall imaging with unmanned aerial vehicles using WiFi. In 2017 16th ACM/IEEE International Conference on Information Processing in Sensor Networks (IPSN), pages 131-142. IEEE, 2017.
J. B. Keller. Geometrical theory of diffraction. Journal of the Optical Society of America, 52(2):116-130, 1962.
B. Korany, C. R. Karanam, H. Cai, and Y. Mostofi. XModal-ID: Using WiFi for through-wall person identification from candidate video footage. In The 25th Annual International Conference on Mobile Computing and Networking, pages 1-15, 2019.
B. Korany and Y. Mostofi. Counting a stationary crowd using off-the-shelf WiFi. In Proceedings of the 19th Annual International Conference on Mobile Systems, Applications, and Services, pages 202-214, 2021.
M. L. Krieg. A tutorial on Bayesian belief networks. Defence Science and Technology Organization (Salisbury, Australia), 2001.
F. R. Kschischang and B. J. Frey. Iterative decoding of compound codes by probability propagation in graphical models. IEEE Journal on Selected Areas in Communications, 16(2):219-230, 1998.
Y. LeCun, L. Bottou, Y. Bengio, and P. Haffner. Gradient-based learning applied to document recognition. Proceedings of the IEEE, 86(11):2278-2324, 1998.
C. Li, Z. Liu, Y. Yao, Z. Cao, M. Zhang, and Y. Liu. WiFi see it all: generative adversarial network-augmented versatile WiFi imaging. In Proceedings of the 18th Conference on Embedded Networked Sensor Systems, pages 436-448, 2020.
X. Liu, J. Cao, S. Tang, J. Wen, and P. Guo. Contactless respiration monitoring via off-the-shelf WiFi devices. IEEE Transactions on Mobile Computing, 15(10):2466-2479, 2015.
J. Pearl. Fusion, propagation, and structuring in belief networks. Artificial intelligence, 29(3):241-288, 1986.
P. C. Proffitt and H. Wang. Static object WiFi imaging and classifier. In 2018 IEEE International Symposium on Technologies for Homeland Security (HST), pages 1-7. IEEE, 2018.
K. Qian, Z. He, and X. Zhang. 3D point cloud generation with millimeter-wave radar. Proceedings of the ACM on Interactive, Mobile, Wearable and Ubiquitous Technologies, 4(4):1-23, 2020.
Y. Rahmat-Samfi. Keller's cone encountered at a hotel. IEEE Antennas and Propagation Magazine, 49(6):88-89, 2007.
R. Ross and M. Hamid. Scattering by a wedge with rounded edge. IEEE Transactions on Antennas and Propagation, 19(4):507-516, 1971.
P. Roy, S. Bhattacharya, S. Ghosh, and U. Pal. STEFANN: scene text editor using font adaptive neural network. In Proceedings of the IEEE/CVF Conference on Computer Vision and Pattern Recognition, pages 13228-13237, 2020.
J. G. Ryan and R. A. Goubran. Near-field beamforming for microphone arrays. In 1997 IEEE International Conference on Acoustics, Speech, and Signal Processing, volume 1, pages 363-366. IEEE, 1997.
S. Vakalis, L. Gong, and J. A. Nanzer. Imaging with WiFi. IEEE Access, 7:28616-28624, 2019.
R. G. Von Gioi, J. Jakubowicz, J.-M. Morel, and G. Randall. LSD: a line segment detector. Image Processing On Line, 2:35-55, 2012.
W. Wang, A. X. Liu, and M. Shahzad. Gait recognition using WiFi signals. In Proceedings of the 2016 ACM International Joint Conference on Pervasive and Ubiquitous Computing, pages 363-373, 2016.
M. E. Yanik and M. Torlak. Near-field 2-D SAR imaging by millimeter-wave radar for concealed item detection. In 2019 IEEE radio and Wireless Symposium (RWS), pages 1-4. IEEE, 2019.
F. Zhang, C. Wu, B. Wang, and K. R. Liu. mmEye: Super-Resolution Millimeter Wave Imaging. IEEE Internet of Things Journal, 8(8):6995-7008, 2020.
S. Zhang, G. Liu, Y. Keping, and S. Wan. Wilmage: Fine-grained Human Imaging from Commodity WiFi. 2021.
M. Zhao, S. Yue, D. Katabi, T. S. Jaakkola, and M. T. Bianchi. Learning sleep stages from radio signals: A conditional adversarial architecture. In International Conference on Machine Learning, pages 4100-4109. PMLR, 2017.
W. Zhong, K. He, and L. Li. Through-the-wall imaging exploiting 2.4 GHz commodity WiFi. arXiv preprint arXiv:1903.03895, 2019.
Y. Zhuo, H. Zhu, and H. Xue. Identifying a new non-linear CSI phase measurement error with commodity WiFi devices. In 2016 IEEE 22nd International Conference on Parallel and Distributed Systems (ICPADS), pages 72-79. IEEE, 2016.
Y. Zi, W. Xi, L. Zhu, F. Yu, K. Zhao, and Z. Wang. WiFi imaging based segmentation and recognition of continuous activity. In International Conference on Collaborative Computing: Networking, Applications and Worksharing, pages 623-641. Springer, 2019.
Seeing through walls MIT's Lincoln Laboratory. www.youtube.com/watch?v=H5xmo7iJ7KA.
Urban Eyes. www.llnl.gov. Lawrence Livermore National Laboratory.
USRP N210. www.ettus.com. Ettus Inc.
R. Bohannon. Comfortable and maximum walking speed of adults aged 20-79 years: reference values and determinants. Age and ageing, 1997.
G. Cohn, D. Morris, S. Patel, and D. Tan. Humantenna: using the body as an antenna for real-time whole-body interaction. In ACM CHI, 2012.
T. Cover and J. Thomas. Elements of information theory. Wiley-interscience, 2006.
Tonini, Elena. “Analysis and Characterization of Wi-Fi Channel State Information.”
Tang, C., Li, W., Vishwakarma, S., Chetty, K., Julier, S., & Woodbridge, K. (2020). Occupancy Detection and People Counting Using WiFi Passive Radar. 2020 IEEE Radar Conference (RadarConf20). doi:10.1109/radarconf2043947.2020
Tang, Chong, Wenda Li, Shelly Vishwakarma, Kevin Chetty, Simon Julier, and Karl Woodbridge. “Occupancy detection and people counting using wifi passive radar.” In 2020 IEEE Radar Conference (RadarConf20), pp. 1-6. IEEE, 2020.
Liu, Jian, Hongbo Liu, Yingying Chen, Yan Wang, and Chen Wang. “Wireless sensing for human activity: A survey.” IEEE Communications Surveys & Tutorials 22, no. 3 (2019): 1629-1645.
Liu, Jian, Hongbo Liu, Yingying Chen, Yan Wang, and Chen Wang. “Wireless sensing for human activity: A survey.” IEEE Communications Surveys & Tutorials 22, no. 3 (2019): 1629-1645.
Li, Wenda, Robert J. Piechocki, Karl Woodbridge, Chong Tang, and Kevin Chetty. “Passive WiFi radar for human sensing using a stand-alone access point.” IEEE Transactions on Geoscience and Remote Sensing 59, no. 3 (2020): 1986-1998.
Li, Wenda, Mohammud Junaid Bocus, Chong Tang, Robert J. Piechocki, Karl Woodbridge, and Kevin Chetty. “On CSI and passive Wi-Fi radar for opportunistic physical activity recognition.” IEEE Transactions on Wireless Communications 21, no. 1 (2021): 607-620.
Feng, Chen, Xiaonan Jiang, Min-Gyo Jeong, Hong Hong, Chang-Hong Fu, Xiaohui Yang, E. Wang, Xiaohua Zhu, and Xiaoguang Liu. “Multitarget vital signs measurement with chest motion imaging based on MIMO radar.” IEEE Transactions on Microwave Theory and Techniques 69, no. 11 (2021): 4735-4747.
Alizadeh, Mostafa. “Remote vital signs monitoring using a mm-wave FMCW radar.” Master's thesis, University of Waterloo, 2019.
Guan, Lei, Zhiya Zhang, Xiaodong Yang, Nan Zhao, Dou Fan, Muhammad Ali Imran, and Qammer H. Abbasi. “Multi-person breathing detection with switching antenna array based on WiFi signal.” IEEE Journal of Translational Engineering in Health and Medicine 11 (2022): 23-31.
Rong, Yu, Isabella Lenz, and Daniel W. Bliss. “Vital Signs Detection Based on High-Resolution 3-D mmWave Radar Imaging.” In 2022 IEEE International Symposium on Phased Array Systems & Technology (PAST), pp. 1-6. IEEE, 2022.
Rong, Yu, Isabella Lenz, and Daniel W. Bliss. “Non-Contact Cardiac Parameters Estimation Using Radar Acoustics for Healthcare IoT.” IEEE Internet of Things Journal (2023).
Wang, Xuyu, Chao Yang, and Shiwen Mao. “On CSI-based vital sign monitoring using commodity WiFi.” ACM Transactions on Computing for Healthcare 1, no. 3 (2020): 1-27.
Singh, Kunwardeep, Himanshu Setia, and Sudhakar Kumar. “Wi-Vi and Li-Fi based framework for Human Identification and Vital Signs Detection through Walls.” In International Conference on Smart Systems and Advanced Computing (Syscom-2021). 2021.
Liu, Jinyi, Youwei Zeng, Tao Gu, Leye Wang, and Daqing Zhang. “WiPhone: Smartphone-based respiration monitoring using ambient reflected WiFi signals.” Proceedings of the ACM on Interactive, Mobile, Wearable and Ubiquitous Technologies 5, no. 1 (2021): 1-19.
Li, Zhi, Tian Jin, Yongpeng Dai, and Yongkun Song. “Through-wall multi-subject localization and vital signs monitoring using UWB MIMO imaging radar.” Remote Sensing 13, no. 15 (2021): 2905.
Mu, Kangle, Tom H. Luan, Lina Zhu, Lin X. Cai, and Longxiang Gao. “A survey of handy see-through wall technology.” IEEE Access 8 (2020): 82951-82971.
Haque, Khandaker Foysal, Francesca Meneghello, and Francesco Restuccia. “Wi-BFI: Extracting the IEEE 802.11 Beamforming Feedback Information from Commercial Wi-Fi Devices.” In Proceedings of the 17th ACM Workshop on Wireless Network Testbeds, Experimental evaluation & Characterization, pp. 104-111. 2023.
Nordin, R.; Armour, S.; McGeehan, J. P. (2010-09-01). “A spatial interference minimization strategy for the correlated LTE downlink channel”. 21st Annual IEEE International Symposium on Personal, Indoor and Mobile Radio Communications. pp. 757-761. doi:10.1109/PIMRC.2010.5671934. hdl:1983/1712. ISBN 978-1-4244-8017-3. S2CID 9927242.
Arapoglou, P. D.; Liolis, K.; Bertinelli, M.; Panagopoulos, A.; Cottis, P.; De Gaudenzi, R. (2011). “MIMO over satellite: A review”. IEEE Communications Surveys & Tutorials. 13 (1): 27-51. doi:10.1109/SURV.2011.033110.00072. S2CID 17591210.
Kyröläinen, J.; Hulkkonen, A.; Ylitalo, J.; Byman, A.; Shankar, B.; Arapoglou, P. D.; Grotz, J. (2014). “Applicability of MIMO to satellite communications”. International Journal of Satellite Communications and Networking. 32 (4): 343-357. doi:10.1002/sat.1040. hdl:10993/24589. S2CID 18467821.
Zang, Guo-zhen; Huang Bao-hua; Mu Jing (2010). “One scheme of cooperative diversity with two satellites based on the alamouti code”. IET 3rd International Conference on Wireless, Mobile and Multimedia Networks (ICWMMN 2010). IET 3rd International Conference on Wireless, Mobile and Multimedia Networks (ICWMMN 2010). pp. 151-4. doi:10.1049/cp.2010.0640. ISBN 978-1-84919-240-8.
Pérez-Neira, A. I.; Ibars, C.; Serra, J.; Del Coso, A.; Gómez-Vilardebó, J.; Caus, M.; Liolis, K. P. (2011). “MIMO channel modeling and transmission techniques for multi-satellite and hybrid satellite-terrestrial mobile networks”. Physical Communication. 4 (2): 127-139. doi:10.1016/j.phycom.2011.04.001. hdl:2117/13225.
Jiang, H.; Shao, S.; Sun, J. (2013). “Virtual MIMO Communication Based on D2D Link”. 2013 3rd International Conference on Consumer Electronics, Communications and Networks. 3rd International Conference on Consumer Electronics, Communications and Networks. pp. 718-722. doi:10.1109/CECNet.2013.6703432. ISBN 978-1-4799-2860-6.
Zaman, N. I.; Kanakis, T.; Rapajic, P. (2010-10-01). “Relaying MIMO for cooperative mobile networks”. 2010 16th Asia-Pacific Conference on Communications (APCC). 2010 16th Asia-Pacific Conference on Communications (APCC). pp. 368-372. doi:10.1109/APCC.2010.5679704. ISBN 978-1-4244-8128-6.
Chu, Shan; Wang, Xin; Yang, Yuanyuan (2013-04-01). “Exploiting Cooperative Relay for High Performance Communications in MIMO Ad Hoc Networks”. IEEE Transactions on Computers. 62 (4): 716-729. doi:10.1109/TC.2012.23. S2CID 18525890.
Tang, Huan; Zhu, Chenxi; Ding, Zhi (2013-06-01). “Cooperative MIMO precoding for D2D underlay in cellular networks”. 2013 IEEE International Conference on Communications (ICC). pp. 5517-5521. doi:10.1109/ICC.2013.6655469. ISBN 978-1-4673-3122-7. S2CID 24022140.
Stefanov, A.; Erkip, E. (2002-09-09). “Cooperative coding for wireless networks”. 4th International Workshop on Mobile and Wireless Communications Network. pp. 273-277. doi:10.1109/MWCN.2002.1045735. ISBN 0-7803-7605-6. S2CID 195861055.
Zhang, Shunwai; Yang, Fengfan; Tang, Lei; Luo, Lin (2013-10-01). “Network-coding-based multisource RA-coded cooperative MIMO”. Proceedings of 2013 3rd International Conference on Computer Science and Network Technology. pp. 737-741. doi:10.1109/ICCSNT.2013.6967215. ISBN 978-1-4799-0561-4. S2CID 16702443.
Baier, P. W.; Meurer, M.; Weber, T.; Troger, H. (2000-09-01). “Joint transmission (JT), an alternative rationale for the downlink of time division CDMA using multi-element transmit antennas”. 2000 IEEE Sixth International Symposium on Spread Spectrum Techniques and Applications. ISSTA 2000. Proceedings (Cat. No. 00TH8536). Vol. 1. pp. 1-5. doi:10.1109/ISSSTA.2000.878069. ISBN 0-7803-6560-7. S2CID 62541739.
Laneman, J. N.; Wornell, Gregory W.; Tse, D. N. C. (2001-06-29). “An efficient protocol for realizing cooperative diversity in wireless networks”. Proceedings. 2001 IEEE International Symposium on Information Theory (IEEE Cat. No. 01CH37252). pp. 294-. doi:10.1109/ISIT.2001.936157. ISBN 0-7803-7123-2. S2CID 830571.
U.S. Patent Application No. 60/286,850, Method and apparatus for using Carrier Interferometry to process multicarrier signals
Shamai, S.; Zaidel, B. M. (2001-05-06). “Enhancing the cellular downlink capacity via co-processing at the transmitting end”. IEEE VTS 53rd Vehicular Technology Conference, Spring 2001. Proceedings (Cat. No. 01CH37202). Vol. 3. pp. 1745-9. doi:10.1109/VETECS.2001.944993. ISBN 0-7803-6728-6. S2CID 62153715.
U.S. Pat. No. 7,430,257, “Multicarrier sub-layer for direct sequence channel and multiple-access coding”
US 20080095121, “Carrier interferometry networks”
U.S. Pat. No. 8,670,390, “Cooperative beam-forming in wireless networks”
Cui, Shuguang; Goldsmith, A. J.; Bahai, A. (2004-08-01). “Energy-efficiency of MIMO and cooperative MIMO techniques in sensor networks”. IEEE Journal on Selected Areas in Communications. 22 (6): 1089-98. doi:10.1109/JSAC.2004.830916. S2CID 8108193.
Li, Xiaohua (2004-12-01). “Space-time coded multi-transmission among distributed transmitters without perfect synchronization”. IEEE Signal Processing Letters. 11 (12): 948-951. Bibcode:2004|SPL . . . 11 . . . 948L. doi:10.1109/LSP.2004.838213.
Zhang, Yanyan; Zhang, Jianhua; Sun, Feifei; Feng, Chong; Zhang, Ping; Xia, Minghua (2008-05-01). “A Novel Timing Synchronization Method for Distributed MIMO-OFDM Systems in Multi-path Rayleigh Fading Channels”. VTC Spring 2008 IEEE Vehicular Technology Conference. pp. 1443-7. doi:10.1109NETECS.2008.340. ISBN 978-1-4244-1644-8. S2CID 18119213.
Gong, Dawei; Zhao, Miao; Yang, Yuanyuan (2010-11-01). “A multi-channel cooperative MIMO MAC protocol for wireless sensor networks”. The 7th IEEE International Conference on Mobile Ad-hoc and Sensor Systems (IEEE MASS 2010). pp. 11-20. doi:10.1109/MASS.2010.5663975. ISBN 978-1-4244-7488-2. S2CID 16943728.
Y. Hua, Y. Mei and Y. Chang, “Wireless antennas—making wireless communications perform like wireline communications,” IEEE Topical Conference on Wireless Communication Technology, pp. 47-73, Honolulu, Hawaii, Oct. 15-17, 2003.
An 802.11ax WiFi radio may be instrumented with PicoScenes CSI monitoring tool. ps.zpj.io, gitlab.com/wifisensing.
Boudlal, Hicham, Mohammed Serrhini, and Ahmed Tahiri. “A comprehensive review of wifi sensing technologies: Tools, challenges and future research directions.” In AIP Conference Proceedings, vol. 2814, no. 1. AIP Publishing, 2023.
Francesco Gringoli, Marco Cominelli, Alejandro Blanco, Joerg Widmer. “AX-CSI: Enabling CSI Extraction on Commercial 802.11ax Wi-Fi Platforms”. In 15th International Workshop on Wireless Network Testbeds, Experimental evaluation & Characterization (WiNTECH'21), Feb. 4, 2022, New Orleans (LA), USA.
Shi, Wei, Meichen Duan, Hui He, Liangliang Lin, Chen Yang, Chenhao Li, and Jizhong Zhao. “Location Adaptive Motion Recognition Based on Wi-Fi Feature Enhancement.” Applied Sciences 13, no. 3 (2023): 1320.
Li, Tianfu, Tangjun Chen, Kunyang Li, and Ruicheng Ao. “Vi-WiFi-Gate: a WiFi sensing gait recognition method inspired by the image vision field.” In International Conference on Internet of Things and Machine Learning (IoTML 2023), vol. 12937, pp. 376-381. SPIE, 2023.
Pokhrel, Shiva Raj, Jonathan Kua, Deol Satish, Phil Williams, Arkady Zaslavsky, Seng W. Loke, and Jinho Choi. “Deakin RF-Sensing: Experiments on Correlated Knowledge Distillation for Monitoring Human Postures with Radios.” IEEE Sensors Journal (2023).
Erdélyi, Viktor, Kazuki Miyao, Akira Uchiyama, and Tomoki Murakami. “Towards Activity Recognition Using Wi-Fi CSI from Backscatter Tags.” In 2023 IEEE International Conference on Pervasive Computing and Communications Workshops and other Affiliated Events (PerCom Workshops), pp. 346-349. IEEE, 2023.
Hu, Jingzhi, Tianyue Zheng, Zhe Chen, Hongbo Wang, and Jun Luo. “MUSE-Fi: Contactless MUlti-person SEnsing Exploiting Near-field Wi-Fi Channel Variation.” In Proceedings of the 29th Annual International Conference on Mobile Computing and Networking, pp. 1-15. 2023.
Shahbazian, Reza, and Irina Trubitsyna. “Human Sensing by using Radio Frequency Signals: A Survey on Occupancy and Activity Detection.” IEEE Access (2023).
Jiao, Wenli, Ju Wang, Yelu He, Xiangdong Xi, Fuwei Wang, Dingyi Fang, and Xiaojiang Chen. “Eliminating design effort: A reconfigurable sensing framework for chipless, backscatter tags.” IEEE/ACM Transactions on Networking (2023).
Sugimoto, Yu, Hamada Rizk, Akira Uchiyama, and Hirozumi Yamaguchi. “Towards Environment-Independent Activity Recognition Using Wi-Fi CSI with an Encoder-Decoder Network.” In Proceedings of the 8th Workshop on Body-Centric Computing Systems, pp. 13-18. 2023.
Pokhrel, Shiva Raj, Jonathan Kua, Deol Satish, Phil Williams, Arkady Zaslavsky, Seng W. Loke, and Jinho Choi. “On Correlated Knowledge Distillation for Monitoring Human Pose with Radios.” arXiv preprint arXiv:2305.14829 (2023).
Luteijn, S. C. A. “Spiking Neural Networks for gesture recognition in WiFi CSI sensing: a feasibility study.”
Zhang, Xianan, Yu Zhang, Guanghua Liu, and Tao Jiang. “AutoLoc: Toward Ubiquitous AoA-Based Indoor Localization Using Commodity WiFi.” IEEE Transactions on Vehicular Technology (2023).
Haque, Khandaker Foysal, Milin Zhang, Francesca Meneghello, and Francesco Restuccia. “BeamSense: Rethinking Wireless Sensing with MU-MIMO Wi-Fi Beamforming Feedback.” arXiv preprint arXiv:2303.09687 (2023).
Cominelli, Marco, Francesco Gringoli, and Francesco Restuccia. “Exposing the CSI: A Systematic Investigation of CSI-based Wi-Fi Sensing Capabilities and Limitations.” In 2023 IEEE International Conference on Pervasive Computing and Communications (PerCom), pp. 81-90. IEEE, 2023.
Ma, Xiaoyu, Wei Xi, Zuhao Chen, Han Hao, and Jizhong Zhao. “ECC: Passenger Counting in the Elevator Using Commodity WiFi.” Applied Sciences 12, no. 14 (2022): 7321.
Yang, Zheng, Yi Zhang, Guoxuan Chi, and Guidong Zhang. “Hands-on wireless sensing with wi-fi: A tutorial.” arXiv preprint arXiv:2206.09532 (2022).
Lin, Liangliang, Kun Zhao, Xiaoyu Ma, Wei Xi, Chen Yang, Hui He, and Jizhong Zhao. “Human Motion Recognition Based on Wi-Fi Imaging.” In Collaborative Computing: Networking, Applications and Worksharing: 17th EAI International Conference, CollaborateCom 2021, Virtual Event, Oct. 16-18, 2021, Proceedings, Part I 17, pp. 608-627. Springer International Publishing, 2021.
Brinke, Jeroen Klein, Alessandro Chiumento, and Paul Havinga. “Joint communication and sensing for human activity recognition in WiFi 6E.” In 5th IFIP International Internet of Things Conference, IoT 2022. 2022.
Ma, Xiaoyu, Hui He, Hui Zhang, Wei Xi, Zuhao Chen, and Jizhong Zhao. “Measuring and Modeling Multipath of Wi-Fi to Locate People in Indoor Environments.” In 2021 IEEE 27th International Conference on Parallel and Distributed Systems (ICPADS), pp. 185-192. IEEE, 2021.
Forbes, Glenn. “Employing multi-modal sensors for personalised smart home health monitoring.” PhD diss., 2022.
Yang, Zheng, Kun Qian, Chenshu Wu, Yi Zhang, Zheng Yang, Kun Qian, Chenshu Wu, and Yi Zhang. “Understanding of Channel State Information.” Smart Wireless Sensing: From IoT to AIoT (2021): 11-21.
Wang, Ruilin, Xiaolin Zhou, Bo Wang, Zhi Zheng, and Yongxin Guo. “A Subcarrier Selection Method for Wi-Fi-based Respiration Monitoring using IEEE 802.11 ac/ax Protocols.” In 2022 IEEE MTT-S International Microwave Biomedical Conference (IMBioC), pp. 189-191. IEEE, 2022.
“Audio Engineering Society Convention Paper, Spatial Aliasing Artifacts Produced by Linear and Circular Loudspeaker Arrays used for Wave Field Synthesis” (PDF). Retrieved 2012-02-03.
Ziemer, Tim (2018). “Wave Field Synthesis”. In Bader, Rolf (ed.). Springer Handbook of Systematic Musicology. Springer Handbooks. Berlin/Heidelberg: Springer. pp. 329-347. doi:10.1007/978-3-662-55004-5_18. ISBN 978-3-662-55004-5.
Ziemer, Tim (2017). “Source Width in Music Production. Methods in Stereo, Ambisonics, and Wave Field Synthesis”. In Schneider, Albrecht (ed.). Studies in Musical Acoustics and Psychoacoustics. Current Research in Systematic Musicology. Vol. 4. Cham: Springer. pp. 299-340. doi:10.1007/978-3-319-47292-8_10. ISBN 978-3-319-47292-8.
Ziemer, Tim (2020). Psychoacoustic Music Sound Field Synthesis. Current Research in Systematic Musicology. Vol. 7. Cham: Springer International Publishing. doi:10.1007/978-3-030-23033-3. ISBN 978-3-030-23033-3.
Berkhout, A. J.: A Holographic Approach to Acoustic Control, J. Audio Eng. Soc., vol. 36, December 1988, pp. 977-995
Berkhout, A. J.; De Vries, D.; Vogel, P.: Acoustic Control by Wave Field Synthesis, J. Acoust. Soc. Am., vol. 93, Mai 1993, pp. 2764-2778
Lim, C.; Yoo, T.; Clerckx, B.; Lee, B.; Shim, B. Recent trend of multiuser MIMO in LTE advanced. IEEE Commun. Mag. 2013, 51, 127-135.
Alamouti, S. M. A Simple Transmit Diversity Technique for Wireless Communications. IEEE J. Sel. Areas Commun. 1998, 16, 1451-1458.
Renzo, M. D.; Haas, H.; Grant, P. M. Spatial Modulation for Multiple-Antenna Wireless System: A Survey. IEEE Commun. Mag. 2011, 49, 182-191.
Nguyen, D. N.; Krunz, M. A cooperative clustering protocol for energy constrained networks. In Proceedings of the 8th IEEE Communications Society Conference on Sensor, Mesh and Ad Hoc Communications and Networks (SECON), Lake City, UT, USA, 27-30 Jun. 2011; pp. 574-582.
Chu, S.; Wang, X. Opportunistic and cooperative spatial multiplexing in MIMO ad hoc networks. In Proceedings of the ACM Mobihoc Conference, Hong Kong, China, 26-30 May 2008; pp. 63-72.
Gesbert, D.; Hanly, S.; Huang, H.; Shitz, S. S.; Simeone, O.; Yu, W. Multi-cell MIMO cooperative networks: A new look at interference. IEEE J. Sel. Areas Commun. 2010, 28, 1380-1408.
Thomas, M. C.; El Gamal, A. A. Capacity Theorems for the Relay Channels. IEEE Trans. Inf. Theory. 1979, 25, 572-584.
Sendonaris, A.; Erkip, E.; Aazhang, B. Increasing Uplink Capacity via User Cooperation Diversity. In Proceedings of the 1998 IEEE International Symposium on Information Theory (Cat. No. 98CH36252), Cambridge, MA, USA, 1-6 Jul. 1998; p. 156.
Laneman, J. N.; Tse, D. N. C.; Wornell, G. W. Cooperative Diversity in Wireless Networks: Efficient Protocols and Outage Behavior. IEEE Trans. Inf. Theory 2004, 50, 3062-3080.
Hunter, T. E.; Nosratinia, A. Cooperation Diversity Through Coding. In Proceedings of the IEEE International Symposium on Information Theory, Lausanne, Switzerland, 30 Jun.-5 Jul. 2002; pp. 220-227.
Mesleh, R.; Haas, H.; Ahn, C. W.; Yun, S. Spatial modulation-A new low complexity spectral efficiency enhancing technique. In Proceedings of the Conference on Communications and Networking in China, Beijing, China, 25-27 Oct. 2006; pp. 1-5.
Mesleh, R.; Hass, H.; Sinanovic, S.; Ahnn, C.; Yun, S. Spatial Modulation. IEEE Trans. Veh. Technol. 2008, 57, 2228-2241.
Wen, M.; Cheng, X.; Yang, L. Index Modulation for 5G Wireless Communications; Springer: Berlin, Germany, 2017.
Basar, E.; Wen, M.; Mesleh, R.; Di Renzo, M.; Xiao, Y.; Haas, H. Index Modulation Techniques for Next-Generation Wireless Networks. IEEE Access 2017, 5, 16693-16746.
Yang, P.; Xiao, Y.; Xiao, M.; Li, S. 6G wireless communications: Vision and potential techniques. IEEE Netw. 2019, 33, 70-75.
Jeganathan, J.; Ghrayeb, A.; Szczecinski, L. Generalized space shift keying modulation for MIMO channels. In Proceedings of the IEEE 19th International Symposium on Personal, Indoor and Mobile Radio Communications, Cannes, France, 15-18 Sep. 2008; pp. 1-5.
Wang, J.; Jia, S.; Song, J. Generalised spatial modulation system with multiple active transmit antennas and low complexity detection scheme. IEEE Trans. Wireless Commun. 2012, 11, 1605-1615.
Bevan, D. D. N.; Tanner, R.; Ward, C. R. Space-Time Coding for Capacity Enhancement in Future-Generation Wireless Communications Networks//Capacity and Range Enhancement Techniques for the Third Generation Mobile Communications and Beyond (Ref. No. 2000/003). IEE Colloq. IET 2000, 8, 1-811.
Foschini, G. J.; Gans, M. J. On Limits of Wireless Communications in A Fading Environment When Using Multiple Antennas. Wirel. Pers. Commun. 1998, 6, 311-335.
Tarokh, V.; Seshadri, N.; Calderbank, A. R. Space-Time Codes for High Aata Rate Wireless Communication: Performance Criterion and Code Construction. IEEE Trans. Inf. Theory 1998, 44, 744-765.
Tarokh, V.; Jafarkhani, H.; Calderbank, A. R. Space-Time Block Codes from Orthogonal Designs. IEEE Trans. Inf. Theory 1999, 45, 1456-1467.
Irfan, M.; Aissa, S. Space-Time Mapping for Equiprobable Antenna Activation in Spatial Modulation. IEEE Commun. Lett. 2020, 24, 2961-2964.
Li, S.; Zhang, J.-K.; Mu, X. Noncoherent massive space-time block codes for uplink network communications. IEEE Trans. Veh. Technol. 2018, 67, 5013-5027.
Duarte, F. L.; de Lamare, R. C. Switched Max-Link Relay Selection Based on Maximum Minimum Distance for Cooperative MIMO Systems. IEEE Trans. Veh. Technol. 2020, 69, 1928-1941.
Huang, F.; Zhan, Y. Design of Spatial Constellation for Spatial Modulation. IEEE Wirel. Commun. Lett. 2020, 9, 1097-1100.
Niu, H.; Lei, X.; Xiao, Y.; Li, Y.; Xiang, W. Performance Analysis and Optimization of Secure Generalized Spatial Modulation. IEEE Trans. Commun. 2020, 68, 4451-4460.
Wei, R. Low-Complexity Differential Spatial Modulation Schemes for a Lot of Antennas. IEEE Access 2020, 8, 63725-63734.
Wang, Y.; Xiong, W.; Xiao, Y.; Fang, S.; Li, Y. Transmit Antenna Selection in Offset Spatial Modulation Systems. IEEE Commun. Lett. 2020, 24, 1572-1576.
Basar, E.; Aygolu, U.; Panayirci, E.; Vincent Poor, H. A reliable successive relaying protocol. IEEE Trans. Commun. 2014, 62, 1431-1443.
Simon, M. K.; Alouini, M. S. Digital Communication over Fading Channels, 2nd ed.; Wiley: Hoboken, NJ, USA, 2005.
Proakis, J. G. Digital Communications, 4th ed.; McGraw-Hill: New York, NY, USA, 2000.
Hai, Han, Caiyan Li, Jun Li, Yuyang Peng, Jia Hou, and Xue-Qin Jiang. 2021. “Space-Time Block Coded Cooperative MIMO Systems” Sensors 21, no. 1: 109. doi.org/10.3390/s21010109
Ropitault, Tanguy, C. R. C. M. da Silva, Steve Blandino, Anirudha Sahoo, Nada Golmie, Kangjin Yoon, Carlos Aldana, and Chunyu Hu. “IEEE 802.11 bf WLAN sensing procedure: Enabling the widespread adoption of Wi-Fi sensing.” IEEE Communications Standards Magazine (2023).
Du, Rui, Haocheng Hua, Hailiang Xie, Xianxin Song, Zhonghao Lyu, Mengshi Hu, Yan Xin et al. “An overview on IEEE 802.11 bf: WLAN sensing.” arXiv preprint arXiv:2310.17661 (2023).
Chen, Cheng, Hao Song, Qinghua Li, Francesca Meneghello, Francesco Restuccia, and Carlos Cordeiro. “Wi-Fi sensing based on IEEE 802.11 bf.” IEEE Communications Magazine 61, no. 1 (2022): 121-127.
Meneghello, Francesca, Cheng Chen, Carlos Cordeiro, and Francesco Restuccia. “Toward integrated sensing and communications in IEEE 802.11 bf Wi-Fi networks.” IEEE Communications Magazine 61, no. 7 (2023): 128-133.
Blandino, Steve, Tanguy Ropitault, Claudio RCM da Silva, Anirudha Sahoo, and Nada Golmie. “IEEE 802.11 bf DMG Sensing: Enabling High-Resolution mmWave Wi-Fi Sensing.” IEEE Open Journal of Vehicular Technology 4 (2023): 342-355.
Blandino, Steve, Tanguy Ropitault, Anirudha Sahoo, and Nada Golmie. “Tools, models and dataset for IEEE 802.11 ay CSI-based sensing.” In 2022 IEEE Wireless Communications and Networking Conference (WCNC), pp. 662-667. IEEE, 2022.
Ropitault, Tanguy, Steve Blandino, Anirudha Sahoo, and Nada T. Golmie. “IEEE 802.11 bf: Enabling the Widespread Adoption of Wi-Fi Sensing.” (2023).
Kondo, Sota, Sohei Itahara, Kota Yamashita, Koji Yamamoto, Yusuke Koda, Takayuki Nishio, and Akihito Taya. “Bi-directional beamforming feedback-based firmware-agnostic WiFi sensing: An empirical study.” IEEE Access 10 (2022): 36924-36934.
Kumar Gupta, Ankit, and T. G. Venkatesh. “Design and analysis of IEEE 802.11 based full duplex WLAN MAC protocol.” Computer Networks 210 (2022): 108933.
Meneghello, Francesca, Domenico Garlisi, Nicoló Dal Fabbro, Ilenia Tinnirello, and Michele Rossi. “Sharp: Environment and person independent activity recognition with commodity ieee 802.11 access points.” IEEE Transactions on Mobile Computing (2022).
Hossen, Mohammad Rabiul, Mehrab Ramzan, and Padmanava Sen. “Slot-loading based compact wideband monopole antenna design and isolation improvement of MIMO for Wi-Fi sensing application.” Microwave and Optical Technology Letters (2023).
Chen, Wanshi, Ilker Demirkol, Gunes Karabulut-Kurt, Miraj Mostafa, and Stefano Ruffini. “Mobile Communications and Networks.” IEEE Communications Magazine 61, no. 7 (2023): 104-105.
Tang, Aimin, Songqian Li, and Xudong Wang. “Self-interference-resistant IEEE 802.11 ad-based joint communication and automotive radar design.” IEEE Journal of Selected Topics in Signal Processing 15, no. 6 (2021): 1484-1499.
Meneghello, Francesca, Alejandro Blanco, Antonio Cusano, Joerg Widmer, and Michele Rossi. “Wi-Fi Multi-Path Parameter Estimation for Sub-7 GHz Sensing: A Comparative Study.” In 2023 19th International Conference on Wireless and Mobile Computing, Networking and Communications (WiMob), pp. 237-242. IEEE, 2023.
Wu, Chenshu, Beibei Wang, Oscar C. Au, and K J Ray Liu. “Wi-fi can do more: toward ubiquitous wireless sensing.” IEEE Communications Standards Magazine 6, no. 2 (2022): 42-49.
Baskind, Alexis, Thibaut Carpentier, Markus Noisternig, Olivier Warusfel, and Jean-Marc Lyzwa. “Binaural and transaural spatialization techniques in multichannel 5.1 production (Anwendung binauraler und transauraler Wiedergabetechnik in der 5.1 Musikproduktion).” 27th Tonmeistertagung—VDT International Convention, November, 2012
Begault, Durand R., and Leonard J. Trejo. “3-D sound for virtual reality and multimedia.” (2000), NASA/TM-2000-209606 discusses various implementations of spatialized audio systems.
Begault, Durand, Elizabeth M. Wenzel, Martine Godfroy, Joel D. Miller, and Mark R. Anderson. “Applying spatial audio to human interfaces: 25 years of NASA experience.” In Audio Engineering Society Conference: 40th International Conference: Spatial Audio: Sense the Sound of Space. Audio Engineering Society, 2010.
Bosun, Xie, Liu Lulu, and Chengyun Zhang. “Transaural reproduction of spatial surround sound using four actual loudspeakers.” In Inter-Noise and Noise-Con Congress and Conference Proceedings, vol. 259, no. 9, pp. 61-69. Institute of Noise Control Engineering, 2019.
Casey, Michael A., William G. Gardner, and Sumit Basu. “Vision steered beam-forming and transaural rendering for the artificial life interactive video environment (alive).” In Audio Engineering Society Convention 99. Audio Engineering Society, 1995.
Cooper, Duane H., and Jerald L. Bauck. “Prospects for transaural recording.” Journal of the Audio Engineering Society 37, no. 1/2 (1989): 3-19.
Duraiswami, Grant, Mesgarani, Shamma, Augmented Intelligibility in Simultaneous Multi-talker Environments. 2003, Proceedings of the International Conference on Auditory Display (ICAD'03). en.wikipedia.org/wiki/Perceptual-based_3D_sound_localization
Fazi, Filippo Maria, and Eric Hamdan. “Stage compression in transaural audio.” In Audio Engineering Society Convention 144. Audio Engineering Society, 2018.
Gardner, William Grant. Transaural 3-D audio. Perceptual Computing Section, Media Laboratory, Massachusetts Institute of Technology, 1995.
Glasal, ralph, Ambiophonics, Replacing Stereophonics to Achieve Concert-Hall Realism, 2nd Ed (2015).
Greff, Raphael. “The use of parametric arrays for transaural applications.” In Proceedings of the 20th International Congress on Acoustics, pp. 1-5. 2010.
Guastavino, Catherine, Véronique Larcher, Guillaume Catusseau, and Patrick Boussard. “Spatial audio quality evaluation: comparing transaural, ambisonics and stereo.” Georgia Institute of Technology, 2007.
Guldenschuh, Markus, and Alois Sontacchi. “Application of transaural focused sound reproduction.” In 6th Eurocontrol INO-Workshop 2009. 2009.
Guldenschuh, Markus, and Alois Sontacchi. “Transaural stereo in a beamforming approach.” In Proc. DAFx, vol. 9, pp. 1-6. 2009.
Guldenschuh, Markus, Chris Shaw, and Alois Sontacchi. “Evaluation of a transaural beamformer.” In 27th Congress of the International Council of the Aeronautical Sciences (ICAS 2010). Nizza, Frankreich, pp. 2010-10. 2010.
Guldenschuh, Markus. “Transaural beamforming.” PhD diss., Master's thesis, Graz University of Technology, Graz, Austria, 2009.
Hartmann, William M., Brad Rakerd, Zane D. Crawford, and Peter Xinya Zhang. “Transaural experiments and a revised duplex theory for the localization of low-frequency tones.” The Journal of the Acoustical Society of America 139, no. 2 (2016): 968-985.
Herder, Jens. “Optimization of sound spatialization resource management through clustering.” In The Journal of Three Dimensional Images, 3D-Forum Society, vol. 13, no. 3, pp. 59-65. 1999 relates to algorithms for simplifying spatial audio processing.
Hollerweger, Florian. Periphonic sound spatialization in multi-user virtual environments. Institute of Electronic Music and Acoustics (IEM), Center for Research in Electronic Art Technology (CREATE) Ph.D dissertation 2006.
Ito, Yu, and Yoichi Haneda. “Investigation into Transaural System with Beamforming Using a Circular Loudspeaker Array Set at Off-center Position from the Listener.” Proc. 23rd Int. Cong. Acoustics (2019).
Johannes, Reuben, and Woon-Seng Gan. “3D sound effects with transaural audio beam projection.” In 10th Western Pacific Acoustic Conference, Beijing, China, paper, vol. 244, no. 8, pp. 21-23. 2009.
Jost, Adrian, and Jean-Marc Jot. “Transaural 3-d audio with user-controlled calibration.” In Proceedings of COST-G6 Conference on Digital Audio Effects, DAFX2000, Verona, Italy. 2000.
Kaiser, Fabio. “Transaural Audio—The reproduction of binaural signals over loudspeakers.” PhD diss., Diploma Thesis, Universitst für Musik und darstellende Kunst Graz/Institut für Elekronische Musik und Akustik/IRCAM, March 2011, 2011.
Lauterbach, Christian, Anish Chandak, and Dinesh Manocha. “Interactive sound rendering in complex and dynamic scenes using frustum tracing.” IEEE Transactions on Visualization and Computer Graphics 13, no. 6 (2007): 1672-1679 also employs graphics-style analysis for audio processing.
Liu, Lulu, and Bosun XIE. “The limitation of static transaural reproduction with two frontal loudspeakers.” (2019)
Malham, David G., and Anthony Myatt. “3-D sound spatialization using ambisonic techniques.” Computer music journal 19, no. 4 (1995): 58-70 discusses use of ambisonic techniques (use of 3D sound fields).
McGee, Ryan, and Matthew Wright. “Sound element spatializer.” In ICMC. 2011.; and McGee, Ryan, “Sound element spatializer.” (M.S. Thesis, U. California Santa Barbara 2010), presents Sound Element Spatializer (SES), a novel system for the rendering and control of spatial audio. SES provides multiple 3D sound rendering techniques and allows for an arbitrary loudspeaker configuration with an arbitrary number of moving sound sources.
Meaux, Eric, and Sylvain Marchand. “Synthetic Transaural Audio Rendering (STAR): a Perceptive Approach for Sound Spatialization.” 2019.
Murphy, David, and Flaithri Neff. “Spatial sound for computer games and virtual reality.” In Game sound technology and player interaction: Concepts and developments, pp. 287-312. IGI Global, 2011 discusses spatialized audio in a computer game and VR context.
Naef, Martin, Oliver Staadt, and Markus Gross. “Spatialized audio rendering for immersive virtual environments.” In Proceedings of the ACM symposium on Virtual reality software and technology, pp. 65-72. ACM, 2002 discloses feedback from a graphics processor unit to perform spatialized audio signal processing.
Samejima, Toshiya, Yo Sasaki, Izumi Taniguchi, and Hiroyuki Kitajima. “Robust transaural sound reproduction system based on feedback control.” Acoustical Science and Technology 31, no. 4 (2010): 251-259.
Shohei Nagai, Shunichi Kasahara, Jun Rekimot, “Directional communication using spatial sound in human-telepresence.” Proceedings of the 6th Augmented Human International Conference, Singapore 2015, ACM New York, NY, USA, ISBN: 978-1-4503-3349-8
Simon Galvez, Marcos F., and Filippo Maria Fazi. “Loudspeaker arrays for transaural reproduction.” (2015).
Simon Galvez, Marcos Felipe, Miguel Blanco Galindo, and Filippo Maria Fazi. “A study on the effect of reflections and reverberation for low-channel-count Transaural systems.” In Inter-Noise and Noise-Con Congress and Conference Proceedings, vol. 259, no. 3, pp. 6111-6122. Institute of Noise Control Engineering, 2019.
Siu-Lan Tan, Annabel J. Cohen, Scott D. Lipscomb, Roger A. Kendall, “The Psychology of Music in Multimedia”, Oxford University Press, 2013.
Verron, Charles, Mitsuko Aramaki, Richard Kronland-Martinet, and Grégory Pallone. “A 3-D immersive synthesizer for environmental sounds.” IEEE Transactions on Audio, Speech, and Language Processing 18, no. 6 (2009): 1550-1561 relates to spatialized sound synthesis.
Villegas, Julian, and Takaya Ninagawa. “Pure-data-based transaural filter with range control.” (2016).
An, Sizhe, and Umit Y. Ogras. “Fast and scalable human pose estimation using mmwave point cloud.” In Proceedings of the 59th ACM/IEEE Design Automation Conference, pp. 889-894. 2022
Cao, Zhongping, Wen Ding, Rihui Chen, Jianxiong Zhang, Xuemei Guo, and Guoli Wang. “A joint global-local network for human pose estimation with millimeter wave radar.” IEEE Internet of Things Journal 10, no. 1 (2022): 434-446
Chen, Anjun, Xiangyu Wang, Shaohao Zhu, Yanxu Li, Jiming Chen, and Qi Ye. “mmbody benchmark: 3d body reconstruction dataset and analysis for millimeter wave radar.” In Proceedings of the 30th ACM International Conference on Multimedia, pp. 3501-3510. 2022
Chen, Haoming, Runyang Feng, Sifan Wu, Hao Xu, Fengcheng Zhou, and Zhenguang Liu. “2D Human pose estimation: A survey.” Multimedia systems 29, no. 5 (2023): 3115-3138
Chen, Yi-Chung, Zhi-Kai Huang, Lu Pang, Jian-Yu Jiang-Lin, Chia-Han Kuo, Hong-Han Shuai, and Wen-Huang Cheng. “Seeing the unseen: Wifi-based 2D human pose estimation via an evolving attentive spatial-Frequency network.” Pattern Recognition Letters 171 (2023): 21-27
Chou, Chia-Jung, Jui-Ting Chien, and Hwann-Tzong Chen. “Self adversarial training for human pose estimation.” In 2018 Asia-Pacific Signal and Information Processing Association Annual Summit and Conference (APSIPA ASC), pp. 17-30. IEEE, 2018
Cui, Han, and Naim Dahnoun. “Real-time short-range human posture estimation using mmwave radars and neural networks.” IEEE Sensors Journal 22, no. 1 (2021): 535-543
Debnath, Bappaditya, Mary O'brien, Motonori Yamaguchi, and Ardhendu Behera. “Adapting MobileNets for mobile based upper body pose estimation.” In 2018 15th IEEE International Conference on Advanced Video and Signal Based Surveillance (AVSS), pp. 1-6. IEEE, 2018
Gao, Zhiqiang, Luqman Ali, Cong Wang, Ruizhi Liu, Chunwei Wang, Cheng Qian, Hokun Sung, and Fanyi Meng. “Real-time non-contact millimeter wave radar-based vital sign detection.” Sensors 22, no. 19 (2022): 7560. www.mdpi.com/1424-8220/22/19/7560
Geng, Jiaqi, Dong Huang, and Fernando De la Torre. “Densepose from wifi.” arXiv preprint arXiv:2301.00250 (2022)
Gian, TD, Toan, Tien Dac Lai, Thien Van Luong, Kok-Seng Wong, and Van-Dinh Nguyen. “HPE-Li: WiFi-Enabled Lightweight Dual Selective Kernel Convolution for Human Pose Estimation.” In European Conference on Computer Vision, pp. 93-111. Springer, Cham, 2024
Iyer, Srikrishna, Leo Zhao, Manoj Prabhakar Mohan, Joe Jimeno, Mohammed Yakoob Siyal, Arokiaswami Alphones, and Muhammad Faeyz Karim. “mm-Wave radar-based vital signs monitoring and arrhythmia detection using machine learning.” Sensors 22, no. 9 (2022): 3106. pmc.ncbi.nlm.nih.gov/articles/PMC9104941/
Kim, Gon Woo, Sang Won Lee, Ha Young Son, and Kae Won Choi. “A study on 3D human pose estimation using through-wall IR-UWB radar and transformer.” IEEE Access 11 (2023): 15082-15095
Lee, Shih-Po, Niraj Prakash Kini, Wen-Hsiao Peng, Ching-Wen Ma, and Jenq-Neng Hwang. “Hupr: A benchmark for human pose estimation using millimeter wave radar.” In Proceedings of the IEEE/CVF Winter Conference on Applications of Computer Vision, pp. 5715-5724. 2023
Li, Guangzheng, Ze Zhang, Hanmei Yang, Jin Pan, Dayin Chen, and Jin Zhang. “Capturing human pose using mmWave radar.” In 2020 IEEE International Conference on Pervasive Computing and Communications Workshops (PerCom Workshops), pp. 1-6. IEEE, 2020
Ling, Zongquan, Weinan Zhou, Yuhao Ren, Jiping Wang, and Liquan Guo. “Non-contact heart rate monitoring based on millimeter wave radar.” IEEE Access 10 (2022): 74033-74044. ieeexplore.ieee.org/document/9828029
Ren, Yili, and Jie Yang. “3d human pose estimation for free-from and moving activities using wifi.” arXiv preprint arXiv:2204.07878 (2022)
Ren, Yili, Zi Wang, Yichao Wang, Sheng Tan, Yingying Chen, and Jie Yang. “GoPose: 3D human pose estimation using WiFi.” Proceedings of the ACM on Interactive, Mobile, Wearable and Ubiquitous Technologies 6, no. 2 (2022): 1-25
Ren, Yili, Zi Wang, Yichao Wang, Sheng Tan, Yingying Chen, and Jie Yang. “3D human pose estimation using WiFi signals.” In Proceedings of the 19th ACM Conference on Embedded Networked Sensor Systems, pp. 363-364. 2021
Shastri, Anish, Neharika Valecha, Enver Bashirov, Harsh Tataria, Michael Lentmaier, Fredrik Tufvesson, Michele Rossi, and Paolo Casari. “A review of millimeter wave device-based localization and device-free sensing technologies and applications.” IEEE Communications Surveys & Tutorials 24, no. 3 (2022): 1708-1749
Song, Yongkun, Tian Jin, Yongpeng Dai, and Xiaolong Zhou. “Efficient through-wall human pose reconstruction using UWB MIMO radar.” IEEE Antennas and Wireless Propagation Letters 21, no. 3 (2021): 571-575
Subramani, Srinivasan, “Using mmWave radar for vital signs monitoring”, (2020) www.embedded.com/using-mmwave-radar-for-vital-signs-monitoring/
Wang, Fei, Sanping Zhou, Stanislav Panev, Jinsong Han, and Dong Huang. “Person-in-WiFi: Fine-grained person perception using WiFi.” In Proceedings of the IEEE/CVF International Conference on Computer Vision, pp. 5452-5461. 2019
Wang, Fei, Stanislav Panev, Ziyi Dai, Jinsong Han, and Dong Huang. “Can WiFi estimate person pose?.” arXiv preprint arXiv:1904.00277 (2019)
Wang, Haili, Fuchuan Du, Hao Zhu, Zhuangzhuang Zhang, Yizhao Wang, Qixin Cao, and Xiaoxiao Zhu. “HeRe: Heartbeat signal reconstruction for low-power millimeter-wave radar based on deep learning.” IEEE Transactions on Instrumentation and Measurement 72 (2023): 1-15. ieeexplore.ieee.org/document/10103728
Wang, Xuan, Tong Liu, Chao Feng, Dingyi Fang, and Xiaojiang Chen. “Rf-cm: Cross-modal framework for rf-enabled few-shot human activity recognition.” Proceedings of the ACM on Interactive, Mobile, Wearable and Ubiquitous Technologies 7, no. 1 (2023): 1-28
Wang, Yiming, Lingchao Guo, Zhaoming Lu, Xiangming Wen, Shuang Zhou, and Wanyu Meng. “From point to space: 3D moving human pose estimation using commodity WiFi.” IEEE Communications Letters 25, no. 7 (2021): 2235-2239
Wu, Jiacheng, and Naim Dahnoun. “A health monitoring system with posture estimation and heart rate detection based on millimeter-wave radar.” Microprocessors and Microsystems 94 (2022): 104670.www.sciencedirect.com/science/article/pii/S0141933122002009
Xue, Hongfei, Qiming Cao, Chenglin Miao, Yan Ju, Haochen Hu, Aidong Zhang, and Lu Su. “Towards generalized mmwave-based human pose estimation through signal augmentation.” In Proceedings of the 29th Annual International Conference on Mobile Computing and Networking, pp. 1-15. 2023
Xue, Hongfei, Yan Ju, Chenglin Miao, Yijiang Wang, Shiyang Wang, Aidong Zhang, and Lu Su. “mmMesh: Towards 3D real-time dynamic human mesh construction using millimeter-wave.” In Proceedings of the 19th Annual International Conference on Mobile Systems, Applications, and Services, pp. 269-282. 2021
Yan, Kangwei, Fei Wang, Bo Qian, Han Ding, Jinsong Han, and Xing Wei. “Person-in-WiFi 3D: End-to-End Multi-Person 3D Pose Estimation with Wi-Fi.” In Proceedings of the IEEE/CVF Conference on Computer Vision and Pattern Recognition, pp. 969-978. 2024
Yang, Jianfei, Yunjiao Zhou, He Huang, Han Zou, and Lihua Xie. “MetaFi: Device-free pose estimation via commodity WiFi for metaverse avatar simulation.” In 2022 IEEE 8th World Forum on Internet of Things (WF-IoT), pp. 1-6. IEEE, 2022
Zeng, Zhiyuan, Xingdong Liang, Yanlei Li, and Xiangwei Dang. “Vulnerable Road User Skeletal Pose Estimation Using mmWave Radars.” Remote Sensing 16, no. 4 (2024): 633
Zhang, Guangcheng, Xiaoyi Geng, and Yueh-Jaw Lin. “Comprehensive mpoint: A method for 3d point cloud generation of human bodies utilizing fmcw mimo mm-wave radar.” Sensors 21, no. 19 (2021): 6455
Zhao, Mingmin, Tianhong Li, Mohammad Abu Alsheikh, Yonglong Tian, Hang Zhao, Antonio Torralba, and Dina Katabi. “Through-wall human pose estimation using radio signals.” In Proceedings of the IEEE conference on computer vision and pattern recognition, pp. 7356-7365. 2018
Zhou, Xiaolong, Tian Jin, Yongpeng Dai, Yongkun Song, and Zhifeng Qiu. “Md-pose: Human pose estimation for single-channel uwb radar.” IEEE Transactions on Biometrics, Behavior, and Identity Science 5, no. 4 (2023): 449-463
Zhou, Yue, Aichun Zhu, Caojie Xu, Fangqiang Hu, and Yifeng Li. “Perunet: Deep signal channel attention in unet for wifi-based human pose estimation.” IEEE Sensors Journal 22, no. 20 (2022): 19750-19760.
Zhou, Yue, Caojie Xu, Lu Zhao, Aichun Zhu, Fangqiang Hu, and Yifeng Li. “CSI-former: Pay more attention to pose estimation with WiFi.” Entropy 25, no. 1 (2022): 20
Zhou, Yunjiao, He Huang, Shenghai Yuan, Han Zou, LihuaXie, and Jianfei Yang. “Metafi++: Wifi-enabled transformer-based human pose estimation for metaverse avatar simulation.” IEEE Internet of Things Journal 10, no. 16 (2023): 14128-14136
Zhou, Yunjiao, Jianfei Yang, He Huang, and LihuaXie. “Adapose: Towards cross-site device-free human pose estimation with commodity wifi.” IEEE Internet of Things Journal (2024)
www.embedded.com/using-mmwave-radar-for-vital-signs-monitoring/.
news.ucsb.edu/2023/021198/wifi-can-read-through-walls
phys.org/news/2017-06-x-ray-eyes-sky-method-d.html
www.media.mit.edu/posts/adib-and-katabi-receive-the-acm-sigmobile-test-of-time-award/
news.mit.edu/2018/artificial-intelligence-senses-people-through-walls-0612
gizmodo.com/wifi-networks-can-now-identify-who-you-are-through-wall-1738998333
spectrum.ieee.org/household-radar-can-see-through-walls-and-knows-how-youre-feeling
www.csoonline.com/article/565638/mits-ai-can-now-see-and-track-people-through-walls-using-wireless-signals.html
www.extremetech.com/extreme/184347-mit-perfects-cheap-accurate-through-wall-movement-and-heartbeat-detection-with-wifi
CN101876707 B; CN102289906 A; CN102486537 A; CN102565791 A; CN102565791 A; CN103258400 B; CN104375140 A; CN104678385 B; CN105093219 A; CN105807279 A; CN105974378 B; CN106353755 A; CN106546974 A; CN106908785 A; CN107589404 A; CN107612879 A; CN107918122 A; CN108983224 A; CN109168175 B; CN109270533 A; CN109709523 B; CN109916241 A; CN110501677 B; CN111127800 A; CN112731299 A; CN113589291 A; CN113671448 A; CN114296045 A; CN114355338 A; CN115480243 A; CN115728715 A; CN115986380 A; CN1186645 C; CN1274964 A; CN202421498 U; CN203037869 U; CN203606490; CN204228954 U; CN204347245 U; CN205067739 U; CN206209102 U; CN206411265 U; CN207399251 U; CN207611137 U; CN211043663 U; CN211066575 U; CN211148909 U; CN212342800 U; CN213633802 U; CN213903792 U; CN213903794 U; CN216209852 U; CN216696672 U; CN216718690 U; CN217766841 U; CN217903447 U; CN217983642 U; CN218671505 U; CN219068383 U; CN219349117 U; CN303095813 S; CN306111739 S; CN306266927 S; CN306272583 S; CN307956770 S; CN308155838 S; DE102007061814 B4; DE202019005611 U1; EP01101138; EP1118872 A3; ES406597 A1; ES428718 A3; FR3070205 B3; GB2044007 A; GB2458123 A; IN202347004777 A; IN422742 B; JP2014519746 A; JP2018098367 A; JP2019039766 A; JP2022169051 A5; JP3608987 B2; JP5396052 B2; JPS5224489 A; KR101653466 B1; N0135008 B; RU2009112426 A; RU2019107125 A; RU2019109661 A; RU2577848 C1; RU2687286 C1; RU32889 U1; SG10201802847VA; SU743208 A1; UA12453 A; U.S. Ser. No. 10/488,490 B2; U.S. Ser. No. 11/108,472 B1; US20080117099 A1; US20090160696 A1; US20130222172 A1; US20130314267 A1; US20180088227 A1; US20180319138 A1; US20210351851 A1; US20230035803 A1; U.S. Pat. No. 8,049,620 B2; U.S. Pat. No. 9,891,315 B2; USD984985 S1; USH1107 H; WO2010072796 A8; WO2012030615 A2; WO2012166616A1; WO2018112439 A1; WO2020161365 A1; WO2022184060 A1; WO2023015067 A3; 10,499,153; 9,361,896; 9,173,032; 9,042,565; 8,880,413; 7,792,674; 7,532,734; 7,379,961; 7,167,566; 6,961,439; 6,694,033; 6,668,061; 6,442,277; 6,185,152; 6,009,396; 5,943,427; 5,987,142; 5,841,879; 5,661,812; 5,465,302; 5,459,790; 5,272,757; 20010031051; 20020150254; 20020196947; 20030059070; 20040141622; 20040223620; 20050114121; 20050135643; 20050271212; 20060045275; 20060056639; 20070109977; 20070286427; 20070294061; 20080004866; 20080025534; 20080137870; 20080144794; 20080304670; 20080306720; 20090046864; 20090060236; 20090067636; 20090116652; 20090232317; 20090292544; 20100183159; 20100198601; 20100241439; 20100296678; 20100305952; 20110009771; 20110268281; 20110299707; 20120093348; 20120121113; 20120162362; 20120213375; 20120314878; 20130046790; 20130163766; 20140016793; 20140064526; 20150036827; 20150131824; 20160014540; 20160050508; 20170070835; 20170215018; 20170318407; 20180091921; 20180217804; 20180288554; 20180288554; 20190045317; 20190116448; 20190132674; 20190166426; 20190268711; 20190289417; 20190320282; 20200143553; 20200014849; 20200008005; 20190387168; 20180278843; 20180182173; 20180077513; 20170256069; WO 00/19415; WO 99/49574; and WO 97/30566.
U.S. Patent and Pub. App. Nos. U.S. Pat. Nos. 6,259,957; 6,639,989; 6,697,491; 6,956,955; 6,987,856; 7,006,638; 7,817,803; 7,945,856; 8,229,134; 8,396,282; 8,718,301; 8,812,013; 8,852,103; 8,879,743; 8,988,970; 8,989,417; 9,002,020; 9,053,562; 9,324,313; 9,363,569; 9,392,366; 9,648,438; 9,667,889; 9,674,661; 9,769,585; 9,848,273; 9,955,281; 9,980,075; 10,003,905; 10,038,966; 10,070,224; 10,113,877; 10,133,544; 10,142,760; 10,163,271; 10,212,532; 10,231,053; 10,390,170; 10,397,725; 10,397,727; 10,412,527; 10,419,843; 10,419,870; 10,425,762; 10,440,473; 10,440,498; 10,477,157; 10,484,809; 10,509,466; 10,511,906; 10,574,472; 10,595,149; 10,616,705; 10,636,260; 10,638,222; 10,638,248; 10,638,252; 10,645,520; 10,701,426; 10,706,693; 10,708,706; 10,715,909; 10,721,521; 10,743,128; 10,757,240; 10,764,707; 10,779,082; 10,788,897; 10,791,389; 10,812,928; 10,812,929; 10,819,953; 10,823,960; 10,824,247; 10,824,390; 10,873,800; 10,880,667; 10,880,668; 10,891,890; 10,893,357; 10,897,570; 10,928,889; 10,932,082; 10,948,976; 10,948,989; 10,966,043; 10,971,130; 10,976,543; 11,006,197; 11,012,804; 11,039,265; 11,039,651; 11,087,777; 11,096,006; 11,098,737; 11,102,578; 11,102,602; 11,102,606; 11,112,389; 11,115,773; 11,159,768; 11,212,606; 11,226,406; 11,234,073; 11,234,095; 11,246,002; 11,259,139; 11,265,668; 11,287,885; 11,290,837; 11,315,277; 11,340,463; 11,388,513; 11,395,087; 11,409,360; 11,425,515; 11,432,095; 11,435,528; 11,436,987; 11,454,700; 11,470,439; 11,481,033; 11,513,578; 11,537,204; 11,540,055; 11,564,038; 11,568,562; 11,570,538; 11,576,005; 11,589,176; 11,598,962; 11,659,043; 11,659,324; 11,683,634; 11,715,479; 11,722,137; 11,741,898; 11,751,003; 11,778,361; 11,796,823; 11,815,692; 11,852,843; 11,924,628; 11,937,073; 11,979,667; 11,997,454; 12,003,946; 12,039,991; 12,066,148; 12,108,241; 12,118,200; 12,141,347; 12,160,703; 12,170,875; 12,170,879; 12,170,883; 20010031053; 20020141597; 20020143414; 20020147586; 20020150254; 20020150256; 20020150257; 20020151996; 20020151997; 20020154179; 20020156633; 20020164037; 20030018477; 20030031333; 20030095668; 20030095669; 20030123676; 20030227476; 20040013252; 20040013271; 20040029086; 20040136538; 20050117771; 20050142032; 20050270146; 20050275914; 20060045294; 20060104458; 20060116930; 20060238877; 20070070069; 20070189559; 20080008324; 20080107287; 20090116657; 20090189830; 20090189974; 20090238370; 20090238371; 20090264114; 20090287324; 20090318826; 20100046767; 20100303266; 20100329490; 20110293129; 20110301729; 20120093348; 20120109645; 20120117502; 20120183161; 20120237037; 20120268563; 20120283593; 20120288124; 20120288126; 20120328107; 20130041648; 20130077792; 20130094683; 20130121505; 20130141221; 20130163765; 20130169779; 20130177166; 20130177187; 20130194107; 20130202116; 20130208897; 20130208898; 20130208899; 20130208900; 20130208926; 20130315422; 20130322667; 20140019037; 20140025287; 20140037117; 20140107916; 20140114560; 20140133658; 20140133683; 20140171195; 20140219485; 20140221017; 20140328505; 20140355765; 20150003649; 20150010160; 20150049004; 20150058102; 20150106475; 20150131824; 20150156578; 20150189449; 20150208184; 20150208190; 20150223002; 20150230036; 20150230040; 20150256613; 20150271620; 20150293655; 20150304791; 20150326963; 20150350804; 20150358715; 20150382127; 20160021480; 20160044436; 20160057529; 20160066118; 20160119731; 20160142851; 20160174013; 20160195856; 20160269833; 20160269849; 20160286329; 20160295341; 20160324478; 20160360326; 20170010671; 20170026771; 20170034641; 20170045941; 20170078819; 20170086005; 20170112671; 20170123492; 20170127211; 20170180863; 20170180873; 20170188168; 20170188172; 20170195793; 20170208392; 20170238102; 20170324931; 20170325043; 20170330365; 20170330382; 20170332186; 20170347192; 20170347193; 20170353811; 20170374317; 20170374444; 20180007488; 20180035226; 20180035234; 20180115852; 20180144752; 20180168453; 20180184225; 20180199137; 20180206038; 20180213343; 20180220253; 20180225805; 20180226105; 20180232471; 20180249271; 20180249275; 20180295463; 20180310114; 20180324540; 20180335903; 20180343432; 20180374276; 20190057612; 20190060741; 20190069114; 20190075418; 20190090060; 20190098426; 20190098427; 20190110137; 20190116452; 20190130927; 20190130928; 20190160083; 20190174237; 20190182594; 20190208348; 20190212824; 20190213792; 20190218202; 20190253821; 20190260930; 20190261095; 20190261124; 20190270118; 20190289420; 20190329364; 20190333397; 20190349702; 20190349703; 20190364352; 20190373357; 20190373395; 20190378385; 20190387324; 20190387352; 20190391783; 20190394564; 20190394565; 20190394567; 20190394569; 20190394570; 20190394583; 20190394598; 20190394601; 20190394602; 20190394603; 20200021927; 20200045491; 20200051325; 20200053503; 20200057493; 20200058310; 20200084538; 20200097248; 20200099792; 20200104620; 20200105282; 20200107148; 20200111262; 20200125317; 20200134026; 20200135163; 20200137488; 20200142667; 20200150751; 20200162140; 20200162833; 20200196058; 20200201495; 20200210127; 20200213702; 20200236488; 20200245091; 20200275195; 20200280816; 20200288262; 20200314524; 20200327877; 20200329327; 20200336856; 20200336858; 20200342846; 20200345757; 20200351606; 20200368616; 20200374646; 20200382871; 20200382895; 20200387341; 20200388065; 20200394288; 20200404441; 20200409481; 20210006921; 20210006925; 20210014614; 20210018102; 20210029479; 20210030308; 20210034725; 20210037335; 20210042994; 20210043005; 20210043223; 20210058693; 20210065523; 20210067896; 20210075074; 20210076150; 20210081048; 20210082191; 20210084357; 20210084429; 20210089260; 20210099826; 20210105435; 20210105552; 20210112360; 20210118218; 20210125412; 20210127220; 20210127223; 20210134314; 20210136508; 20210144475; 20210144506; 20210156986; 20210168549; 20210168551; 20210176588; 20210185471; 20210195360; 20210204058; 20210204085; 20210211806; 20210211823; 20210235189; 20210248827; 20210250686; 20210256175; 20210256261; 20210256769; 20210258713; 20210258715; 20210264931; 20210274296; 20210281232; 20210297805; 20210301581; 20210306751; 20210306786; 20210311553; 20210314721; 20210325683; 20210329403; 20210333402; 20210350604; 20210354137; 20210366142; 20210373654; 20210375257; 20210377659; 20210392223; 20210409876; 20210409879; 20220013991; 20220014680; 20220014868; 20220021972; 20220021996; 20220030369; 20220030377; 20220038832; 20220038838; 20220042646; 20220049944; 20220053281; 20220060820; 20220061767; 20220101126; 20220115007; 20220124446; 20220124447; 20220124448; 20220125342; 20220129062; 20220135974; 20220141604; 20220141608; 20220141611; 20220148115; 20220150657; 20220150658; 20220167105; 20220167109; 20220180885; 20220182772; 20220187655; 20220191578; 20220191638; 20220194909; 20220201388; 20220201403; 20220206566; 20220208086; 20220208134; 20220225016; 20220225050; 20220232342; 20220243202; 20220246128; 20220256300; 20220272449; 20220272454; 20220272477; 20220272481; 20220279303; 20220279304; 20220286788; 20220291513; 20220294100; 20220303657; 20220312144; 20220321999; 20220322010; 20220322023; 20220322028; 20220342213; 20220345820; 20220345845; 20220373803; 20220385796; 20220400330; 20220400352; 20220405946; 20220413296; 20230011087; 20230011408; 20230011591; 20230020792; 20230027060; 20230037463; 20230041678; 20230044624; 20230045610; 20230046511; 20230049597; 20230054213; 20230055257; 20230065296; 20230067081; 20230072423; 20230083937; 20230085063; 20230090315; 20230093585; 20230096953; 20230106761; 20230130524; 20230134249; 20230136085; 20230139061; 20230139295; 20230140699; 20230143857; 20230146178; 20230152583; 20230171553; 20230171556; 20230194869; 20230196765; 20230208921; 20230209298; 20230209299; 20230209302; 20230216269; 20230217201; 20230224667; 20230232178; 20230239626; 20230247381; 20230254637; 20230254660; 20230260268; 20230269553; 20230282177; 20230282962; 20230282965; 20230283976; 20230298226; 20230300532; 20230305306; 20230306695; 20230308605; 20230308821; 20230319190; 20230319474; 20230320669; 20230328461; 20230329913; 20230345168; 20230353930; 20230362528; 20230370800; 20230380739; 20230384860; 20230387729; 20230388690; 20230388731; 20230388732; 20230394886; 20230396920; 20230403443; 20230403529; 20230410348; 20230413005; 20230418022; 20230418076; 20230418383; 20240007819; 20240031742; 20240031759; 20240031767; 20240045035; 20240045216; 20240048934; 20240061249; 20240062403; 20240064486; 20240073564; 20240073589; 20240078995; 20240089687; 20240089689; 20240094390; 20240096340; 20240098404; 20240103617; 20240104871; 20240114309; 20240118423; 20240118746; 20240135912; 20240137720; 20240151882; 20240152817; 20240155283; 20240163630; 20240168300; 20240179487; 20240192481; 20240198578; 20240201456; 20240204549; 20240211563; 20240214709; 20240219562; 20240231093; 20240233099; 20240233100; 20240236256; 20240256600; 20240256641; 20240259742; 20240259755; 20240259761; 20240265796; 20240285190; 20240297863; 20240297972; 20240305942; 20240305951; 20240310175; 20240311075; 20240311076; 20240312892; 20240329731; 20240329916; 20240330425; 20240331677; 20240331713; 20240332252; 20240332260; 20240332275; 20240334112; 20240334149; 20240340603; 20240340604; 20240346221; 20240346729; 20240348278; 20240349001; 20240353922; 20240355245; 20240359090; 20240359099; 20240370344; 20240370542; 20240371364; 20240372968; 20240379102; 20240388862; 20240395073; 20240402800; 20240402869; 20240402984; 20240404210; 20240404216; 20240406368; 20240406666; 20240414492; 20240420676; 20240420718; 20240422503; 20200077187; 20200070862; 20200021940; 20200005758; 20190387347; 20190385600; 20190258894; 20190253796; 20190172476; 20190139552; 20180374469; 20180293507; 20180262832; 20180261201; 20180213309; 20180206052; 20180184225; 20170308164; 20170140771; 20170134849; 20170053667; 20170047079; 20160337523; 20160322062; 20160302006; 20160300584; 20160241974; 20160192068; 20160118038; 20160063986; 20160029130; 20150249899; 20150139444; 20150003631; 20140355776; 20140270248; 20140112103; 20140003635; 20140003611; 20130332156; 20130304476; 20130301837; 20130300648; 20130275873; 20130275872; 20130275077; 20130272539; 20130272538; 20130272097; 20130094664; 20120263315; 20120237049; 20120183149; 20110235808; 20110232989; 20110200206; 20110131044; 20100195844; 20100030558; 20090326870; 20090310444; 20090228272; 20070028593; 20060002546; 20050100176; 20040032796; 20200162821; and 20180166062

What is claimed is:

1. A spatialized audio method, comprising:
analyzing characteristics of an environment comprising at least one human, each human having a dynamic physiological patterns, by transmitting radio frequency signals and analyzing received radio frequency signals;
estimating a body pose, head and ear position within the environment of each human based on the analyzed characteristics of the environment and the sensed dynamic physiological patterns and the at least one human dynamic physiological pattern of each human; and
generating spatialized audio for each human in the environment using an estimated head and ear position within the environment of each human in conjunction with a head-related transfer function.

2. The method according to claim 1, wherein the dynamic physiological patterns of each human comprises a heartbeat pattern.

3. The method according to claim 1, wherein the dynamic physiological patterns of each human comprises a respiration pattern.

4. The method according to claim 1, wherein the radio frequency signals are channelized into a plurality of radio frequency subchannels, further comprising determining channel state information for the plurality of radio frequency subchannels.

5. The method according to claim 4, wherein the plurality of radio frequency subchannels are orthogonal frequency channels, and the channel state information comprises phase information and amplitude information.

6. The method according to claim 1, wherein the sensed characteristics comprise a Doppler shift of the radio frequency signals due to movements associated with the dynamic physiological patterns of each human.

7. The method according to claim 1, wherein the radio frequency signals comprise radio frequency waves having a frequency over 5 GHz.

8. The method according to claim 1, wherein the radio frequency signals comprise radio frequency waves emitted and analyzed by a radio compliant with IEEE-802.11ax or IEEE-802.11be.

9. The method according to claim 1, wherein the radio frequency signals comprise radio frequency waves emitted and analyzed by a radio compliant with IEEE-802.11bf.

10. The method according to claim 1, wherein said estimating comprises feeding the received radio frequency signals to a neural network responsive to a human heartbeat and human respiration, the neural network being trained with training data comprising received radio frequency signals tagged with human ear location.

11. The method according to claim 1, wherein said estimating comprises feeding the received radio frequency signals to a neural network responsive to extract a human body pose for each human.

12. The method according to claim 1, wherein the generated spatialized audio comprises aggregated virtualized audio transducer signals.

13. A spatialized audio system comprising:
a radar device configured to emit radar signals into a region comprising a listener and receive scattered radar signals from the listener;
at least one automated processor configured to process the received scattered radar signals to determine one or more ear locations for determination of a head-related transfer function (HRTF); and
a spatialized audio emitter configured to emit spatialized audio sounds dependent on the head related transfer function.

14. The spatialized audio system of claim 13, wherein the radar device is further configured to determine one or more distances between the radar device and the listener.

15. The spatialized audio system of claim 13, further comprising an audio feedback device configured to receive audio signals proximate to ear canals of the listener, to calibrate the determination of the HRTF and the emission of the spatialized audio sounds.

16. The spatialized audio system of claim 13, wherein the radar device comprises a radio compliant with IEEE-802.11 ax or IEEE-802.11be.

17. The spatialized audio system of claim 16, wherein a source audio for the spatialized audio emitter is received through the radio compliant with IEEE-802.11 ax or IEEE-802.11be.

18. The spatialized audio system of claim 16, wherein the radar device is configured to extract a heartbeat pattern and a respiration pattern from the listener, and infer an ear location based on the extracted heartbeat pattern and respiration pattern from the listener.

19. The spatialized audio system of claim 13, wherein the at least one processor is configured to implement a neural network trained with received scattered radar signals tagged with ear location of the listener in the region.

20. A system for targeting spatialized audio to ears of a listener comprising:
an input port configured to receive an audio signal;
one or more processors configured to:
sense characteristics of an environment comprising a listener by receiving radio frequency signals;
analyze at least one dynamic physiological pattern of the listener in the sensed characteristics;
estimate a body pose and ear position within the environment of the listener, based on the sensed characteristics and the at least one dynamic physiological pattern; and
define a head-related transfer function for the listener dependent on the estimated body pose and ear position; and
an output port configured to communicate a signal defining spatialized audio for the listener.
